(19) United States
(12) Patent Application Publication
(10) Pub. No.: US 2022/0356628 A1
(43) Pub. Date: Nov. 10, 2022

(54) APPARATUS AND METHOD FOR TREATING A SUBSTRATE WITH SOLID PARTICLES

(71) Applicant: Xeros Limited, Rotherham, South Yorkshire (GB)

(72) Inventors: Gareth Evan Lyn JONES, Bath and North East Somerset (GB); Christopher HOLDEN, Bath And North East Somerset (GB); David STEVENS, Bath And North East Somerset (GB)

(21) Appl. No.: 17/280,519

(22) PCT Filed: Sep. 25, 2019
(86) PCT No.: PCT/EP2019/075851

§ 371 Date: Mar. 26, 2021

(30) Foreign Application Priority Data
Sep. 26, 2018 (GB) 1815678.6

(51) Int. Cl. D06F 37/06; D06F 23/02; D06F 35/00; B01D 43/00

(52) U.S. Cl. CPC D06F 37/06; D06F 23/02; D06F 35/00; B01D 43/00

(57) ABSTRACT

An apparatus for use in tie treatment of substrates with a solid particulate material, said apparatus comprising a housing having mounted therein a rotatably mounted drum having an inner surface and an end wall, and access means for introducing said substrates into said drum, wherein (a) said drum comprises storage means for storage of said sold particulate material; (b) said drum has at least one elongate protrusion located on said inner surface of said drum wherein the elongate protrusion extends in a direction away from said end wall, wherein said elongate protrusion has an end proximal to the end wall and an end distal to the end wall; (c) the or each elongate protrusion comprises a collecting aperture and a collecting flow path to facilitate flow of said solid particulate material from the interior of said drum to said storage means, wherein said collecting aperture defines the start of a collecting flow path, and wherein the same elongate protrusion further comprises a dispensing aperture and a dispensing flow path to facilitate flow of said solid particulate material from said storage means to the interior of said drum, wherein said dispensing aperture defines the end of a dispensing flow path; (d) wherein said collecting aperture is disposed in a first side of said elongate protrusion, wherein said first side of said elongate protrusion is the leading side of said elongate protrusion during rotation of the drum in a collecting direction; and (e) wherein said flow of said solid particulate material from the storage means towards the interior of the drum is facilitated by the rotation of said drum in a dispensing direction and the flow of said solid particulate material from the interior of tie drum towards the storage means is facilitated by the rotation of said drum in said collecting direction, wherein rotation in said dispensing direction is in the opposite rotational direction to rotation in said collecting direction, characterised in that: (f) said elongate protrusion exhibits one or more harvesting apertures disposed in a second side of said elongate protrusion, wherein the second side is defined as the leading side of said elongate protrusion during rotation of the drum in said dispensing direction, wherein said harvesting aperture(s) are in fluid communication with a harvesting flow path, wherein said harvesting aperture(s) facilitate flow of said solid particulate material from toe interior of said drum via said harvesting flow path to said storage means during rotation of the drum in a dispensing direction.

The present disclosure relates to an apparatus that employs a solid particulate material in the treatment of substrates, particularly a substrate which is or comprises a textile. The present disclosure further relates to a method for the treatment of substrates with solid particles using the apparatus. The present disclosure further relates to components of the apparatus, in particular to the elongate protrusions of the apparatus. The present disclosure particularly relates to an apparatus, components thereof (in particular the elongate protrusions) and a method suitable for cleaning of soiled substrates. The present disclosure further relates to a kit and method suitable for retrofitting or converting an apparatus into an apparatus according to the present disclosure.

Conventional methods for treating and cleaning of textiles and fabrics typically involve aqueous cleaning using large volumes of water. These methods generally involve aqueous submersion of fabrics followed by soil removal, aqueous soil suspension, and water rinsing. The use of solid particles to provide improvements in, and advantages over, these conventional methods is known in the art. For example PCT patent publication WO2007/128962 discloses a method for cleaning a soiled substrate using a solid particulate material. Other PCT patent publications which have related disclosures of cleaning methods include: WO2012/056252; WO2014/006424; WO2015/004444; WO2014/147390; WO2014/147391; WO2014/006425; WO2012/035343; WO2012/167545; WO2011/098815; WO2011/064581; WO2010/094959; and WO2014/147389. These disclosures teach apparatus and methods for treating or cleaning a substrate which offers several advantages over conventional methods including: improved treating/cleaning performance, reduced water consumption, reduced consumption of detergent and other treatment agents, and better low temperature treating/cleaning (and thus more energy efficient treating/cleaning). Other patent applications, for instance WO2014/167358, WO2014/167359, WO2016/051189, WO/2016/055789 and WO2016/055788, teach the advantages provided by solid particles in other fields such as leather treatment and tanning.

It would be desirable to provide even better apparatus for treatment methods which involve the use of a solid particulate material. In particular, it would be desirable to improve the efficiency and reliability, to further reduce water consumption, to facilitate quieter operation, to improve fabric care, and/or to reduce the power consumption and costs (including capital costs and/or running costs) of the apparatus and the operation thereof. It would also be desirable to reduce the complexity of the apparatus and the number of moving components therein. Furthermore, it would also be desirable to retrofit a conventional apparatus so that it is suitable for operation with a solid particulate material.

The present Applicant's pending PCT application PCT/GB2017/053815 discloses an apparatus in which solid particles are stored in a rotatable drum which further provides a plurality of dispensing flow path(s) for the solid particles to flow from the storage compartment(s) to the interior of the drum, and a plurality of collecting flow paths for the solid particles to flow from the interior of the drum to the storage compartment(s), such that the direction of flow between the storage compartment(s) and the interior of the drum is controlled by the direction of rotation of the drum.

It would be desirable to provide further improvements to the apparatus. The present inventors found that while the apparatus described in PCT/GB2017/053815 had a good rate of collection of solid particles from the interior of the drum, it is desirable to effect brief and intermittent counter-rotation of the drum (in the so-called dispensing direction) during the particle collection phase of the treatment cycle in which the particles are separated from the treated substrates and in which the drum is rotated in the so-called collecting direction so that particles are collected in the storage means. Said brief and intermittent counter-rotation was found to inhibit undesirable “roping” or tangling of the substrates in the interior of the drum. During said brief and intermittent counter-rotation of the drum at this stage of the treatment cycle, no collection of solid particles was being achieved and some particles were being dispensed back into the interior of the drum, which reduced the collection rate and extended the duration of the treatment cycle. It would be desirable to increase the collection rate, especially at the end of a treatment cycle when the solid particles are being separated from the treated substrate, and reduce the duration of the treatment cycle. It would be desirable to do so particularly when the axis of the rotatable drum is in the horizontal plane.

It is an object of the present invention to address one or more of the aforementioned problems.

According to a first aspect of the invention, there is provided an apparatus for use in the treatment of substrates with a solid particulate material, said apparatus comprising a housing having mounted therein a rotatably mounted drum having an inner surface and an end wall, and access means for introducing said substrates into said drum, wherein
(a) said drum comprises storage means for storage of said solid particulate material;
(b) said drum has at least one elongate protrusion located on said inner surface of said drum wherein the elongate protrusion extends in a direction away from said end wall, wherein said elongate protrusion has an end proximal to the end wall and an end distal to the end wall;
(c) the or each elongate protrusion comprises a collecting aperture and a collecting flow path to facilitate flow of said solid particulate material from the interior of said drum to said storage means, wherein said collecting aperture defines the start of a collecting flow path, and wherein the same elongate protrusion further comprises a dispensing aperture and a dispensing flow path to facilitate flow of said solid particulate material from said storage means to the interior of said drum, wherein said dispensing aperture defines the end of a dispensing flow path;
(d) wherein said collecting aperture is disposed in a first side of said elongate protrusion, wherein said first side of said elongate protrusion is the leading side of said elongate protrusion during rotation of the drum in a collecting direction; and
(e) wherein said flow of said solid particulate material from the storage means towards the interior of the drum is facilitated by the rotation of said drum in a dispensing direction and the flow of said solid particulate material from the interior of the drum towards the storage means is facilitated by the rotation of said drum in said collecting direction, wherein rotation in said dispensing direction is in the opposite rotational direction to rotation in said collecting direction,
   characterised in that:
(f) said elongate protrusion exhibits one or more harvesting apertures disposed in a second side of said elongate protrusion, wherein the second side is defined as the leading side of said elongate protrusion during rotation of the drum in said dispensing direction, wherein said harvesting aperture(s) are in fluid communication with a harvesting flow path, wherein said harvesting aperture(s) facilitate flow of said solid particulate material from the interior of said drum via said harvesting flow path to said storage means during rotation of the drum in a dispensing direction.

The apparatus of the present invention advantageously allows collection of solid particulate material in both rotational directions of the drum, i.e. bidirectional collection. Thus, the apparatus provides improved collection efficiency of solid particulate material from the interior of the drum to the storage means. In particular, the apparatus allows an improvement in the overall rate of recovery of solid particulate material to the storage means towards the end of the treatment cycle, or generally any point in the cycle when most of the solid particulate material is already present in the storage means. Thus, the apparatus of the present invention advantageously reduces overall cycle time.

The apparatus of the present invention can avoid, and preferably does not comprise, a further storage means which is not attached to or integral with the drum (for instance a sump for storage of solid particulate material, such as a sump located beneath the drum). Similarly, the apparatus can avoid, and preferably does not comprise, a pump for circulating said solid particulate material between the storage means and the interior of the drum (i.e. from the storage means to the interior of the drum, and from the interior of the drum to the storage means). Preferably, the apparatus can dispense with, and preferably does not comprise, a pump for circulating said solid particulate material.

In addition, the amount of water used in the treatment of the substrates is reduced because water is not required to transport the solid particulate material around the apparatus. The apparatus and methods of the present invention therefore only require the water needed as the liquid medium in the treatment of the substrates, which provides a significant reduction in water consumption.

A further advantage of the storage means being located in the rotatable drum is that solid particulate material can be centrifugally dried, i.e. it can undergo one or more spin cycles to dry the particles. Centrifugal drying of the solid particulate material may be separate from or included in the operation of the apparatus to treat substrates. For instance, centrifugal drying may be effected concurrently with extraction step(s) for removing liquid medium, as described hereinbelow. Thus, the method described hereinbelow for treating a substrate optionally comprises the step of centrifugal drying of the solid particulate material. It will therefore be appreciated that an advantage of the present invention is the dry storage of the solid particulate material.

Preferably, the drum is configured to bias solid particulate material present inside the drum towards said collecting apertures during rotation of the drum in the collecting direction, and the drum is configured to bias solid particulate material present inside the storage means and/or dispensing flow path towards a dispensing aperture during rotation of the drum in the dispensing direction.

In a preferred embodiment, the dispensing flow path and/or the storage means are configured such that it takes 2, 3, 4, 5, 6, 7, 8, 9 or 10 or more rotations in the dispensing direction to begin to release the solid particulate material into the interior of said drum. This depends on the size of the drum and the apparatus. For larger drums, the number of rotations in the dispensing direction to begin to release solid particulate material into the interior of said drum may exceed 10 and possibly may exceed 20, although it is unlikely to exceed 30 rotations and more typically it is unlikely to exceed 25 rotations. Advantageously, this facilitates separation and untangling of substrates within the drum. This also facilitates controlled release of the solid particulate material during the treatment cycle, enabling more consistent exposure of the substrates to the solid particulate material, thereby providing excellent treatment performance and efficiency.

It will be appreciated that the rate of flow of the solid particulate material between the storage means and the interior of the drum may also be controlled, additionally or alternatively, by varying the rate of rotation of the drum and/or by intermittently rotating the drum, in either the dispensing or collecting direction. Similarly, the rate of flow of the solid particulate material between the storage means and the interior of the drum may be controlled, additionally or alternatively, by varying the direction of rotation of the drum. Thus, a given phase in the treatment cycle may comprise a number (n) of rotations in the collecting direction and further comprise a number (m) of rotations in the dispensing direction, where n and m are different and independently selected from integers or non-integers, thereby leading to a net increase or decrease in the amount of solid particulate material in the storage means and the interior of the drum.

The apparatus is preferably a front-loading apparatus, with the access means disposed in the front of the apparatus. Preferably the access means is or comprises a door. It will be appreciated that the drum has an opening at the opposite end of the drum to the end wall, suitably wherein the opening is aligned with the access means, and through which opening said substrates are introduced into said drum.

The rotatably mounted drum (also referred to herein as a rotatable drum) is preferably cylindrical, but other configurations are also envisaged, including for instance hexagonal drums.

Thus, the inner surface of the drum is preferably a cylindrical inner surface.

The inner surface of the drum is the surface of the inner wall(s) of the drum. The inner wall(s) of the drum is/are joined to the end wall of the drum at the juncture of the inner and end walls. Thus, the inner surface is the surface of the inner wall of the drum which is disposed around the rotational axis of the drum, i.e. substantially perpendicular to the end wall of the drum.

For a cylindrical drum, the axis of the cylindrical drum is preferably the rotational axis of the drum. More generally, the inner and end walls of the drum define a three-dimensional volume in which the end wall intersects the rotational axis of the drum, and preferably intersects said rotational axis in a substantially perpendicular manner, and wherein the inner wall(s) is/are disposed around the rotational axis, preferably wherein the inner walls are substantially parallel to the rotational axis.

The inner surface of the drum preferably comprises perforations which have dimensions smaller than the shortest linear dimension of the solid particulate material so as to permit passage of fluids into and out of said drum but to prevent egress of said solid particulate material (which is the opposite of many prior art apparatus, in which both fluids and solid particulate material exit the drum via perforations in its inner surface). Preferably the housing of the apparatus is a tub which surrounds said drum, preferably wherein said tub and said drum are substantially concentric, preferably wherein the walls of said tub are unperforated but having disposed therein one or more inlets and/or one or more outlets suitable for passage of a liquid medium and/or one or more treatment formulation(s) into and out of the tub. Thus, the tub is suitably water-tight, permitting ingress and egress of the liquid medium and other liquid components only through pipes or ducting components.

Preferably, the drum is disposed in the apparatus such that the axis of the drum is substantially horizontal. In a preferred embodiment, the drum is disposed in the apparatus such that the axis of the drum is substantially horizontal during at least part of the operation of the apparatus, and preferably during the whole of the operation of the apparatus. The improved collection rate of the apparatus of the present invention provides significant improvement in the collection efficiency for apparatus in which the axis of the drum is substantially horizontal during operation.

In an alternative embodiment, the apparatus and/or drum (and particularly the drum) is tilted or tiltable, as is known in the art. In a tiltable apparatus and/or drum, the axis of the drum to the horizontal plane can be varied before, during or after the treatment of the substrates in the apparatus, and preferably during the treatment or portion thereof, and particularly during rotation of the drum in a collecting direction. Tilting may be effected by any suitable means, including for instance an air bag, hydraulic ram, pneumatic piston and/or electric motor. In this embodiment, the drum and/or apparatus is tillable preferably such that the axis of the drum defines an angle a to the horizontal plane which is greater than 0 and less than about 10°. In this embodiment, the drum and/or apparatus is preferably configured to be tiltable such that the drum is inclined in a downwards direction from the front of the drum to the end wall of the drum during at least a part of said treatment, and particularly during rotation of the drum in a collecting direction. Thus, the apparatus is suitably configured such that for at least a part of said treatment (particularly during rotation of the drum in a collecting direction) the axis of the drum is tilted such that it defines an angle a to the horizontal plane which is greater than 0 and less than about 10° and such that the drum is inclined in a downwards direction from the front of the drum to the end wall of the drum.

Advantageously, during operation of the apparatus of the present invention, neither the drum nor the tub allows ingress or egress of the solid particulate material, which is retained by the drum throughout the treatment cycle by which substrates are treated in the apparatus. In other words, the solid particulate material remains in the storage means and/or in the interior of the drum and/or in the flow paths between the storage means and the interior of the drum throughout the treatment cycle, thereby obviating the need for a pump to circulate the particulate material and thereby obviating the need for a further storage means (such as a sump) which is not attached to or integral with the drum.

The apparatus preferably comprises a seal between the access means and the tub such that, in use, liquid medium is not able to exit the tub. Preferably, said seal is a door seal, as is conventional in the art. The seal between the access means and the tub prevents water leakage from the apparatus. The apparatus preferably further comprises a seal which prevents egress of the solid particulate material from the drum at the periphery thereof, in order to prevent egress of solid particulate material into the tub or egress of solid particulate material from the apparatus at the periphery of the access means, and such a seal is preferably disposed as a seal between the access means and the drum. Typically, said seal is made from foam or rubber or some other resiliently flexible material.

The apparatus further comprises the typical components present in apparatus suitable for the treatment of substrates with solid particulate material, preferably in a liquid medium and/or in combination with one or more treatment formulation(s) as described in more detail hereinbelow. Thus, the apparatus preferably comprises at least one pump for circulation of the liquid medium, and associated ports and/or piping and/or ducting for transport of the liquid medium and/or one or more treatment formulation(s) into the apparatus, into the drum, out of the drum, and out of the apparatus.

Preferably, the apparatus comprises a suitable drive means to effect rotation of the drum, and suitably a drive shaft to effect rotation of the drum. Preferably, the apparatus comprises heating means for heating the liquid medium. Preferably, the apparatus comprises mixing means to mix the liquid medium with one or more treatment formulation(s). The apparatus may further comprise one or more spray means to apply a liquid medium and/or one or more treatment formulation(s) into the interior of the drum and onto the substrate during the treatment thereof.

The apparatus typically further comprises an external casing, which surrounds the tub and drum.

It will be appreciated that the apparatus suitably further comprises a control means programmed with instructions for the operation of the apparatus according to at least one treatment cycle. The apparatus suitably further comprises a user interface for interfacing with the control means and/or apparatus.

The apparatus preferably comprises said solid particulate material.

### ELONGATE PROTRUSIONS

The elongate protrusion(s) located on the inner surface of the drum in the apparatus of the present invention are also known as “lifters”. Lifters are used in conventional apparatus, as well as in apparatus adapted for the treatment of substrates using solid particulate material, to encourage circulation and agitation of the contents (i.e. the substrate(s), treatment agents and solid particulate material) within the drum during rotation of the drum.

An elongate protrusion extends in a direction away from said end wall, and preferably extends from said end wall. An elongate protrusion therefore has an end proximal to the end wall and an end distal to the end wall. Typically, an elongate protrusion is disposed on the inner surface of the drum such the elongate dimension of the protrusion is essentially perpendicular to the direction of rotation of the drum.

The apparatus of the present invention preferably comprises a multiplicity of spaced apart elongate protrusion(s) affixed to the inner surface of the drum. The drum preferably has from 2 to 10, preferably 2, 3, 4, 5 or 6 and preferably 2, 3 or 4, and preferably 3 or 4, of said elongate protrusions. For domestic washing machines, 3 protrusions are most preferred. For commercial washing machines, 3 to 6 protrusions are most preferred. Where a plurality of elongate protrusions are located on the inner surface of the drum, all of the elongate protrusions typically have the same or substantially the same dimensions as each other. In alternative embodiments, a plurality of elongate protrusions may have elongate protrusions of differing dimensions, i.e. one or more elongate protrusions of a first size and/or shape, and one or more elongate protrusions of a second size and/or shape, etc.

The elongate dimension of an elongate protrusion may be rectilinear or curvilinear in shape. A drum may comprise both curvilinear and rectilinear elongate protrusions, but typically a drum comprises either curvilinear or rectilinear elongate protrusions.

An elongate protrusion has a base which is, or which faces and is juxtaposed with, the inner surface of the drum. The elongate protrusion preferably also has an apex which is defined herein as the region of the elongate protrusion which is closer (relative to the base of the elongate protrusion) to the rotational axis of the drum. An elongate protrusion preferably has a substantially triangular cross-section, and thus the apex of such an elongate protrusion is the region of the elongate protrusion which protrudes furthermost into the interior of the drum, i.e. in the direction of the rotational axis of the drum. The term “substantially triangular cross-section”, as used herein, encompasses truncated triangular cross-sections in which the apex of the elongate protrusion has been rounded (i.e. having a smooth or curved surface) or has been flattened so as to provide a trapezoid cross-section. Thus, the term “substantially triangular cross-section”, as used herein, encompasses cross-sections wherein the base of the elongate protrusion is relatively broader than the apex of the elongate protrusion, and wherein said apex may be rounded or flattened.

Optionally, an elongate protrusion may comprise one or more perforations which have dimensions smaller than the shortest linear dimension of the solid particulate material so as to permit passage of fluids through said perforations but to prevent passage of said solid particulate material through said perforations.

The elongate protrusions are configured to facilitate flow of solid particulate material between the storage means and the interior of the drum.

The flow of solid particulate material from the interior of the drum to the storage means is facilitated by apertures which are referred to herein as “collecting apertures” and “harvesting apertures”. A “collecting aperture” is defined as an aperture which is disposed in the first side of said elongate protrusion, wherein the first side is the leading side of said elongate protrusion during rotation of the drum in the collecting direction. Thus, the collecting apertures function to collect solid particulate material from the interior of the drum during rotation of the drum in said collecting direction. A “harvesting aperture” is an aperture in the second side of said elongate protrusion, wherein the second side is the leading side of said elongate protrusion during rotation of the drum in the dispensing direction. The harvesting apertures function to collect solid particulate material from the interior of the drum during rotation of the drum in a dispensing direction. The harvesting apertures are in fluid communication with a harvesting flow path, which is also referred to herein as a “herringbone” flow path and described in further detail below.

The flow of solid particulate material from the storage means to the interior of the drum is facilitated by apertures which are referred to herein as “dispensing apertures”.

An elongate protrusion and/or dispensing flow path is preferably configured such that it dispenses solid particulate material from a dispensing aperture when the dispensing aperture is above the horizontal plane bisecting the axis of drum rotation, preferably such that the solid particulate material falls on to the substrate(s) present in the interior of the drum.

Preferred embodiments for the configuration of the collecting and dispensing apertures are described below as Embodiments A and B. The preferred configurations for the harvesting apertures and the herringbone flow paths are applicable to each of Embodiments A and B

In a first embodiment of the present invention, hereinafter referred to as Embodiment A, the elongate protrusions are characterised in that said collecting flow path and said dispensing flow path are partially but not completely coextensive.

Preferably, an elongate protrusion is configured to bias solid particulate material present inside said collecting flow path towards the storage means during rotation of the drum in the collecting direction, and preferably configured to bias solid particulate material present inside the dispensing flow path towards a dispensing aperture during rotation of the drum in the dispensing direction.

Preferably, an elongate protrusion is configured to bias solid particulate material present inside the storage means and/or dispensing flow path towards said dispensing aperture during rotation of the drum in the dispensing direction.

Preferably, the elongate dimension of said elongate protrusion is rectilinear in shape in Embodiment A.

Preferably, an elongate protrusion comprises a plurality of collecting apertures disposed in said first side of said elongate protrusion at a plurality of positions from the proximal end to the distal end thereof.

Preferably, said first side of the elongate protrusion is adapted to bias solid particulate material towards said collecting aperture(s).

For instance, in a preferred embodiment, said collecting aperture(s) have a funnel shape to increase the cross-sectional area at the entry to the collecting flow path and thereby increase the probability of entry of solid particulate material into the collecting flow path.

Additionally or alternatively, the region in said first side of the elongate protrusion between adjacent collecting apertures is angled towards a collecting aperture, thereby encouraging solid particulate material to enter the collecting aperture and collecting flow path during rotation of the drum in a collecting direction.

Optionally, an elongate protrusion may comprise a collecting groove along at least part of said first side of an elongate protrusion, wherein the collecting groove is configured to collect solid particulate material during rotation in a collecting direction, whereupon the solid particulate material is biased towards the collecting aperture(s) during further rotation in a collecting direction. Such a collecting groove is preferably disposed in the elongate protrusion along at least part of the edge of the elongate protrusion where it meets the inner wall of the drum.

A collecting flow path is defined as a flow path of solid particulate material from a collecting aperture to the storage means. A collecting aperture defines the start of a collecting flow path. Solid particulate material enters the collecting flow path from the interior of the drum via a collecting aperture. A collecting flow path is in fluid communication with the storage means. Optionally, a valve separates a collecting flow path and the storage means, but preferably there is no valve separating a collecting flow path and the storage means.

The collecting flow path preferably comprises a chain of open compartments located in the elongate protrusion and configured to bias solid particulate material present inside the collecting flow path towards said storage means during rotation of the drum in a collecting direction.

In a preferred embodiment, the collecting flow path comprises an Archimedean screw arrangement which is located in the elongate protrusion. As the drum is rotated in the collecting direction, the solid particulate material within the collecting flow path is urged by the internal surfaces of the Archimedean screw along the collecting flow path and towards the storage means. Thus, as a result only of the rotation of the drum, the solid particulate material may be conveyed from the collecting aperture and/or collecting flow path to the storage means.

Preferably, each screw pitch of said Archimedean screw arrangement is associated with a collecting aperture. Similarly, each open compartment in said chain of open compartments is associated with a collecting aperture.

In the preferred embodiment wherein an elongate protrusion has a plurality of collecting apertures, an elongate protrusion preferably comprises a plurality of collecting flow paths. Preferably, each of said collecting flow paths starts at one of said plurality of collecting apertures and then unites with the other collecting flow paths to form a single common collecting flow path in said elongate protrusion, wherein said single common collecting flow path is in fluid communication with said storage means. Preferably, said single common collecting flow path comprises a chain of open compartments or Archimedean screw arrangement as described hereinabove.

A dispensing aperture is preferably located in an elongate protrusion at its distal end or closer to its distal end than its proximal end. A dispensing aperture in an elongate protrusion may alternatively be located from about half way along the elongate protrusion from the proximal end thereof to the distal end thereof.

An elongate protrusion may have a plurality of dispensing apertures, which are suitably spaced along the length of the elongate protrusion from its proximal end to its distal end, and such embodiments promote more even distribution of the solid particulate material into the drum.

A dispensing flow path is defined as a flow path of solid particulate material from said storage means to a dispensing aperture. A dispensing aperture defines the end of a dispensing flow path. Solid particulate material exits a dispensing flow path and enters the interior of the drum via a dispensing aperture. A dispensing flow path is in fluid communication with the storage means, and preferably there is no valve between a dispensing flow path and the storage means.

The dispensing flow path preferably comprises a chain of open compartments located in the elongate protrusion and configured to bias solid particulate material present inside the storage means and/or dispensing flow path towards said dispensing aperture during rotation of the drum in a dispensing direction.

In a preferred embodiment, the dispensing flow path comprises a chain of open compartments or an Archimedean screw arrangement which is located in the elongate protrusion. As the drum is rotated in the dispensing direction, the solid particulate material within the dispensing flow path is urged by the internal surfaces of said chain of open compartments or Archimedean screw arrangement along the dispensing flow path and towards the dispensing aperture, and then into the interior of the drum. Thus, as a result only of the rotation of the drum, the solid particulate material may be conveyed from the storage means back to the interior of the drum.

In the embodiment wherein an elongate protrusion has a plurality of dispensing apertures, an elongate protrusion preferably comprises a plurality of dispensing flow paths. Preferably, said plurality of dispensing flow paths starts at said storage means in the form of a shared single common dispensing flow path in said elongate protrusion and then divides into separate dispensing flow paths wherein each of said separate dispensing flow paths terminates in a dispensing aperture, wherein said single common dispensing flow path is in fluid communication with said storage means and each of said separate dispensing flow paths. Preferably, said single common dispensing flow path comprises a chain of open compartments or Archimedean screw arrangement as described hereinabove.

Thus, preferably movement of said solid particulate material between the storage means and the interior of the drum is actuated entirely by rotation of the drum. It will be appreciated that the term “actuated entirely by rotation of the drum” means that said movement of said particulate material is effected by the rotation of the drum and may also be affected by gravity. In particular, it will be appreciated that the term “actuated entirely by rotation of the drum” means that said movement of said solid particulate material between the storage means and the interior of the drum does not require a pump.

In the apparatus of Embodiment A of the present invention, a collecting flow path and a dispensing flow path are partially but not completely coextensive. In other words, a portion (but not the entirety) of a collecting flow path occupies the same space as a portion of a dispensing flow path. In particular, a portion (but not the entirety) of a collecting flow path and a portion of a dispensing flow path preferably share a common internal flow path within said elongate protrusion. Said common internal flow path is suitably configured to bias solid particulate material present inside said common internal flow path towards the storage means during rotation of the drum in the collecting direction and towards a dispensing aperture during rotation of the drum in the dispensing direction. Preferably, said common internal flow path is or comprises a chain of open compartments or an Archimedean screw arrangement as described hereinabove, and preferably an Archimedean screw arrangement, located in the elongate protrusion.

Preferably, the flow of solid particulate material within the common internal flow path describes a substantially helical path during rotation of the drum in each of the collecting and dispensing directions. Thus, during rotation of the drum in the collecting direction, solid particulate material is transferred towards the proximal end of the elongate protrusion in a substantially helical flow path within said chain of open compartments or Archimedean screw arrangement. Similarly, during rotation of the drum in the dispensing direction, solid particulate material is transferred towards the distal end of the elongate protrusion in a substantially helical flow path within said chain of open compartments or Archimedean screw arrangement.

Thus, a collecting flow path preferably extends from a collecting aperture through said common internal flow path to the storage means. Preferably, a collecting flow path comprises a first portion which is in fluid communication with a collecting aperture and said common internal flow path. Said first portion of a collecting flow path is defined by a collecting aperture at one end of said first portion and a transferring aperture at the other end of said first portion wherein said transferring aperture facilitates the transfer of solid particulate material from said first portion to said common internal flow path during rotation of the drum in the collecting direction. Preferably, said first portion facilitates the flow of solid particulate material into said common internal flow path during rotation of the drum in a collecting direction.

In the preferred embodiment wherein an elongate protrusion has a plurality of collecting apertures, an elongate protrusion preferably comprises a plurality of collecting flow paths and each of said collecting flow paths in said elongate protrusion comprises a first portion as described hereinabove, wherein each of said first portions is in fluid communication with said common internal flow path. Thus, said plurality of collecting flow paths comprises a plurality of first portions and further comprises a single second portion which is the common internal flow path as described above.

Preferably, said first portion of a collecting flow path is located within a wall of said Archimedean screw arrangement, or within a wall of one of said chain of open compartments.

Preferably, said first portion of a collecting flow path is equipped with a plurality of vanes (or baffles) which permit flow of solid particulate material from the collecting aperture to the transferring aperture but discourage flow of solid particulate present in said first portion back out of the collecting aperture. Said plurality of vanes preferably comprises a first series of vanes and a second series of vanes, wherein said first and second series of vanes are disposed along at least part of the length of said first portion of a collecting flow path, wherein said first series of vanes is disposed in an opposing and staggered arrangement with said second series of vanes. Thus, said first series of vanes is disposed on a first internal wall of said first portion of a collecting flow path, and said second series of vanes is disposed on second internal wall of said first portion of a collecting flow path, wherein said first and second internal walls face each other. The vanes of each series are advantageously angled away from an internal wall of said first portion in the direction of flow of solid particulate from the collecting aperture to the transferring aperture, thereby permitting flow of solid particulate material from the collecting aperture to the transferring aperture but discouraging flow in the opposite direction. The vanes of the first series are preferably angled away from the first internal wall by a substantially common angle relative to the first internal wall. The vanes of the second series are preferably angled away from the second internal wall by a substantially common angle relative to the second internal wall. The common angle of the first series of vanes is preferably substantially the same as the common angle of the second series of vanes. Preferably the vanes of said first and second series extend into said first portion of a collecting flow path by a distance which is sufficient to prevent linear flow (i.e. flow in a single straight line) of solid particulate material between the collecting and transferring apertures. Thus, the first series of vanes is advantageously configured in an interlocking but non-contacting arrangement with the second series of vanes. It will be appreciated that the term “interlocking”, as used herein, is not intended to imply any contact between the respective vanes, and not intended to imply any correspondence in shape or fit between opposing vanes. Said first and second series of vanes thereby provide a tortuous pathway from a collecting aperture to a transferring aperture which biases solid particulate material towards the common internal flow path during rotation of the drum. This configuration of a first portion of a collecting flow path may be used in association with any of the configurations of the common internal flow path described hereinbelow but it is of particular utility in association with the peripheral entry embodiments, and particularly in association with the third configuration of the peripheral entry embodiment.

Similarly, a dispensing flow path preferably extends from said storage means through said common internal flow path to a dispensing aperture. Preferably, a dispensing flow path comprises a first portion which is said common internal flow path and a second portion which is in fluid communication with a dispensing aperture and said common internal flow path.

In the embodiment wherein an elongate protrusion has a plurality of dispensing apertures, an elongate protrusion may comprise a plurality of dispensing flow paths, wherein each of said dispensing flow paths comprises a first portion which is the common internal flow path described hereinabove and further comprises a second portion which is in fluid communication with a dispensing aperture and said common internal flow path. Thus, said plurality of dispensing flow paths comprises a single first portion which is the common internal flow path as described above and further comprises a plurality of second portions as described above.

Preferably, said transferring aperture is configured such that rotation of the drum in either the collecting or dispensing direction biases solid particulate material which is present in said common internal flow path away from said transferring aperture.

Preferably, the dimensions of said transferring aperture are small enough to discourage flow of solid particulate material from said common internal flow path into said first portion of a collecting flow path. Preferably, the transferring aperture is located within said common internal flow path such that rotation of the drum in either the collecting or dispensing direction biases solid particulate material present in said common internal flow path away from the transferring aperture.

Preferably, the largest dimension of the transferring aperture is no more than 8 times, preferably no more than 7 times, preferably no more than 6 times, preferably no more than 5 times, the longest dimension of the solid particulate material. Preferably, the smallest dimension of the transferring aperture is at least 2 times, preferably at least 3 times, more preferably at least 4 times, the longest dimension of the solid particulate material.

The preferred configuration (including its location within the elongate protrusion and its dimensions) of a transferring aperture is such that it promotes flow from a collecting aperture and/or said first portion of a collecting flow path to the common internal flow path during rotation of the drum in a collecting direction, and such that it minimises or prevents flow from the common internal flow path to a collecting aperture or said first portion of a collecting flow path during rotation of the drum in either of the collecting direction or the dispensing direction, In other words, the preferred configuration is such that the flow of solid particulate material through the transferring aperture is unidirectional which, as used herein, means that once solid particulate material has entered the common internal flow path it does not or is unlikely to exit the elongate protrusion via a transferring aperture during rotation of the drum in either the collecting direction or the dispensing direction.

There are a variety of ways that said elongate protrusion can be configured internally in order to achieve the preferred configuration for a common internal flow path, a collecting flow path, a dispensing flow path and particularly a transferring aperture

Preferably, a transferring aperture is associated with a deflector rib around at least part (and preferably all) of its periphery, wherein said deflector rib projects into the common internal flow path and biases solid particulate material away from the transferring aperture during rotation of the drum in either the collecting or dispensing direction. The distance by which a deflector rib projects into the common flow path may vary around the periphery of the transferring aperture. Preferably, a deflector rib projects a distance which is at least equal to the longest dimension of the solid particulate material, and preferably at least 2 times, preferably at least 3 times the longest dimension of the solid particulate material.

In a preferred embodiment, referred to herein as “central entry”, solid particulate material flows from a collecting aperture into the common internal flow path such that said material arrives at a location which is approximately central within the common internal flow path. Thus, preferably, said transferring aperture is located approximately centrally within the common internal flow path.

In the central entry embodiment, said transferring aperture is preferably in a different plane to the plane of its associated collecting aperture, and is preferably substantially perpendicular, wherein the term “substantially perpendicular” in this context means that the planes defined by the cross-sectional area of the respective apertures make an angle with each other which is greater than 50°, preferably greater than 60°, preferably greater than 70°. In this embodiment, the plane defined by the cross-sectional area of the transferring aperture is preferably substantially parallel with the tangential plane of the base of the elongate protrusion in which it is located, i.e. the portion of said elongate protrusion which is juxtaposed with the inner wall of the drum, wherein the term “substantially parallel” in this context means that the respective planes make an angle with each other which is less than 30°, preferably less than 2020 , preferably less than 10°, preferably less than 5°. In this embodiment, the cross-sectional area of the collecting aperture is preferably co-planar with the first side of the elongate protrusion in which it is located, i.e. the leading side of said elongate protrusion when the drum is rotated in a collecting direction. The preferred substantially perpendicular relationship of said planes assists in minimising or preventing flow of solid particulate material present in said common internal flow path to the interior of the drum during rotation of the drum, particularly during rotation in a dispensing direction.

In this central entry embodiment, preferably said first portion of a collecting flow path is partially disposed at the base of an elongate protrusion, preferably wherein said first portion extends along at least 20%, preferably at least 30%, preferably at least 40%, and preferably no more than 70%, preferably no more than 60%, preferably no more than 50% of the base of the elongate protrusion. Said first portion of a collecting flow path may be characterised as having a first section, which is the section of said first portion nearest the collecting aperture, and a second portion which is the section of said first portion nearest the transferring aperture. Preferably, the first section of said first portion is disposed at the base of an elongate protrusion as described immediately above, and preferably at least 50%, preferably at least 60%, preferably at least 70%, preferably at least 80% of the length of said first portion is disposed at the base of an elongate protrusion in this way. Said first portion is preferably configured to bias the flow of solid particulate material towards the transferring aperture during rotation of the drum in a collecting direction, for instance by having curved or inclined surfaces which extend from said first section of said first portion in a direction away from the base of said elongate protrusion and towards the centre of said common internal flow path, for instance wherein said inclined surfaces define an angle of at least 20°, preferably at least 30°, preferably at least 45° with the base of the elongate protrusion. Such curved or inclined surfaces may be present in the second section, or in said second section and said first section.

In this central entry embodiment, said second section of said first portion of a collecting flow path is preferably disposed at an angle β to said first section of said first portion, when viewed from a position which is normal to the base of the elongate protrusion, such that said second section directs the first portion of said collecting flow path towards the proximal end of the elongate protrusion, i.e. towards the end wall of the drum and towards the storage means. Preferably β is from about 100° to about 170°, preferably from about 120° to about 150°, and may vary with or depend upon, for instance, the size of the elongate protrusion and the pitch of the Archimedean screw. Such a configuration assists in the biasing of solid particulate material towards the storage means during rotation of the drum in a collecting direction.

In a further preferred embodiment, referred to herein as “peripheral entry”, said transferring aperture is located at the periphery of the common internal flow path. In this embodiment, said deflector rib preferably comprises a first deflector rib portion which biases solid particulate material away from the transferring aperture during rotation of the drum in either the collecting or dispensing direction, and preferably said first deflector rib portion is located such that it is adapted particularly to bias solid particulate material away from the transferring aperture during rotation of the drum in the dispensing direction. Said deflector rib preferably further comprises a second deflector rib portion which biases solid particulate material away from the transferring aperture during rotation of the drum in either the collecting or dispensing direction, and preferably said second deflector rib portion is located such that it is adapted particularly to bias solid particulate material away from the transferring aperture during rotation of the drum in in the collecting direction. Preferably, said first deflector rib portion and/or said second deflector rib portion projects into the common internal flow path in a direction which is substantially perpendicular to the internal wall of the common internal flow path. Preferably, said first deflector rib portion projects into the common internal flow path further than said second deflector rib portion. Thus, solid particulate material which is following a peripheral trajectory inside the common internal flow path during rotation of the drum in either direction hits a deflector rib portion (and particularly said first or second deflector rib portion), whereupon its peripheral trajectory is perturbed such that the solid particulate material is deflected away from the transferring aperture, and away from the section of the periphery in which is disposed the transferring aperture, for instance towards the centre of the common internal flow path.

It will be appreciated that, in the peripheral entry embodiment, the transferring aperture is preferably disposed substantially tangentially to the internal wall of the common internal flow path, which is particularly applicable for a common internal flow path which is or comprises an Archimedean screw arrangement. Where the common internal flow path is or comprises a rectilinear chain of open of compartments, the transferring aperture in this embodiment is preferably disposed substantially co-planar with the internal wall of the common internal flow path.

In the peripheral entry embodiment, said first portion of a collecting flow path preferably follows part of the periphery of the common internal flow path until said first portion opens into the common internal flow path at the transferring aperture.

In the peripheral entry embodiment, the transferring aperture may comprise vanes or louvres which extend across the cross-sectional area of said aperture, so that said transferring aperture becomes a plurality of slits. Such vanes or louvres preferably extend in substantially the same direction as the elongate protrusion and/or the axis of the drum wherein the term “substantially the same direction” in this context means that the vanes or louvres aperture make an angle with the axis of the drum which is less than 40°, preferably less than 30°, preferably less than 20°, preferably less than 10°, and preferably less than 5°. The plurality of slits are suitably wide enough to avoid blockage by solid particulate material and maintain flow, preferably wherein the narrowest dimension of a slit is at least 2 times, preferably at least 3 times, preferably at least 4 times the longest dimension of solid particulate material. The vanes or louvres advantageously improve the direction of entry of solid particulate material into the common internal flow path during rotation of the drum in a collecting direction, and further minimise the possibility of entry of solid particulate material into said first portion of a collecting flow path during rotation of the drum in a dispensing direction.

In a first configuration of the peripheral entry embodiment, said transferring aperture is located in the periphery of the common internal flow path at a position which is closer to the second side of the elongate protrusion than to the first side of the elongate protrusion, wherein the second side is the trailing side of the elongate protrusion during rotation of the drum in a collecting direction. Thus, in this first configuration, a transferring aperture is located at or near the side of the elongate protrusion which is opposite to the side where the collecting aperture is located. In this first configuration, said first portion of a collecting flow path is preferably disposed at the base of an elongate protrusion, i.e. the portion of an elongate protrusion which is juxtaposed with the inner wall of the drum, preferably wherein said first portion of a collecting flow path extends along at least 50%, preferably at least 60%, preferably at least 70% of the base of the elongate protrusion.

In this first configuration of the peripheral entry embodiment, solid particulate material preferably enters the common internal flow path from the transferring aperture in a direction (A) which is substantially opposite to the direction (B) in which solid particulate material enters the collecting aperture from the interior of the drum, wherein directions (A) and (B) are relative to each other in the context of the structure of the elongate protrusion rather than in the context of the absolute position of the elongate protrusion in space (which of course changes during rotation of the drum). It will be appreciated that, at the point of entry of solid particulate material into the collecting aperture, direction (B) is opposite to the collecting direction.

In this first configuration of the peripheral entry embodiment, a transferring aperture and its associated collecting aperture are preferably substantially parallel, wherein the term “substantially parallel” in this context means that the planes defined by the cross-sectional area of the respective apertures make an angle with each other which is less than 40°, preferably less than 30°, preferably less than 20°, preferably less than 10°.

In a second configuration of the peripheral entry embodiment, said transferring aperture is located in the periphery of the common internal flow path at a position which is closer to the first side of the elongate protrusion than to the second side of the elongate protrusion, wherein the second side is the trailing side of the elongate protrusion during rotation of the drum in a collecting direction. Thus, in this second configuration, a transferring aperture is located at or near the side of the elongate protrusion where the collecting aperture is located. In this second configuration, said first portion of a collecting flow path is preferably disposed along the first side of an elongate protrusion, preferably wherein said first portion of a collecting flow path extends along at least 30%, preferably at least 40%, preferably at least 50% of the first side of the elongate protrusion.

In this second configuration of the peripheral entry embodiment, said first portion of a collecting flow path is S-shaped. Thus, solid particulate material preferably enters the common internal flow path from the transferring aperture in a direction (A) which is in substantially the same direction (B) in which solid particulate material enters the collecting aperture from the interior of the drum wherein, as for the first configuration, directions (A) and (B) are relative to each other in the context of the structure of the elongate protrusion rather than in the context of the absolute position of the elongate protrusion in space (which of course changes during rotation of the change). It will be appreciated that, as for the first configuration, at the point of entry of solid particulate material into the collecting aperture, direction (B) is opposite to the collecting direction.

In this second configuration of the peripheral entry embodiment, a transferring aperture and its associated collecting aperture are preferably substantially parallel, as for the first configuration.

This second configuration is particularly advantageous since the more convoluted first portion of the collecting path further minimises the possibility of egress of solid particulate material from a collecting aperture during rotation of the drum in a dispensing direction.

In a third configuration of the peripheral entry embodiment, a transferring aperture is located at the periphery of the common internal flow path at a position in the periphery of the common internal flow path which is relatively more distal to the inner surface of the drum and relatively more proximal to the rotational axis of the drum. Preferably, said transferring aperture is located at the periphery of the common internal flow path at the position in the periphery of the common internal flow path which is most distal to the inner surface of the drum and most proximal to the rotational axis of the drum. Thus, in this configuration, the transferring aperture is preferably located approximately equidistant between the first and second sides of the elongate protrusion. In other words, the transferring aperture in this configuration is preferably located at the periphery of the common internal flow path which is nearest the apex of the elongate protrusion and nearest the rotational axis of the drum. This third configuration is particularly advantageous since it allows both centrifugal force and gravity to assist entry of the solid particulate material into the common internal flow path.

In the third configuration, a transferring aperture is preferably associated with a deflector rib around at least part (and preferably all) of its periphery, as described hereinabove. Preferably, said deflector rib comprises a first deflector rib portion which biases solid particulate material away from the transferring aperture during rotation of the drum in the collecting direction, and further comprises a second deflector rib portion which biases solid particulate material away from the transferring aperture during rotation of the drum in the dispensing direction. Thus, solid particulate material which is following a peripheral trajectory inside the common internal flow path during rotation of the drum in either direction hits a deflector rib portion, whereupon its peripheral trajectory is perturbed such that the solid particulate material is deflected away from the transferring aperture, and away from the section of the periphery in which is disposed the transferring aperture, for instance towards the centre of the common internal flow path. Preferably, said first and second deflector rib portions project into the common internal flow path such that each deflector rib portion presents a deflecting surface which is continuous with, but angled relative to, the internal peripheral wall of the common internal flow path such that the angle of the deflecting surface relative to said internal peripheral wall is greater than 90° and typically no more than about 150° (preferably from about 100 to about 130°). Preferably, said first and second deflector rib portions project into the common internal flow path by an approximately similar distance to each other.

In this third configuration, a transferring aperture is preferably defined by a slot in the internal wall of the common internal flow path wherein said slot extends between opposing internal surfaces of said Archimedean screw arrangement or chain of open compartments. In this preferred embodiment, the transferring aperture is preferably associated with first and second deflector rib portions which extend between opposing internal surfaces of said Archimedean screw arrangement or chain of open compartments and in a direction which is substantially parallel with the elongate dimension of the elongate protrusion.

In this third configuration, the core of the Archimedean screw may be disposed centrally or eccentrically. In an eccentric arrangement, the core is disposed closer to the periphery of the common internal flow path proximal to the inner wall than the periphery of the common internal flow path proximal to the rotational axis of the drum. An eccentric arrangement advantageously improves the balance of Archimedean screw.

Particularly in the peripheral entry embodiment, and especially in the third configuration thereof described hereinabove, the collecting aperture may be a slot which extends along at least a part and preferably all of said first side of said elongate protrusion. Such a collecting aperture is preferably disposed in said first side of said elongate protrusion at the base of said elongate protrusion, i.e. the portion of an elongate protrusion which is juxtaposed with the inner wall of the drum. Such a collecting aperture is in fluid communication with a plurality of collecting flow paths, each of which has a first flow portion as defined hereinabove which is in fluid communication with the common internal flow path via a transferring aperture as defined hereinabove. Such a collecting aperture advantageously maximises the collection rate of solid particulate material from the interior of the drum.

Where the collecting aperture is a slot, a series of vertical guide ribs is preferably disposed in front of said slot, thereby defining a series of collecting channels which are in fluid communication with the interior of the drum and said slot. It will be appreciated that the term “in front of” in this context means that the vertical guide ribs are disposed between the slot and the interior of the drum. Said vertical guide ribs suitably extend in a direction substantially parallel to the collecting and dispensing directions defined herein. Said vertical guide ribs suitably extend substantially perpendicularly from the inner wall of the drum to the first side of the elongate protrusion. Said vertical guide ribs are suitably planar. Said vertical guide ribs are preferably shaped so that the leading edge of each rib (i.e. the leading edge of the rib when the drum is rotated in a collecting direction) is angled away from the inner surface of the drum and towards the apex of the elongate protrusion (i.e. the portion of the elongate protrusion which is proximal to the rotational axis of the drum). The vertical guide ribs assist in the capture and transfer of solid particulate material from the interior of the drum to the collecting aperture.

In a further embodiment of the internal configuration of said elongate protrusion, referred to herein as the “double helix embodiment”, said common internal flow path and said first portion of a collecting flow path are arranged as a double helical Archimedean screw, or as a first chain and second chain of open compartments, as described hereinabove, and are preferably as a double helical Archimedean screw. In this embodiment, the common internal flow path is in helical juxtaposition with said first portions of said collecting paths along the elongate protrusion. Similarly, said first chain of open compartments is in substantially helical juxtaposition with said second chain of open compartments. The common internal flow path preferably occupies more of the internal volume of the elongate protrusion relative to said first portions of said collecting paths, and preferably at least 1.5 times more, preferably at least 2.0 times more, preferably at least 2.5 times more, preferably not more than 4.0 times more, preferably not more than 3.0 times more volume than the total volume of said first portions of said collecting paths. Preferably, the common internal flow path occupies at least 55%, preferably at least 60%, preferably not more than 90%, preferably not more than 80%, preferably not more than 75% of the internal volume of the elongate protrusion. In this embodiment, solid particulate material flows from a collecting aperture into the common internal flow path such that said material arrives at a location which is approximately central within the common internal flow path. Thus, preferably, said transferring aperture is located approximately centrally within the common internal flow path.

Preferably, the common internal flow path is constituted by the walls of a series of separate modular sections, preferably wherein each of said modular sections comprises a collecting aperture, a first portion of a collecting flow path and a transferring aperture as defined hereinabove, wherein said series of separate modular sections, when joined together, form at least some of the boundary walls of the common internal flow path. Preferably, said modular sections form the internal walls of the elongate protrusion, i.e. the walls of the common internal flow path, rather than the outer walls of the elongate protrusion which contact the substrates in the interior of the drum. A modular arrangement has the advantage of easier and more economic manufacturing, for instance by injection moulding. Preferably the modular sections in this embodiment are joined together linearly, preferably by means of a tie-bar which extends from the first to the last modular section. The assembly comprising the tie-bar and joined modular sections are suitably covered by the outer skin of the elongate protrusion (typically a stainless steel outer skin), which extends from the proximal end to the distal end thereof. Thus, the tie bar is suitably located within the elongate protrusion, preferably within the lobe of an elongate protrusion which is most remote from the inner surface of the drum, or juxtaposed with the trailing edge of the elongate protrusion during rotation of the drum in the collecting direction.

Said Archimedean screw may be motorised but preferably the inner surfaces of the Archimedean screw are static, relative to the inner wall of the drum, i.e. the inner surfaces of the Archimedean screw preferably do not rotate independently of the rotation of the drum.

The inner surfaces of the Archimedean screw suitably have a conventional circular and/or smooth arrangement. Alternatively or additionally, the Archimedean screw is rectilinear, having stepped surfaces along at least a part of its length. Similarly, while the cross-section of an Archimedean screw is suitably circular, other cross-sections are envisaged, and particularly multi-lobal cross-sections, such as tri-lobal or quadri-lobal. A tri-lobal cross-section is of particular utility because the elongate protrusions within which the Archimedean screw is disposed are typically triangular in cross-section; hence a tri-lobal cross-section for the Archimedean screw makes the best possible use of the space available inside the elongate protrusion. Rectilinear arrangements are of particular utility because the elongate protrusion may be manufactured in multiple pieces and assembled together to form the flow paths discussed hereinabove in the elongate protrusion. Suitable manufacturing processes include injection moulding.

In another preferred embodiment, referred to herein as the paternoster configuration, said chain of open compartments located in the elongate protrusion are formed by a first series of inclined vanes substantially parallel to each other and a second series of inclined vanes substantially parallel to each other, wherein said first and second series are disposed along at least part of the length of the interior of the elongate protrusion, wherein said first series of vanes are disposed in a facing arrangement to said second series of vanes, wherein said first series of vanes are not parallel to said second series of vanes, and wherein the compartments and vanes are configured to bias solid particulate material present inside the storage means and/or dispensing flow path towards a dispensing aperture during rotation of the drum in a dispensing direction, and configured to bias solid particulate material present inside a collecting flow path towards said storage means during rotation of the drum in a collecting direction.

In a further preferred embodiment, said chain of open compartments, or said common internal flow path, is formed by opposing and offset saw-tooth surfaces configured to bias solid particulate material present inside the storage means and/or dispensing flow path towards said dispensing aperture during rotation of the drum in a dispensing direction, and configured to bias solid particulate material present inside a collecting flow path towards said storage means during rotation of the drum in a collecting direction.

In a second embodiment of the present invention, hereinafter referred to as Embodiment B, the elongate protrusion comprises a dispensing flow path and a collecting flow which are different flow paths, as described in the present applicant's co-pending PCT/GB/2017/053815 application.

In Embodiment B, said collecting aperture is preferably located in said elongate protrusion at its proximal end. Optionally, the elongate protrusion may comprise a collecting groove along at least part of said first side thereof, wherein the collecting groove is configured to collect solid particulate material during rotation in a collecting direction, whereupon the solid particulate material is biased towards the collecting aperture during further rotation in a collecting direction. Such a collecting groove is preferably disposed in the elongate protrusion along at least part of the edge of the elongate protrusion where it meets the inner wall of the drum.

In Embodiment B, the elongate protrusion(s) and/or the drum are preferably configured to bias solid particulate material present inside the drum towards the collecting flow path, and particularly towards the end wall, during rotation of the drum in a collecting direction.

In a preferred arrangement of Embodiment B, the elongate dimension of said elongate protrusion is curvilinear and configured to bias said solid particulate material towards said collecting aperture located in the elongate protrusion at its proximal end during rotation of the drum in a collecting direction. A curvilinear elongate protrusion which has a spiral or helical geometry is preferred. It will be appreciated that the term “spiral or helical spiral ” geometry” refers to a three dimensional spiral curve which also encompasses an arc of a complete spiral or helical spiral curve. The use of curvilinear elongate protrusions are of particular utility for apparatus in which the axis of the drum is substantially horizontal during operation of the apparatus.

In a further preferred arrangement of Embodiment B, the elongate dimension of said elongate protrusion is rectilinear. In this arrangement, preferably the apparatus and/or drum is tilted or tillable, as described hereinabove, such that the bias which encourages solid particulate material present inside the drum towards the collecting flow path, and particularly towards the end wall, during rotation of the drum in a collecting direction is provided in part by the tilt of the drum

In Embodiment B, the elongate protrusions may be configured to bias solid particulate material towards a collecting flow path and/or the end wall during rotation of the drum in a collecting direction in ways which are additional or alternative to those described above.

Thus, in one preferred configuration of Embodiment B, hereinafter referred to as the “flow-under” configuration, an elongate protrusion is disposed on the inner surface of the drum such that one or more angled channels are present between the underside of the elongate protrusion and the inner surface of the drum, or are present through an elongate protrusion at one or more position(s) where the elongate protrusion meets the inner surface of the drum so that one boundary wall of the angled channel presents a surface which is continuous with the inner surface of the drum. The angled channels allow solid particulate material to flow underneath or through the elongate protrusion such that during rotation of the drum in a collecting direction, the exit point of an angled channel is closer to the end-wall of the drum than the entry point of that angled channel. The entry point of an angled channel is located on a first side of an elongate protrusion and the exit point of an angled channel is located on the opposite, second side of an elongate protrusion. During rotation of the drum in a collecting direction, solid particulate material is biased towards an entry point in the first side of a first elongate protrusion, passes through the angled channel, and exits from the exit point in the angled channel on the second side of the first elongate protrusion. In so doing, the solid particulate material becomes closer to the end-wall of the drum and, hence, closer to the collecting pathway present in the next elongate protrusion which said solid particulate material contacts on its trajectory inside the drum during rotation of the drum in a collecting direction, i.e. a second elongate protrusion which is spaced apart from the first elongate protrusion on the inner surface of the drum, thereby improving the collecting efficiency of the solid particulate material. One or more angled channels may be associated with each elongate protrusion, and where a plurality of angled channels are associated with a single elongate protrusion, they may be disposed along all or part of the length of the elongate protrusion. The angled channel is preferably disposed underneath or in the elongate protrusion such that the channel defines an angle with the back-wall of the drum of at least about 10°, preferably at least about 20°, preferably at least about 30°, and no more than about 80°, preferably no more than 70°, preferably no more than about 60°, typically no more than about 50°. Preferably, the angle of the channel is defined herein as a straight line between the entry point and the exit point of the channel. The pathway of the channel may have a rectilinear or curvilinear configuration, and for instance may be straight or curved, and is typically straight. Where the pathway is curved, the channel preferably curves towards the end-wall of the drum. The flow-under embodiment may be used where the rotational axis of the drum is substantially horizontal, tilted or tiltable during operation of the apparatus, but is of particular utility for apparatus in which the rotational axis of the drum is substantially horizontal.

In Embodiment B, the drum, and particularly the inner surface thereof, may be configured to bias solid particulate material towards the collecting flow path and/or the end wall during rotation of the drum in a collecting direction in ways additional or alternative to those described above. In particular, the inner surface of the drum may be textured or contoured, for instance by virtue of guiding elements affixed thereto or formed integrally therewith, in order to increase the bias of solid particulate material towards the collecting flow path and/or the end-wall of the drum during rotation of the drum in a collecting direction. Such guiding elements are intended, and adapted, to encourage flow of solid particulate material towards the end-wall of the drum and are hence differentiated from the elongate protrusions or lifters, the primary purpose of which is to encourage agitation of the substrates to be treated with the solid particulate material and any treatment agents and/or liquid medium. Accordingly, guiding elements are significantly smaller in depth than elongate protrusions, wherein “depth” refers to the maximum height above or below the inner surface of the drum. Thus, guiding elements which are proud of the inner surface of the drum extend into the interior of the drum much less than elongate protrusions. Preferably, the depth of a guiding element is defined with reference to the longest dimension of the solid particulate material, and preferably the depth of a guiding element has a dimension which is at least as large as the longest dimension of the solid particulate material, preferably at least twice, and preferably no more than about 5 times, preferably no more than about 4 times, the size of the longest dimension of the solid particulate material. Preferably, the depth of a guiding element is no more than 90%, preferably no more than 80%, preferably no more than 70%, preferably no more than 60%, preferably no more than 50%, preferably no more than 40%, preferably no more than 30%, preferably no more than 20% of the depth of an elongate protrusion, and preferably at least 1%, preferably at least 5% of the depth of an elongate protrusion.

One useful embodiment of a guiding element comprises one or more ribs which are disposed on the inner surface of the drum. In a further useful embodiment, a guiding element comprises one or more grooves which are disposed in the inner surface of the drum. Said one or more rib(s) and/or said one or more groove(s) are preferably disposed between adjacent elongate protrusions. Advantageously, the ribs or grooves are angled in a manner which directs solid particulate material away from the front of the drum (and away from a first elongate protrusion) and towards the end-wall of the drum (and towards a second elongate protrusion spaced apart from said first elongate protrusion) during rotation of the drum in a collecting direction. The ribs or grooves may extend across the inner surface for the whole or part of the distance between adjacent elongate protrusions, but typically the ribs or grooves extend across the inner surface for only part of the distance between adjacent elongate protrusions, and typically from about 5% to about 95%, or from about 10% to about 80%, of the distance between adjacent elongate protrusions. Thus, the ribs or grooves bias the solid particulate material towards the end wall during rotation of the drum in a collecting direction. The ribs or grooves are disposed at an angle to the end walls, and at an angle to the elongate protrusions, wherein said angle is neither parallel nor perpendicular to the end wall or to an elongate protrusion. In particular, the ribs or grooves are disposed such that the leading end of a rib or groove during rotation of the drum in a collecting direction is closer to the front of the drum than the trailing end of said rib or groove during rotation of the drum in a collecting direction. A rib or groove preferably defines an angle with the end wall of the drum of at least about 10°, preferably at least about 20°, preferably at least about 30°, and no more than about 80°, preferably no more than 70°, preferably no more than about 60°, typically no more than about 50°. Preferably, the angle of the rib or groove is defined herein as a straight line between the start of the rib or groove and the end of the rib or groove. The ribs or grooves on or in the inner surface of the drum may define a straight or curved pathway. It will be appreciated that the inner surface of a cylindrical drum is curved, and so reference herein to a “straight pathway” will be understood as a pathway which follows the curvature of the surface of the drum in a linear manner between two points on said curved inner surface of the drum, and reference herein to a “curved pathway” will be understood as a pathway which follows the curvature of the inner surface of the drum and which is also curved in a further dimension across the inner surface of the drum. Where the pathway is a curved pathway, the rib or groove preferably curves towards the end-wall of the drum. A combination of rib(s) and groove(s) may be used. A plurality of ribs and/or a plurality of grooves may be disposed across an area of the inner surface of the drum which is bounded by the front of the drum and the end-wall of the drum and across an area of the inner surface of the drum which is at least partially bounded by adjacent elongate protrusions. It is preferred that the ribs disclosed in this embodiment are either unperforated or contain no perforations therein which are as big as any dimension of the solid particulate material.

In the aforementioned rib embodiment, the profile of the rib is preferably configured to retain solid particulate material during the biasing thereof towards the end-wall of the drum. Thus, it is preferred that the edge of the rib which is the leading edge during rotation of the drum in a collecting direction comprises a collecting groove which runs at least partially along the length of the rib, and preferably along substantially the whole length of the rib.

A further useful embodiment of a guiding element is a perforated diverting rib disposed on the inner surface of the drum, preferably between adjacent elongate protrusions. A perforated diverting rib is preferably disposed on the inner surface of the drum such that it extends in a direction away from the end-wall of the drum and towards the front of the drum. In other words, a perforated diverting rib generally extends in a direction which is substantially parallel with the rotational axis of the drum and/or substantially parallel with the elongate protrusions. A perforated diverting rib is defined by a first edge which is the leading edge during rotation of the drum in a collecting direction, and a second edge which is the trailing edge during rotation of the drum in a collecting direction. Each of the first and second edges has one or more apertures therein. The perforated diverting rib comprises a plurality of angled channels which connect the aperture(s) on the first edge with the aperture(s) on the second edge. Where the perforated diverting rib meets the inner surface of the drum, the aperture(s) and angled channels are preferably disposed such that one boundary wall of the angled channel (i.e. the base of the channel) presents a surface which is continuous with the inner surface of the drum. These angled channels work on the same principle as the angled channels of the “flow-under ”configuration described hereinabove. The exit point from an angled channel at the second edge of the rib is closer to the end-wall of the drum than the entry point into that angled channel at the first edge of the rib, thereby allowing solid particulate material to flow through the perforated diverting rib so that during rotation of the drum in a collecting direction the solid particulate material is biased towards the end-wall of the drum, thereby improving the collecting efficiency of the solid particulate material. The plurality of angled channels may be disposed along all or part of the length of a perforated diverting rib. The angled channel preferably defines an angle with the back-wall of the drum of at least about 10°, preferably at least about 20°, preferably at least about 30°, and no more than about 80°, preferably no more than 70°, preferably no more than about 60°, typically no more than about 50°. Preferably, the angle of a channel is defined herein as a straight line between the entry point and the exit point of that channel. The pathway of a channel may have a rectilinear or curvilinear configuration, and for instance may be straight or curved, and is typically straight. Where the pathway is curved, the channel preferably curves towards the end-wall of the drum. A perforated diverting rib may be used where the rotational axis of the drum is substantially horizontal, tilted or tiltable during operation of the apparatus, but is of particular utility for apparatus in which the rotational axis of the drum is substantially horizontal.

In Embodiment B, another configuration of the inner surface of the rotatably mounted drum to bias solid particle material towards the end wall of the drum is as follows. Thus, in a preferred configuration of Embodiment B, the inner surface of the drum is inclined such that the surface of the drum defines an angle A′ to the horizontal plane which is greater than 0 and less than about 20°, preferably at least about 1°, preferably at least about 5°, preferably from 1 to 20°, preferably from 1 to 10°, preferably from 5 to 10°. In this configuration, the inner surface of the drum is inclined in a downwards direction from the front of the drum to the end wall of the drum. Thus, the inner surface of the drum defines a frusto-conical surface. The frusto-conical surface thus has a diameter at the front of the apparatus which is smaller than the diameter thereof at the end wall of the drum. It will be appreciated that this configuration is of particular utility wherein the drum is disposed in the apparatus such that the rotational axis of the drum is substantially horizontal, for instance wherein the drum and/or apparatus is not tilted or tiltable. Thus, this configuration biases solid particulate material towards said collecting flow path which comprises said collecting aperture located in said elongate protrusion at its proximal end. In this frusto-conical surface configuration, the inner surface of the drum is preferably configured to define at least one collecting channel in the inner surface at the juncture of the inner surface and the end-wall of the drum. Said collecting channel extends at least partially around the perimeter of the end-wall of the drum, and at least partially between each elongate protrusion. The collecting channel extends along the juncture of the inner surface and the end-wall of the drum to the collecting aperture, and is thus configured to bias solid particulate material towards the collecting aperture during rotation of the drum in a collecting direction. Said at least one collecting channel advantageously improves the collection efficiency of solid particulate material during rotation of the drum in a collecting direction. A frusto-conical inner surface may be assembled inside the drum and/or is able to be retrofitted to an existing drum, particularly where the apparatus comprises a drum in which the rotational axis is fixed in the horizontal plane. Thus, a conventional apparatus which is not suitable or adapted for the treatment of substrates using a solid particulate material may be converted into an apparatus which is suitable for the treatment of substrates using a solid particulate material. Such a frusto-conical surface is preferably provided as a plurality of inserts which may be disposed on the existing surface (typically a cylindrical surface) of the drum of the conventional apparatus. Such a frusto-conical surface is suitably used in combination with the retrofittable storage means and elongate protrusions described herein, and would typically be provided as a non-integral element thereto in order to allow the components to be introduced into the drum without dissembling the whole apparatus.

In Embodiment B, said dispensing aperture is preferably located in said elongate protrusion as described herein for Embodiment A. A plurality of dispensing apertures may be present in the elongate protrusion, as described for Embodiment A.

The dispensing flow path of Embodiment B is configured to bias solid particulate material present inside the storage means and/or dispensing flow path towards the dispensing aperture during rotation of the drum in a dispensing direction. Preferably, the dispensing flow path comprises a chain of open compartments or an Archimedean screw arrangement located in the elongate protrusion and configured to bias solid particulate material present inside the storage means and/or dispensing flow path towards said dispensing aperture during rotation of the drum in a dispensing direction. The configuration of the chain of open compartments or Archimedean screw arrangement is preferably as described hereinabove for the configuration of the dispensing flow path or common internal flow path of Embodiment A. It will be appreciated, however, that in Embodiment B the dispensing flow path is distinct and different from the collecting flow path as noted above, i.e. there is no common internal flow path in Embodiment B.

In a further configuration of the dispensing flow path of Embodiment B, and particularly where the apparatus comprises curvilinear (such as spiral or helical) elongate protrusions, the dispensing flow path may simply be a hollow cavity inside the elongate protrusion. However, this embodiment is less preferred.

In the apparatus of Embodiment B, at least a portion of the collecting flow path may be juxtaposed with at least a portion of the dispensing flow path, wherein said juxtaposed portions are separated by a deflector wall which helps to prevent egress of said solid particulate material from said storage means to the interior of said drum via said collecting flow path and/or which assists in biasing the particles from said storage means towards the dispensing path.

In the apparatus of Embodiment B, the collecting flow path preferably comprises a valve, preferably a one-way flap valve, to prevent egress of said solid particulate material from said storage means to the interior of said drum via said collecting flow path. Advantageously, such a valve helps ensure the storage means is filled as efficiently as possible. The flap valve may be biased with a spring, and/or be mechanically controlled with a cam, and/or be gravity-operated and comprise therein a sufficient weight, in order to prevent egress of solid particulate material from said storage means to the interior of said drum via said collecting flow path.

Thus, just as for Embodiment A, movement of solid particulate material between the storage means and the interior of the drum in Embodiment B is preferably actuated entirely by rotation of the drum.

The configurations of the harvesting apertures and the associated harvesting (or herringbone) flow path will now be described. The configuration is referred to as the “Herringbone” arrangement. As noted above, these configurations are applicable to both Embodiments A and B.

Preferably, said elongate protrusion comprises a plurality of said harvesting apertures disposed in said second side of said elongate protrusion. The harvesting apertures may be located at multiple positions along the second side of said elongate protrusion from the proximal end to the distal end thereof.

As described above, said harvesting aperture(s) are in fluid communication with the storage means via said harvesting flow path. Said harvesting flow path is configured to bias solid particulate material towards the storage means during rotation of the drum in a dispensing direction and preferably also in a collecting direction. Said harvesting flow path is configured to bias solid particulate material towards the storage means particularly during rotation of the drum in a dispensing direction. Thus, said harvesting flow path is configured to bias solid particulate material towards the storage means during rotation of the drum in either direction once the solid particulate material is present in the harvesting flow path, which is of particular utility for rotation of the drum in a dispensing direction.

Preferably said harvesting flow path defines a tortuous flow path from the harvesting aperture(s) to the storage means.

It will be appreciated that the harvesting flow path is distinct from and different to the collecting flow path and the dispensing flow path.

Said harvesting flow path may be located in or on the base of said elongate protrusion, or may be located in or on the second side of said elongate protrusion.

Where the harvesting flow path is located in or on the base of said elongate protrusion then, in the context of Embodiment A above, said harvesting flow path is located closer to the inner wall of the drum than the collecting flow path, the dispensing flow path and the common internal flow path, and, in the context of Embodiment B above, said harvesting flow path is located closer to the inner wall of the drum than the dispensing flow path.

Said harvesting flow path is preferably located within an elongate cavity located in or on the base of said elongate protrusion, or in or on the second side of said elongate protrusion, wherein said elongate cavity has a flat, plate-like shape having a length, width and depth, wherein the elongate dimension (or length) of said cavity is disposed along at least a part of the elongate dimension of the elongate protrusion. The elongate cavity suitably follows the shape and contours of the elongate protrusion, and may be rectilinear and/or curvilinear. It will be appreciated that the length, width and depth of the elongate cavity are substantially orthogonal to each other. The width dimension of said elongate cavity is disposed along at least a part of the width of the base of said elongate protrusion, or along at least a part of the width of the second side of said elongate protrusion, depending on the location of the harvesting flow path in or on the elongate protrusion. The depth dimension of the elongate cavity is substantially normal to the base of said elongate protrusion, or the second side of said elongate protrusion, depending on the location of the harvesting flow path in or on the elongate protrusion.

It will be appreciated that said elongate cavity has a first edge and a second edge, wherein the first and second edges are on opposite edges of the width dimension of the cavity. Said harvesting aperture(s) are disposed in the first edge. In the configurations where a harvesting flow path is either located in or on the base of said elongate protrusion, or located in or on the second side of said elongate protrusion, then said second edge does not contain harvesting apertures.

Thus, wherein said harvesting flow path is located in or on the base of said elongate protrusion, the first edge of the elongate cavity (i.e. the edge in which is disposed harvesting aperture(s)) is located at the second side of the elongate protrusion.

Similarly, wherein said harvesting flow path is located in or on the second side of said elongate protrusion, the first edge of the elongate cavity (i.e. the edge in which is disposed harvesting aperture(s)) is located at the juncture of the second side of said elongate protrusion with the inner wall of the drum.

Preferably, the harvesting flow path comprises a chain of open compartments. Thus, preferably said harvesting aperture(s) is/are in fluid communication with the storage means via a chain of open compartments configured to bias solid particulate material towards the storage means during rotation of the drum. Said chain of open compartments is configured to bias solid particulate material towards the storage means during rotation of the drum in a dispensing direction and preferably also in a collecting direction. Thus, said chain of open compartments is configured to bias solid particulate material towards the storage means during rotation of the drum in either direction once the solid particulate material is present in the harvesting flow path, which finds particular utility in the present invention during rotation of the drum in a dispensing direction. Said chain of open compartments preferably forms at least a part of the harvesting (or herringbone) flow path.

It will be appreciated that said chain of open compartments is located in the elongate cavity described hereinabove.

Said chain of open compartments of the harvesting flow path is formed by a first series of vanes and a second series of vanes, wherein said first and second series of vanes are disposed along at least part of the length of the elongate protrusion. Preferably, the first series of vanes is disposed within the elongate cavity such that said first series is located at or along the interior of said first edge of said elongate cavity, and said second series of vanes is disposed within the elongate cavity such said second series is located at or along the interior of said second edge of said elongate cavity. It will be appreciated that each of the vanes of said first and second series extend laterally into and across a part of the width dimension of the elongate cavity, and advantageously do so in a manner such that the harvesting flow path from the harvesting aperture(s) to the storage means is a tortuous flow path which biases solid particulate material towards the storage means during rotation of the drum.

Said first series of vanes are preferably disposed in an opposing and staggered arrangement with said second series of vanes, in a manner to provide a tortuous flow path from the harvesting aperture(s) to the storage means which biases solid particulate material towards the storage means during rotation of the drum. Thus, preferably, at least some of the first series of vanes extend laterally from the interior of said first edge into and across a part of the width dimension of the elongate cavity to a position X1, and at least some of the second series of vanes extend laterally from the interior of said second edge into and across a part of the width dimension of the elongate cavity to a position X2, wherein position X1 is closer to the interior of the second edge than position X2 and/or (and preferably and) wherein position X2 is closer to the interior of the first edge than position X1, wherein the distance of positions X1 and X2 to the interior of the relevant edge is measured in a direction normal to the interior of said edge. Thus, said first and second series of vanes arranged in this manner along the length of the elongate cavity define a series of positions comprising positions X1_{1, X}2₁, X1₂, X2₂, X1₃, X2₃, . . . X1ₙ and X2ₘ, where n and m are integers, which defines a non-linear and tortuous pathway configured to bias solid particulate material towards the storage means during rotation of the drum. Thus, preferably the first and second series of vanes define a set of positions X1 and X2 which alternate along the length of the elongate cavity. In other words, the vanes of the first series may be described as dove-tailing with the vanes of the second series. Thus, the first series of vanes is advantageously configured in an interlocking but non-contacting arrangement with the second series of vanes. It will be appreciated the term “interlocking”, as used herein, is not intended to imply any contact between the respective vanes, and not intended to imply any correspondence in shape or fit between opposing vanes. Nevertheless, at the start of a harvesting flow path, i.e. the end of the harvesting flow path which is closer to the distal end of the elongate protrusion, the first vane of the first series optionally contacts the first vane of the second series in order to provide an end to the harvesting flow path.

One or more additional vane(s) of one or both of the first and second series may be interspersed in this alternating pattern, optionally wherein said additional vane(s) of a given series extend laterally into the width dimension of the elongate cavity to a position Y1 or Y2 which is closer to the edge from which the vane extends than position X1 or X2 respectively.

Thus, the first series of vanes are preferably disposed in an interlocking but non-contacting arrangement with the second series of vanes along the length of the harvesting flow path, in a manner to provide a tortuous flow path from the harvesting aperture(s) to the storage means which biases solid particulate material towards the storage means during rotation of the drum.

In the harvesting flow path, preferably the vanes of the second series are substantially parallel to each other. Preferably, consecutive vanes of said second series are arranged in a U-shape, wherein each U-shape has a distal wall closer to the distal end of the elongate protrusion and a proximal wall closer to the proximal end of the elongate protrusion. Thus, said second series of vanes preferably defines a series of adjoining U-shapes comprising a first U-shape and a second U-shape and optionally one or more subsequent U-shape(s), wherein said first U-shape is closer to the distal end of the elongate protrusion than said second adjoining U-shape, preferably wherein a proximal wall of said first U-shape is the same wall as the distal wall of said adjoining second U-shape. Thus, for instance, the proximal wall of the first U-shape which is nearest the distal end of the elongate protrusion is preferably the same wall as the distal wall of the adjacent, second U-shape which is nearer the proximal end of the elongate protrusion. Thus, a series of n U-shapes may be generated by a series of (n+1) vanes.

Preferably, said second series of vanes of the harvesting flow path defines a series of inclined adjoining U-shapes wherein the incline of the distal and proximal walls of said U-shape is towards the distal end of the elongate protrusion. As used herein, the term “incline of the distal and proximal walls” refers to the direction of the incline of said wall starting from the base of the U-shape.

Preferably, the mouth of said U-shape of said second series of vanes in the harvesting flow path faces inwardly towards the interior of the elongate protrusion (i.e. towards the interior of said elongate cavity), and preferably towards a harvesting aperture or towards the side of the harvesting flow path in which the harvesting apertures are located (i.e. towards the interior of said first edge of said elongate cavity).

Wherein said chain of open compartments of the harvesting flow path is located in or on the base of the elongate protrusion, the second series of vanes is preferably disposed adjacent the first side of the elongate protrusion or closer to said first side than said first series of vanes, preferably such that the base of said U-shape is or is juxtaposed with the interior surface of the first side of the elongate protrusion. Thus, the mouth of said U-shape of said second series of vanes preferably faces inwardly towards the interior of the elongate protrusion (i.e. towards the interior of said elongate cavity) and in the direction of rotation of the drum during rotation in a dispensing direction.

Wherein said chain of open compartments of the harvesting flow path is located in or on the second side of the elongate protrusion, the second series of vanes is preferably disposed adjacent the apex of the elongate protrusion or closer to said apex than said first series of vanes. Thus, the mouth of said U-shape of the second series of vanes preferably faces inwardly towards the interior of the elongate protrusion (i.e. towards the interior of said elongate cavity) and towards the inner surface of the drum. Thus, for an elongate protrusion having a substantially triangular cross-section, the mouth of said U-shape of the second series of vanes in a harvesting flow path disposed on the second side of said elongate protrusion is angled downwards towards the inner surface of the drum.

In the harvesting flow path, the vanes of the first series are preferably arranged in a series of U-shapes wherein each U-shape has a distal wall closer to the distal end of the elongate protrusion and a proximal wall closer to the proximal end of the elongate protrusion.

Like the second series of vanes of the harvesting flow path, said first series of vanes of the harvesting flow path may define a series of adjoining U-shapes comprising a first U-shape and a second U-shape and optionally one or more subsequent U-shape(s), wherein said first U-shape is closer to the distal end of the elongate protrusion than said second adjoining U-shape, wherein a proximal wall of said first U-shape is the same wall as the distal wall of said adjoining second U-shape. However, such an arrangement reduces the opportunities for harvesting apertures in the second side of the elongate protrusion. Instead, in a preferred arrangement, the first series of vanes defines a series of U-shapes wherein at least one and preferably each pair of adjacent U-shapes do not adjoin each other, and wherein at least one and preferably each pair of adjacent U-shapes are interrupted by a harvesting aperture in the second side of the elongate protrusion, i.e. a harvesting aperture in the second side of the elongate protrusion separates a pair of adjacent U-shapes of the first series of vanes of the harvesting flow path.

Thus, it is preferred that a plurality of harvesting apertures is disposed in the second side of the elongate protrusion to provide multiple entry points into the chain of open compartments, thereby significantly improving collection efficiency.

Preferably, the mouth of said U-shape of said first series of vanes in said harvesting flow path faces inwardly towards the interior of the elongate protrusion (i.e. towards the interior of said elongate cavity) and away from a harvesting aperture.

Preferably, a U-shape defined by the vanes of the first series in said harvesting flow path comprises a distal wall which is inclined towards the distal end of the elongate protrusion and a proximal wall which is inclined towards the proximal end of the elongate protrusion. As used herein, the term “inclined towards” in respect of said distal and proximal walls refers to the direction of the incline of said wall starting from the base of the U-shape.

Wherein said chain of open compartments of the harvesting flow path is located in or on the base of the elongate protrusion, said first series of vanes is preferably disposed adjacent the second side of the elongate protrusion or closer to said second side than said second series of vanes, preferably such that the base of said U-shape is or is juxtaposed with the interior surface of the second side of the elongate protrusion. In other words, the mouth of the U-shape of the first series of vanes preferably faces inwardly towards the interior of the elongate protrusion (i.e. towards the interior of said elongate cavity) and in the opposite direction to the rotational direction of the drum during rotation in a dispensing direction.

Wherein said chain of open compartments of the harvesting flow path is located in or on the second side of the elongate protrusion, the first series of vanes is preferably disposed adjacent the inner surface of the drum or closer to said inner surface than said second series of vanes. Thus, said U-shape of the first series of vanes in a harvesting flow path is preferably disposed in or on the second side of said elongate protrusion and proximal the base of the elongate protrusion. The mouth of said U-shape of said first series of vanes preferably faces inwardly towards the interior of the elongate protrusion (i.e. towards the interior of said elongate cavity) and towards the apex of the elongate protrusion.

In the harvesting flow path, it will be appreciated that the series of U-shapes defined by the first series of vanes are disposed in an opposing and staggered arrangement, which is advantageously an interlocking but non-contacting arrangement, with the series of U-shapes defined by the second series of vanes in a manner to provide a tortuous harvesting flow path from the harvesting aperture(s) to the storage means which biases solid particulate material towards the storage means during rotation of the drum.

A U-shape formed by any pair of vanes in either the first or the second series of vanes in the harvesting flow path need not be symmetrical, and is typically asymmetrical. Thus, the U-shape may be a distorted U-shape, for instance approximating a J-shape. The U-shape may be rectilinear or curvilinear or a combination thereof.

The chain of open compartments of the harvesting flow path thus defines a harvesting flow path from the harvesting aperture(s) to the storage means, and is configured to bias solid particulate material from the harvesting aperture(s) to the storage means via the harvesting flow path during rotation of the drum.

The harvesting flow path optionally comprises a valve, preferably a one-way flap valve, to prevent egress of solid particulate material from the storage means back into the harvesting flow path during rotation of the drum in a collecting direction. Advantageously, such a valve helps ensure the storage means is filled as efficiently as possible. The flap valve may be biased with a spring, and/or be mechanically controlled with a cam, and/or be gravity-operated and comprise therein a sufficient weight, in order to prevent egress of solid particulate material from said storage means to the harvesting flow path and hence into the interior of the drum. Preferably, the harvesting flow path does not comprise a valve. In embodiment A, preferably the harvesting flow path joins the common internal flow path approximately in the region of said common internal flow path where it meets the storage means. In Embodiment B, preferably the harvesting flow path feeds directly into the storage means, rather than the collecting flow path.

Thus, the harvesting flow path of the apparatus according to the present invention is preferably configured such that:
(i) during rotation of the drum in a dispensing direction solid particulate material enters a harvesting aperture and passes into one of the open compartments in said chain of open compartments of the harvesting flow path, preferably into a U-shape formed by the second series of vanes,
(ii) wherein upon further rotation of the drum in the dispensing direction said solid particulate material is transferred into an opposing and staggered U-shape formed by the first series of vanes wherein said opposing and staggered U-shape is closer to the proximal end of the elongate protrusion than said U-shape formed by the second series of vanes from which the solid particulate material was transferred, and
(iii) wherein upon further rotation of the drum in the dispensing direction said solid particulate is transferred into a further U-shape formed by the second series of vanes wherein said further U-shape formed by the second series of vanes is closer to the proximal end of the elongate protrusion than said U-shape formed by the first series of vanes from which the solid particulate material was transferred,
   and so on, thereby biasing said solid particulate material towards the storage means.

The harvesting flow path improves collection efficiency whether the rotational axis of the drum is substantially horizontal, tilted or tiltable during operation of the apparatus. However, the harvesting flow path is of particular utility for apparatus in which the rotational axis of the drum is substantially horizontal, and remains so during operation of the apparatus.

As described above, the harvesting flow path allows collection of solid particulate material in both rotational directions of the drum. It will be appreciated that the herringbone arrangement described herein reduces the quantity of solid particulate material in the drum during rotation of the drum in a dispensing direction, and hence reduces the net rate of introduction of solid particulate material into the drum during rotation of the drum in a dispensing direction.

In the apparatus of the present invention, the rate at which solid particulate material is dispensed into the interior of the drum during rotation of the drum in a dispensing direction may be defined as the dispensing rate (R_{D}), and the rate at which solid particulate material is harvested from the drum via the harvesting aperture(s) into the elongate protrusion during rotation of the drum in a dispensing direction may be defined as the harvesting rate (R_{H}). Thus, the net rate of introduction (NR) of solid particulate material into the drum during rotation of the drum in a dispensing direction is given by NR_{I}=R_{D}−R_{H}. The apparatus is suitably configured such that NR_{I} remains positive, i.e. more solid particulate material enters the drum than leaves the drum during rotation in a dispensing direction. The harvesting rate (R_{H}) during rotation of the drum in a dispensing direction is preferably no more than about 50%, preferably no more than about 40%, preferably no more than about 30%, preferably no more than about 25%, preferably no more than about 20%, of the dispensing rate (R_{D}) at which solid particulate material is dispensed into the interior of the drum during rotation of the drum in a dispensing direction.

As noted above, the harvesting flow path improves the overall rate of recovery of solid particulate material to the storage means towards the end of the treatment cycle, which advantageously reduces overall cycle time, as can be seen from the illustration below.

Thus, for a given drum running at a rotation speed of 30 RPM, without the harvesting flow path:
wherein the dispensing rate (R_{D}) during rotation of the drum in the dispensing direction is 80 g solid particulate material per revolution per lifter, such that dispensing 5 kg solid particulate material per lifter into the drum would take 2 min 5 sec;
wherein the collecting rate during rotation of the drum in the collecting direction is 10 g solid particulate material per revolution per lifter, such that collecting 5 kg solid particulate material per lifter would take 16 min 40 sec (for rotation solely in the collecting direction); and
wherein during the separation phase of the treatment cycle (i.e. the phase of the treatment cycle during which the particles are recovered and transferred back to the storage means), the drum rotates in the collecting direction for 90% of the rotation time and rotates in the dispensing direction for 10% of the rotation time in order to prevent or inhibit roping of the substrates,
   then the total time of the dispensing and separation phases in aggregate is 20 minutes 36 seconds, calculated as [5000/(10*30)*100/90]+[5000/(80*30)].

For a corresponding drum in which a harvesting flow path is incorporated into the lifter such that the harvesting rate (R_{H}) is 5 g particles per revolution per lifter:
the net rate of introduction (NR_{I}) during rotation of the drum in the dispensing direction becomes 75 g solid particulate material per revolution per lifter, so dispensing 5 kg solid particulate material per lifter into the drum now takes 2 min 13 sec, i.e. 8 seconds more than the lifter without the herringbone arrangement;
the collecting rate during rotation of the drum in the collecting direction is the same as before;
the overall rate of recovery of solid particulate material to the storage means at the end of the cycle is then 10 g solid particulate material per revolution per lifter in the collecting direction and 5 g particles per revolution per lifter in the dispensing direction;
   then the total time of the dispensing and separation phases in aggregate as described above is reduced to 19 min 45 sec, calculated as [5000/(0.9*(10*30)+0.1(5*30))]+[5000/(80*30−5*30)].

It will be appreciated that in the preferred embodiments which comprise a plurality of elongate protrusions, the time savings are proportionally greater.

Thus, the aggregate time of the dispensing step and the separation step (during which solid particulate material is separated from the treated substrates) at the beginning and end of the treatment cycle is advantageously reduced. The overall cycle time is reduced because the time lost as a result of the longer duration of dispensing during the treatment step of the overall cycle is less than the time gained as a result of the more efficient collecting/harvesting step (i.e. the “separation step”) at the end of the overall cycle

It should also be noted that, as described above, the dispensing flow path and/or the storage means are suitably configured such that it typically takes 2 to 10 rotations in the dispensing direction to begin to release solid particulate material into the interior of the drum then, for an example where the dispensing flow path and storage means are configured to dispense solid particulate material after 8 rotations in the dispensing direction, it will be appreciated that no solid particulate material present in the storage means is released into the interior of the drum by 8 rotations in the dispensing rotation but, during those 8 rotations, solid particulate material present in the interior of the drum is harvested. Thus, 8 rotations in the collecting direction (e.g. clockwise) followed by 8 rotations in the dispensing direction (e.g. anti-clockwise) would result in no solid particulate material present in the storage means being dispensed into the drum, but would result in 10×8+5×8=120 g solid particulate material being collected/harvested from the interior of the drum.

Thus, in a preferred embodiment the harvesting flow path of an elongate protrusion is configured in combination with the dispensing flow path of said elongate protrusion and/or the storage means to reduce the dispensing rate (relative to apparatus without the harvesting flow path) of solid particulate material into the interior of the drum during rotation in a dispensing direction during a treatment step of the overall cycle and to increase the collecting rate (relative to embodiments without the herringbone flow path) of solid particulate material during a separation step (also referred to herein as “separation phase”) of the overall cycle wherein during the separation step the drum is rotated both in the collecting direction and the dispensing direction, thereby reducing the duration of the overall cycle. In this embodiment, preferably the drum is rotated more in the collecting direction than in the dispensing direction during the separation step, preferably wherein the ratio of the total duration of rotations in the collecting direction : the total duration of rotations in the dispensing direction is from 60:40 to 95:5, preferably from 70:30 to 95:5, preferably from 80:20 to 95:5 and preferably from 85:15 to 95:5. In this embodiment, preferably the speed of rotation in the collecting direction is within 20%, preferably within 10%, preferably within 5% of the speed of rotation in the dispensing direction.

Where the harvesting flow path is located in or on the second side of said elongate protrusion, the present invention provides a further advantageous embodiment, which is referred to herein as the “Double Herringbone” arrangement. In this embodiment, the harvesting flow path on the second side is configured as described hereinabove to harvest solid particulate material during rotation of the drum in the dispensing direction, and the preferences described hereinabove are applicable to this embodiment also. In this embodiment, the elongate protrusion is as described for Embodiment B, i.e. wherein the elongate protrusion comprises a dispensing flow path and a collecting flow which are different flow paths, as described in the present applicant's co-pending PCT/GB/2017/053815 application. However, in the Double Herringbone embodiment, the elongate protrusion comprises one or more additional collecting aperture(s) disposed in a first side thereof at one or more position(s) from the proximal end to the distal end thereof, and preferably said elongate protrusion comprises a plurality of said additional collecting apertures disposed in the first side thereof. Said additional collecting aperture(s) is/are in fluid communication with an additional collecting flow path which in turn is in fluid communication with the storage means, wherein said additional collecting flow path is located in or on the base of the elongate protrusion and is configured to bias solid particulate material towards the storage means during rotation of the drum, particularly during rotation of the drum in a collecting direction.

It will be appreciated that the additional collecting flow path is distinct from and different to the collecting flow path, the dispensing flow path and the harvesting flow path. In the context of Embodiment A above, said additional collecting flow path is located closer to the inner wall of the drum than the collecting flow path, the dispensing flow path and the common internal flow path, and, in the context of Embodiment B above, said additional collecting flow path is located closer to the inner wall of the drum than the dispensing flow path.

Said additional collecting flow path is preferably located within an elongate cavity located in or on the base of said elongate protrusion, wherein said elongate cavity has a flat, plate-like shape having a length, width and depth, wherein the elongate dimension (or length) of said cavity is disposed along at least a part of the elongate dimension of the elongate protrusion. The elongate cavity suitably follows the shape and contours of the elongate protrusion, and may be rectilinear and/or curvilinear. It will be appreciated that the length, width and depth of the elongate cavity are substantially orthogonal to each other. The width dimension of said elongate cavity is disposed along at least a part of the width of the base of said elongate protrusion. The depth dimension of the elongate cavity is substantially normal to the base of said elongate protrusion. It will be appreciated that said elongate cavity has a first edge and a second edge, wherein the first and second edges are on opposite edges of the width dimension of the cavity. Said additional collecting aperture(s) are disposed in the first edge, and said second edge does not contain additional collecting apertures. Thus, the first edge of the elongate cavity (i.e. the edge in which is disposed harvesting aperture(s)) is located at the first side of the elongate protrusion.

Preferably said additional collecting flow path defines a tortuous flow path from the additional collecting aperture(s) to the storage means.

Preferably, said additional collecting flow path is a chain of open compartments which is located in or on the base of the elongate protrusion. Said chain of open compartments of the additional collecting flow path is preferably configured as described herein for the chain of open compartments of a harvesting flow path located in or on the base of the elongate protrusion (including the preferred features thereof), the difference being that the harvesting apertures on the second side of the elongate protrusion are replaced by additional collecting apertures on the first side. Thus, in the Double Herringbone arrangement, said chain of open compartments is configured to bias solid particulate material towards the storage means during rotation of the drum, particularly during rotation of the drum in a collecting direction and preferably also in a dispensing direction. Thus, said chain of open compartments is configured to bias solid particulate material towards the storage means during rotation of the drum in either direction once the solid particulate material is present in the additional collecting flow path. It will be appreciated that said chain of open compartments is located in the elongate cavity described hereinabove.

Said chain of open compartments of the additional collecting flow path is formed by a first series of vanes and a second series of vanes, wherein said first and second series of vanes are disposed along at least part of the length of the elongate protrusion. Preferably, the first series of vanes is disposed within the elongate cavity such that said first series is located at or along the interior of said first edge of said elongate cavity, and said second series of vanes is disposed within the elongate cavity such said second series is located at or along the interior of said second edge of said elongate cavity. It will be appreciated that each of the vanes of said first and second series extend laterally into and across a part of the width dimension of the elongate cavity, and advantageously do so in a manner such that the additional collecting flow path from the additional collecting aperture(s) to the storage means is a tortuous flow path which biases solid particulate material towards the storage means during rotation of the drum.

In the Double Herringbone arrangement, said first series of vanes are preferably disposed in an opposing and staggered arrangement with said second series of vanes, in a manner to provide a tortuous flow path from the additional collecting aperture(s) to the storage means which biases solid particulate material towards the storage means during rotation of the drum. Thus, preferably, at least some of the first series of vanes extend laterally from the interior of said first edge into and across a part of the width dimension of the elongate cavity to a position X1, and at least some of the second series of vanes extend laterally from the interior of said second edge into and across a part of the width dimension of the elongate cavity to a position X2, wherein position X1 is closer to the interior of the second edge than position X2 and/or (and preferably and) wherein position X2 is closer to the interior of the first edge than position X1, wherein the distance of positions X1 and X2 to the interior of the relevant edge is measured in a direction normal to the interior of said edge. Thus, said first and second series of vanes arranged in this manner along the length of the elongate cavity define a series of positions comprising positions X1₁, X2₁, X1₂, X2₂, X1₃, X2₃, . . . X1ₙ and X2ₘ, where n and m are integers, which defines a non-linear and tortuous pathway configured to bias solid particulate material towards the storage means during rotation of the drum. Thus, preferably the first and second series of vanes define a set of positions X1 and X2 which alternate along the length of the elongate cavity. In other words, the vanes of the first series may be described as dove-tailing with the vanes of the second series. Thus, the first series of vanes is advantageously configured in an interlocking but non-contacting arrangement with the second series of vanes. It will be appreciated the term “interlocking”, as used herein, is not intended to imply any contact between the respective vanes, and not intended to imply any correspondence in shape or fit between opposing vanes. Nevertheless, at the start of an additional collecting flow path, i.e. the end of the additional collecting flow path which is closer to the distal end of the elongate protrusion, the first vane of the first series optionally contacts the first vane of the second series in order to provide an end to the additional collecting flow path. One or more additional vane(s) of one or both of the first and second series may be interspersed in this alternating pattern, optionally wherein said additional vane(s) of a given series extend laterally into the width dimension of the elongate cavity to a position Y1 or Y2 which is closer to the edge from which the vane extends than position X1 or X2 respectively.

Thus, the first series of vanes are preferably disposed in an interlocking but non-contacting arrangement with the second series of vanes along the length of the additional collecting flow path, in a manner to provide a tortuous flow path from the additional collecting aperture(s) to the storage means which biases solid particulate material towards the storage means during rotation of the drum.

In the additional collecting flow path, preferably the vanes of the second series are substantially parallel to each other. Preferably, consecutive vanes of said second series are arranged in a U-shape, wherein each U-shape has a distal wall closer to the distal end of the elongate protrusion and a proximal wall closer to the proximal end of the elongate protrusion. Thus, said second series of vanes preferably defines a series of adjoining U-shapes comprising a first U-shape and a second U-shape and optionally one or more subsequent U-shape(s), wherein said first U-shape is closer to the distal end of the elongate protrusion than said second adjoining U-shape, preferably wherein a proximal wall of said first U-shape is the same wall as the distal wall of said adjoining second U-shape. Thus, for instance, the proximal wall of the first U-shape which is nearest the distal end of the elongate protrusion is preferably the same wall as the distal wall of the adjacent, second U-shape which is nearer the proximal end of the elongate protrusion. Thus, a series of n U-shapes may be generated by a series of (n+1) vanes.

Preferably, said second series of vanes of the additional collecting flow path defines a series of inclined adjoining U-shapes wherein the incline of the distal and proximal walls of said U-shape is towards the distal end of the elongate protrusion. As used herein, the term “incline of the distal and proximal walls” refers to the direction of the incline of said wall starting from the base of the U-shape.

Preferably, the mouth of said U-shape of said second series of vanes in the additional collecting flow path faces inwardly towards the interior of the elongate protrusion (i.e. towards the interior of said elongate cavity), and preferably towards an additional collecting aperture or towards the side of the additional collecting flow path in which the additional collecting aperture(s) are located (i.e. towards the interior of said first edge of said elongate cavity).

In the Double Herringbone arrangement, the second series of vanes is preferably disposed adjacent the second side of the elongate protrusion or closer to said second side than said first series of vanes, preferably such that the base of said U-shape is or is juxtaposed with the interior surface of the second side of the elongate protrusion. Thus, the mouth of said U-shape of said second series of vanes preferably faces inwardly towards the interior of the elongate protrusion (i.e. towards the interior of said elongate cavity) and in the direction of rotation of the drum during rotation in a collecting direction.

In the additional collecting flow path, the vanes of the first series are preferably arranged in a series of U-shapes wherein each U-shape has a distal wall closer to the distal end of the elongate protrusion and a proximal wall closer to the proximal end of the elongate protrusion.

Like the second series of vanes of the additional collecting flow path, said first series of vanes of the additional collecting flow path may define a series of adjoining U-shapes comprising a first U-shape and a second U-shape and optionally one or more subsequent U-shape(s), wherein said first U-shape is closer to the distal end of the elongate protrusion than said second adjoining U-shape, wherein a proximal wall of said first U-shape is the same wall as the distal wall of said adjoining second U-shape. However, such an arrangement reduces the opportunities for additional collecting apertures in the first side of the elongate protrusion. Instead, in a preferred arrangement, the first series of vanes defines a series of U-shapes wherein at least one and preferably each pair of adjacent U-shapes do not adjoin each other, and wherein at least one and preferably each pair of adjacent U-shapes are interrupted by an additional collecting aperture in the first side of the elongate protrusion, i.e. an additional collecting aperture in the first side of the elongate protrusion separates a pair of adjacent U-shapes of the first series of vanes of the additional collecting flow path.

Thus, it is preferred that a plurality of additional collecting apertures is disposed in the first side of the elongate protrusion to provide multiple entry points into the chain of open compartments, thereby significantly improving collection efficiency.

Preferably, the mouth of said U-shape of said first series of vanes in said additional collecting flow path faces inwardly towards the interior of the elongate protrusion (i.e. towards the interior of said elongate cavity) and away from an additional collecting aperture.

Preferably, a U-shape defined by the vanes of the first series in said additional collecting flow path comprises a distal wall which is inclined towards the distal end of the elongate protrusion and a proximal wall which is inclined towards the proximal end of the elongate protrusion. As used herein, the term “inclined towards” in respect of said distal and proximal walls refers to the direction of the incline of said wall starting from the base of the U-shape.

In the Double Herringbone arrangement, said first series of vanes is preferably disposed adjacent the first side of the elongate protrusion or closer to said first side than said second series of vanes, preferably such that the base of said U-shape is or is juxtaposed with the interior surface of the first side of the elongate protrusion. In other words, the mouth of the U-shape of the first series of vanes preferably faces inwardly towards the interior of the elongate protrusion (i.e. towards the interior of said elongate cavity) and in the opposite direction to the rotational direction of the drum during rotation in a collecting direction.

In the additional collecting flow path, it will be appreciated that the series of U-shapes defined by the first series of vanes are disposed in an opposing and staggered arrangement, which is advantageously an interlocking but non-contacting arrangement, with the series of U-shapes defined by the second series of vanes in a manner to provide a tortuous additional collecting flow path from the additional collecting aperture(s) to the storage means which biases solid particulate material towards the storage means during rotation of the drum.

A U-shape formed by any pair of vanes in either the first or the second series of vanes in the additional collecting flow path need not be symmetrical, and is typically asymmetrical. Thus, the U-shape may be a distorted U-shape, for instance approximating a J-shape. The U-shape may be rectilinear or curvilinear or a combination thereof.

The chain of open compartments of the additional collecting flow path thus defines an additional collecting flow path from the additional collecting aperture(s) to the storage means, and is configured to bias solid particulate material from the additional collecting aperture(s) to the storage means via the additional collecting flow path during rotation of the drum.

The additional collecting flow path optionally comprises a valve, preferably a one-way flap valve, to prevent egress of solid particulate material from the storage means back into the additional collecting flow path during rotation of the drum in a dispensing direction. Preferably, the additional collecting flow path feeds directly into the storage means, rather than the collecting flow path.

Preferably, in the Double Herringbone arrangement the additional collecting flow path and the harvesting flow path unite and feed directly into the storage means.

Thus, the additional collecting flow path of the Double Herringbone arrangement is preferably configured such that:
(i) during rotation of the drum in a collecting direction solid particulate material enters an additional collecting aperture and passes into one of the open compartments in said chain of open compartments of the additional collecting flow path, preferably into a U-shape formed by the second series of vanes,
(ii) wherein upon further rotation of the drum in the collecting direction said solid particulate material is transferred into an opposing and staggered U-shape formed by the first series of vanes wherein said opposing and staggered U-shape is closer to the proximal end of the elongate protrusion than said U-shape formed by the second series of vanes from which the solid particulate material was transferred, and
(iii) wherein upon further rotation of the drum in the collecting direction said solid particulate is transferred into a further U-shape formed by the second series of vanes wherein said further U-shape formed by the second series of vanes is closer to the proximal end of the elongate protrusion than said U-shape formed by the first series of vanes from which the solid particulate material was transferred,
   and so on, thereby biasing said solid particulate material towards the storage means.

The “Double Herringbone” embodiment improves the collection rate of solid particulate material from the interior of the drum to the storage means. Furthermore, the “Double Herringbone” embodiment provides an alternative flow path for solid particulate material from the interior of the drum to the storage means should the primary collecting aperture of the elongate protrusion of Embodiment B become blocked.

According to a second aspect of the invention, there is provided an elongate protrusion as described herein. The elongate protrusion is suitable for use in a rotatable drum of an apparatus of the sort described herein, i.e. an apparatus for use in the treatment of substrates with a solid particulate material. In the second aspect, where the elongate protrusion comprises modular sections, and preferably a tie-bar and outer skin, as described herein, it may be provided in assembled or in dissembled form

### STORAGE MEANS

In the apparatus of the present invention, the storage means and elongate protrusion(s) together are preferably configured to bias solid particulate material present inside the storage means towards the dispensing flow path during rotation of the drum in a dispensing direction. Preferably, the storage means and elongate protrusion(s) together are configured to bias solid particulate material present inside the storage means and/or dispensing flow path towards said dispensing aperture during rotation of the drum in a dispensing direction. Preferably, the storage means and elongate protrusion(s) together are configured to bias solid particulate material present inside a collecting flow path towards the storage means during rotation of the drum in the collecting direction.

The storage means may take a variety of forms and the drum may comprise storage means at one or more locations. In a preferred embodiment, the storage means comprises multiple compartments, for instance, 2, 3, 4, 5 or 6 compartments, particularly wherein said multiple compartments are arranged so as to retain balance of the drum during rotation, preferably such that said multiple compartments are equi-spaced and arranged symmetrically around the axis of the drum.

The capacity of the storage means will vary with the size of the drum and the amount of solid particulate material. Preferably the capacity of the storage means is from about 20 to about 50%, preferably from about 30 to about 40%, larger than the volume of the solid particulate material. In this context, the term “volume of the solid particulate material” preferably refers to the volume occupied by solid particulate material when packed randomly (i.e. including the spaces around each particle of the multiplicity of particles when in packed form in the storage means). Thus, a washing machine for domestic use would typically require about 8 litres of solid particulate material, and an appropriate storage means for such a machine has a capacity of about 11 litres.

In one particularly useful embodiment, the storage means and the elongate protrusions can be assembled together inside the drum and/or are able to be retrofitted to an existing drum. This arrangement is of particular utility in converting a conventional apparatus which is not suitable or adapted for the treatment of substrates using a solid particulate material into an apparatus which is suitable for the treatment of substrates using a solid particulate material. In this embodiment, the storage means and the elongate protrusions would normally be non-integral elements, in order to allow these components to be introduced into the drum without dissembling the whole apparatus. However, integral storage means and elongate protrusions are also envisaged.

In a further particularly useful embodiment, the storage means and the elongate protrusions are removable and replaceable, either by the consumer or by a service engineer. In this embodiment, the storage means and the elongate protrusions would normally be non-integral elements, in order to allow these components to be introduced into the drum without dissembling the whole apparatus. However, integral storage means and elongate protrusions are also envisaged. One advantage of this embodiment is that it allows convenient replacement of the solid particulate material. Thus, solid particulate material located within the storage means and/or elongate protrusions may be removed at the same time as the storage means and/or elongate protrusions, and replaced with fresh solid particulate material contained in the replacement storage means and/or elongate protrusions. Alternatively, solid particulate material may be replaced by operating the apparatus (normally by a cycle determined by pre-programmed instructions stored in the control means of the apparatus) such that solid particulate material is dispensed into an empty drum by rotating the drum in the manner described herein, and then manually removed by a service engineer, wherein fresh solid particulate material is then manually loaded into the empty drum by a service engineer and the apparatus then operated (normally by a cycle determined by pre-programmed instructions stored in the control means of the apparatus) such that solid particulate material is collected from the drum and passed into the storage means via said elongate protrusions by rotating the drum in the manner described herein. Thus, it is not necessary to replace the storage means and/or elongate protrusions just to replace the solid particulate material.

In a particularly preferred embodiment, at least part of (and preferably all of) the storage means is or comprises at least one cavity located in the end wall of the drum. It will be appreciated that the term “located in the end wall of the drum” describes a storage means which is integral with, or affixed or disposed on, any part of the structure of the end wall. Thus, in the retro-fitting embodiment described herein, the storage means are disposed or affixed onto the existing end wall of an existing drum. The outer surface of the retrofitted storage means which faces towards the interior of the drum thus creates a new interior surface, which is different to the original interior surface of the original end wall prior to retro-fitting, but it will be appreciated that this new interior surface is treated for the purposes of this invention as being the interior surface of the new end wall of the drum. In other words, the retro-fitted storage means becomes part of the element which is described herein as the “end wall of the drum”. Similarly, storage means may be also present on or retro-fitted to the exterior surface of an end wall of the drum which faces the casing of the apparatus, and for the purposes of the present invention such a storage means is also treated as “located in the end wall of the drum”.

Thus, the storage means may be or comprise at least one spiral or helical pathway located in the end wall of the drum.

In another preferred embodiment, the storage means is or comprises a toroidal cavity located at the juncture of the inner surface and end wall of the drum, or wherein the storage means is or comprises a cavity having a shape defined by a toroidal segment located at the juncture of said inner surface and said end wall. It will be appreciated that such a storage means does not fall within the meaning of “located in the end wall of the drum” as used herein.

The storage means may comprise multiple parts, preferably from 2 to 8 parts, and for domestic washing machine preferably 2, 3 or 4 parts, which advantageously can be assembled inside the drum and/or which is able to be retrofitted to an existing drum.

In a most preferred embodiment, the storage means comprises multiple compartments or cavities located in the end wall of the drum, as described above. Preferably, each of the compartments in such a multi-compartment arrangement is defined by a cavity bound by a first wall and a second wall which each extend substantially radially outwards from the rotational axis of the drum towards, and preferably extend to, the inner wall of the drum. The drum is normally cylindrical, and so preferably each compartment substantially defines a sector of a cylindrical storage volume in the end wall of drum. Preferably, each compartment in the multi-compartment arrangement is adjacent another compartment, preferably so that the compartments define adjacent such sectors which fill or substantially fill a cylindrical storage volume in the end wall of drum. As used herein, the terms “extend substantially radially outwards” and “substantially defines a sector” means that said first wall and/or said second wall of said cavity need not follow a straight line defining the mathematical radius, i.e. a straight line extending radially outwards from the rotational axis towards and preferably to the inner wall of the drum, but said first wall and/or said second wall of said cavity may also follow a curvilinear path which extends outwards from the rotational axis of the drum towards and preferably to the inner wall of the drum. Preferably, each compartment in the multi-compartment arrangement is associated with a single elongate protrusion.

In the multi-compartment embodiment, it is preferred that at least one pair of adjacent compartments are in fluid communication. Preferably, each compartment is in fluid communication with its adjacent compartment or compartments. As used herein, the term “fluid communication” means that solid particulate material, as well as any liquid medium, is able to pass from one compartment directly into an adjacent compartment or compartments during rotation of the drum. Such an arrangement advantageously minimises or avoids the tendency for aggregation of solid particulate material which has been contacted with the liquid medium, i.e. it minimises or avoids the tendency of moist or wet solid particulate material to aggregate or clump together in the storage means, which can cause at least partial blockage of the collecting flow path and/or the dispensing flow path. Such an arrangement also provides an improvement in the collection efficiency of the solid particulate material. Such an arrangement advantageously creates more space in the storage means at the point(s) where the storage means meet the collecting and/or dispensing flow paths. Such an arrangement can also advantageously improve the balance of the drum during rotation. The fluid communication between adjacent compartments is preferably effected by an aperture, hereinafter referred to as a communicating aperture, in the wall between adjacent compartments. Such a communicating aperture preferably exhibits a smallest dimension which is at least 4 times greater than the longest dimension of the solid particulate material. The largest dimension of the communicating aperture is suitably appropriate to retain the individual nature of the compartments and, as such, the largest dimension of the communicating aperture is preferably no greater than 50%, preferably no greater than 40%, preferably no greater than 30%, preferably no greater than 20%, and typically no greater than 15%, of the longest dimension of a wall between adjacent compartments. A communicating aperture is preferably located in a wall between adjacent compartments approximately midway between the rotational axis and the inner wall of the drum. As used herein, the term “approximately midway” means any position along a wall between adjacent compartments that is closer to the mid-point of said wall between adjacent compartments than to either the rotational axis of the drum or the inner wall of the drum. For instance, where each compartment defines a sector of a cylindrical storage volume in the end wall of the drum, the mid-point of a wall between adjacent compartments is half the radius of the drum. Preferably, a communicating aperture in a wall between adjacent compartments is located at said mid-point.

Suitably, the storage means further comprises one or more perforations which have dimensions smaller than the shortest linear dimension of the solid particulate material so as to permit passage of fluids through said perforations into and out of the storage means, particularly from or into the interior of said drum respectively, but to prevent egress of said solid particulate material through said perforations. The presence of such perforations is advantageous for the cleaning and general hygiene of the interior of the storage means.

### DIMENSIONS AND SURGACES

The dimensions of said storage means, said dispensing and collecting flow paths, said common internal flow path, and said harvesting (or herringbone) flow path are preferably such that they have no internal dimension which is less than 2 times, more preferably which is less than 3 times, more preferably which is less than 4 times, the longest dimension of the solid particulate material. Similarly, the dimensions of said collecting aperture, said transferring aperture and said harvesting aperture are preferably at least 2 times, preferably at least 3 times, more preferably at least 4 times, the longest dimension of the solid particulate material. Such dimensions help to maintain the particle flow and the speed thereof, as well as preventing blockages.

The elements of the drum which come into contact with the substrates to be treated preferably present a smooth surface to said substrates, so that the substrates do not become trapped or snag on said elements. Such elements include the inner and end walls of the drum and the elongate protrusions generally, and particularly the collecting apertures, dispensing apertures and harvesting apertures thereof.

### THE SOLID PARTICULATE MATERIAL AND THE METHOD OF TREATMENT OF SUBSTRATES THEREWITH

The apparatus of the present invention is preferably configured for the treatment of substrates with solid particulate material in the presence of a liquid medium and/or one of more treatment formulation(s).

The solid particulate material preferably comprises a multiplicity of solid particles. Typically, the number of particles is no less than 1000, more typically no less than 10,000, even more typically no less than 100,000. A large number of particles is particularly advantageous in preventing creasing and/or for improving the uniformity of treating or cleaning of the substrate, particularly wherein the substrate is a textile.

Preferably, the particles have an average mass of from about 1 mg to about 1000 mg, or from about 1 mg to about 700 mg, or from about 1 mg to about 500 mg, or from about 1 mg to about 300 mg, preferably at least about 10 mg, per particle. In one preferred embodiment, the particles preferably have an average mass of from about 1 mg to about 150 mg, or from about 1 mg to about 70 mg, or from about 1 mg to about 50 mg, or from about 1 mg to about 35 mg, or from about 10mg to about 30 mg, or from about 12 mg to about 25 mg. In an alternative embodiment, the particles preferably have an average mass of from about 10 mg to about 800 mg, or from about 20 mg to about 700 mg, or from about 50 mg to about 700 mg, or from about 70 mg to about 600 mg from about 20 mg to about 600 mg. In one preferred embodiment, the particles have an average mass of about 25 to about 150 mg, preferably from about 40 to about 80 mg. In a further preferred embodiment, the particles have an average mass of from about 150 to about 500 mg, preferably from about 150 to about 300 mg.

The average volume of the particles is preferably in the range of from about 5 to about 500 mm³, from about 5 to about 275 mm³, from about 8 to about 140 mm³, or from about 10 to about 120 mm³, or at least 40 mm³, for instance from about 40 to about 500 mm³, or from about 40 to about 275 mm³, per particle.

The average surface area of the particles is preferably from 10 mm² to 500 mm² per particle, preferably from 10 mm² to 400 mm², more preferably from 40 to 200 mm² and especially from 50 to 190 mm².

The particles preferably have an average particle size of at least 1 mm, preferably at least 2 mm, preferably at least 3 mm, preferably at least 4 mm, and preferably at least 5 mm. The particles preferably have an average particle size no more than 100 mm, preferably no more than 70 mm, preferably no more than 50 mm, preferably no more than 40 mm, preferably no more than 30 mm, preferably no more than 20 mm, preferably no more than 10 mm, and optionally no more than 7 mm. Preferably, the particles have an average particle size of from 1 to 50 mm, preferably from 1 to 20 mm, more preferably from 1 to 10 mm, more preferably from 2 to 10 mm, more preferably from 5 to 10 mm. Particles which offer an especially prolonged effectiveness over a number of treatment cycles are those with an average particle size of at least 5 mm, preferably from 5 to 10 mm. The size is preferably the largest linear dimension (length). For a sphere this equates to the diameter. For non-spheres this corresponds to the longest linear dimension. The size is preferably determined using Vernier callipers. The average particle size is preferably a number average. The determination of the average particle size is preferably performed by measuring the particle size of at least 10, more preferably at least 100 particles and especially at least 1000 particles. The above mentioned particle sizes provide especially good performance (particularly cleaning performance) whilst also permitting the particles to be readily separable from the substrate at the end of the treatment method.

The particles preferably have an average particle density of greater than 1 g/cm³, more preferably greater than 1.1 g/cm³, more preferably greater than 1.2 g/cm³, even more preferably at least 1.25 g/cm³, even more preferably greater than 1.3 g/cm³, and even more preferably greater than 1.4 g/cm³. The particles preferably have an average particle density of no more than 3 g/cm³ and especially no more than 2.5 g/cm³. Preferably, the particles have an average density of from 1.2 to 3 g/cm³. These densities are advantageous for further improving the degree of mechanical action which assists in the treatment process and which can assist in permitting better separation of the particles from the substrate after the treatment.

Unless otherwise stated, reference herein to an “average” is to a mean average, preferably an arithmetic mean average, as is conventional in this art.

The particles of the solid particulate material may be polymeric and/or non-polymeric particles. Suitable non-polymeric particles may be selected from metal, alloy, ceramic and glass particles. Preferably, however, the particles of the solid particulate material are polymeric particles.

Preferably the particles comprise a thermoplastic polymer. A thermoplastic polymer, as used herein, preferably means a material which becomes soft when heated and hard when cooled. This is to be distinguished from thermosets (e.g. rubbers) which will not soften on heating. A more preferred thermoplastic is one which can be used in hot melt compounding and extrusion.

The polymer preferably has a solubility in water of no more than 1 wt %, more preferably no more than 0.1 wt % in water and most preferably the polymer is insoluble in water. Preferably the water is at pH 7 and a temperature of 20° C. whilst the solubility test is being performed. The solubility test is preferably performed over a period of 24 hours. The polymer is preferably not degradable. By the words “not degradable” it is preferably meant that the polymer is stable in water without showing any appreciable tendency to dissolve or hydrolyse. For example, the polymer shows no appreciable tendency to dissolve or hydrolyse over a period of 24hrs in water at pH 7 and at a temperature of 20° C. Preferably a polymer shows no appreciable tendency to dissolve or hydrolyse if no more than about 1 wt %, preferably no more than about 0.1 wt % and preferably none of the polymer dissolves or hydrolyses, preferably under the conditions defined above. The solubility and degradability characteristics are preferably assessed on a polymeric particle as disclosed herein. The solubility and degradability characteristics are preferably equally applicable to non-polymeric particles.

The polymer may be crystalline or amorphous or a mixture thereof.

The polymer can be linear, branched or partly cross-linked (preferably wherein the polymer is still thermoplastic in nature), more preferably the polymer is linear.

The polymer preferably is or comprises a polyalkylene, a polyamide, a polyester or a polyurethane and copolymers and/or blends thereof, preferably from polyalkylenes, polyamides and polyesters, preferably from polyamides and polyalkylene, and preferably from polyamides.

A preferred polyalkylene is polypropylene.

A preferred polyamide is or comprises an aliphatic or aromatic polyamide, more preferably an aliphatic polyamide. Preferred polyamides are those comprising aliphatic chains, especially C₄-C₁₆, C₄-C₁2 and C₄-C₁₀ aliphatic chains. Preferred polyamides are or comprise Nylons. Preferred Nylons include Nylon 4,6, Nylon 4,10, Nylon 5, Nylon 5,10, Nylon 6, Nylon 6,6, Nylon 6/6,6, Nylon 6,6/6,10, Nylon 6,10, Nylon 6,12, Nylon 7, Nylon 9, Nylon 10, Nylon 10,10, Nylon 11, Nylon 12, Nylon 12,12 and copolymers or blends thereof. Of these, Nylon 6, Nylon 6,6 and Nylon 6,10, and particularly Nylon 6 and Nylon 6,6, and copolymers or blends thereof are preferred. It will be appreciated that these Nylon grades of polyamides are not degradable, wherein the word degradable is preferably as defined above.

Suitable polyesters may be aliphatic or aromatic, and preferably derived from an aromatic dicarboxylic acid and a C₁-C₆, preferably C₂-C₄ aliphatic diol. Preferably, the aromatic dicarboxylic acid is selected from terephthalic acid, isophthalic acid, phthalic acid, 1,4-, 2,5-, 2,6- and 2,7-naphthalenedicarboxylic acid, and is preferably terephthalic acid or 2,6-naphthalenedicarboxylic acid, and is most preferably terephthalic acid. The aliphatic diol is preferably ethylene glycol or 1,4-butanediol. Preferred polyesters are selected from polyethylene terephthalate and polybutylene terephthalate. Useful polyesters can have a molecular weight corresponding to an intrinsic viscosity measurement in the range of from about 0.3 to about 1.5 dl/g, as measured by a solution technique such as ASTM D-4603.

Preferably, polymeric particles comprise a filler, preferably an inorganic filler, suitably an inorganic mineral filler in particulate form, such as BaSO₄. The filler is preferably present in the particle in an amount of at least 5 wt %, more preferably at least 10 wt %, even more preferably at least 20 wt %, yet more preferably at least 30 wt % and especially at least 40 wt % relative to the total weight of the particle. The filler is typically present in the particle in an amount of no more than 90 wt %, more preferably no more than 85 wt %, even more preferably no more than 80 wt %, yet more preferably no more than 75 wt %, especially no more than 70 wt %, more especially no more than 65 wt % and most especially no more than 60 wt % relative to the total weight of the particle. The weight percentage of filler is preferably established by ashing. Preferred ashing methods include ASTM D2584, D5630 and ISO 3451, and preferably the test method is conducted according to ASTM D5630. For any standards referred to in the present invention, unless specified otherwise, the definitive version of the standard is the most recent version which precedes the priority filing date of this patent application. Preferably, the matrix of said polymer optionally comprising filler(s) and/or other additives extends throughout the whole volume of the particles.

The particles can be spheroidal or substantially spherical, ellipsoidal, cylindrical or cuboid, Particles having shapes which are intermediate between these shapes are also possible. The best results for treatment performance (particularly cleaning performance) and separation performance (separating the substrate from the particles after the treating steps) in combination are typically observed with ellipsoidal particles. Spheroidal particles tend to separate best but may not provide optimum treatment or cleaning performance. Conversely, cylindrical or cuboid particles separate poorly but treat or clean effectively. Spheroidal and ellipsoidal particles are particularly useful where improved fabric care is important because they are less abrasive. Spheroidal or ellipsoidal particles are particularly useful in the present invention which is designed to operate without a particle pump and wherein the transfer of the particles between the storage means and the interior of the drum is facilitated by rotation of the drum.

The term “spheroidal”, as used herein, encompasses spherical and substantially spherical particles. Preferably, the particles are not perfectly spherical. Preferably, the particles have an average aspect ratio of greater than 1, more preferably greater than 1.05, even more preferably greater than 1.07 and especially greater than 1.1. Preferably, the particles have an average aspect ratio of less than 5, preferably less than 3, preferably less than 2, preferably less than 1.7 and preferably less than 1.5. The average is preferably a number average. The average is preferably performed on at least 10, more preferably at least 100 particles and especially at least 1000 particles. The aspect ratio for each particle is preferably given by the ratio of the longest linear dimension divided by the shortest linear dimension. This is preferably measured using Vernier Callipers. Where a good balance between treating performance (particularly cleaning performance) and substrate care is required, it is preferred that the average aspect ratio is within the abovementioned values. When the particles have a very low aspect ratio (e.g. highly spherical particles), the particles may not provide sufficient mechanical action for good treating or cleaning characteristics. When the particles have an aspect ratio which is too high, the removal of the particles from the substrate may become more difficult and/or the abrasion on the substrate may become too high, which may lead to unwanted damage to the substrate, particularly wherein the substrate is a textile.

According to a third aspect of the present invention, there is provided a method for treating a substrate, the method comprising agitating the substrate with solid particulate material in the apparatus of the present invention, as described herein. It will be appreciated that the features, preferences and embodiments described herein in respect of the apparatus (including the elongate protrusion) and solid particulate material are applicable to the third aspect of the invention.

Preferably, in the method of the present invention, the solid particulate material is re-used in further treatment procedures.

Preferably the method additionally comprises separating the solid particulate material from the treated substrate. The particles are preferably stored in the storage means for use in the next treatment procedure.

Thus, it will be appreciated that the solid particulate material preferably does not become affixed to or associated with the substrate as a result of the treatment.

Preferably the method comprises rotating the drum for multiple rotations in said dispensing direction and further comprises rotating the drum for multiple rotations in said collecting direction.

It will be appreciated that during the step of agitating the substrate with solid particulate material, the drum rotates for multiple rotations in said dispensing direction, and may also rotate for multiple rotations in said collecting direction. Rotation in both directions during the agitating phase may be preferable in order to facilitate circulation of the solid particulate material through the drum and storage means. Preferably, however, the agitating phase comprises a greater number of rotations in the dispensing direction than in the collecting direction.

It will also be appreciated that during the step of separating the solid particulate material from the treated substrate, the drum rotates for multiple rotations in said collecting direction, and may also rotate for multiple rotations in said dispensing direction. Rotation in both directions during the separating phase may be advantageous in order to facilitate better separation of the solid particulate material from the treated substrate. Preferably, however, the separating phase comprises a greater number of rotations in the collecting direction than in the dispensing direction.

The method preferably comprises agitating the substrate with solid particulate material and a liquid medium. Preferably, the method comprises agitating the substrate with said solid particulate material and a treatment formulation. Preferably, the method comprises agitating the substrate with said solid particulate material, a liquid medium and one or more treatment formulation(s).

The method may comprise the additional step of rinsing the treated substrate. Rinsing is preferably performed by adding a rinsing liquid medium, optionally comprising one or more post-treatment additives, to the treated substrate. The rinsing liquid medium is preferably an aqueous medium as defined herein.

Thus, preferably, the method is a method for treating multiple batches, wherein a batch comprises at least one substrate, the method comprising agitating a first batch with solid particulate material, wherein said method further comprises the steps of:
(a) collecting said solid particulate material in the storage means;
(b) agitating a second batch comprising at least one substrate with solid particulate material collected from step (a); and
(c) optionally repeating steps (a) and (b) for subsequent batch(es) comprising at least one substrate.

The treatment procedure of an individual batch typically comprises the steps of agitating the batch with said solid particulate material in a treatment apparatus for a treatment cycle. A treatment cycle typically comprises one or more discrete treatment step(s), optionally one or more rinsing step(s), optionally one or more step(s) of separating the solid particulate material from the treated batch (a“separation step”), optionally one or more extraction step(s) of removing liquid medium from the treated batch, optionally one or more drying step(s), and optionally the step of removing the treated batch from the apparatus.

In the method of the present invention, steps (a) and (b) may be repeated at least 1 time, preferably at least 2 times, preferably at least 3 times, preferably at least 5 times, preferably at least 10 times, preferably at least 20 times, preferably at least 50 times, preferably at least 100 times, preferably at least 200 times, preferably at least 300 times, preferably at least 400 at least or preferably at least 500 times. Thus, the same solid particulate material is preferably re-used in repeated methods of the present invention, i.e. the solid particulate material is re-used preferably at least 1 time, preferably at least 2 times, preferably at least 3 times, preferably at least 5 times, preferably at least 10 times, preferably at least 20 times, preferably at least 50 times, preferably at least 100 times, preferably at least 200 times, preferably at least 300 times, preferably at least 400 at least or preferably at least 500 times.

The substrate may be or comprise a textile and/or an animal skin substrate. In a preferred embodiment, the substrate is or comprises a textile. The textile may be in the form of an item of clothing such as a coat, jacket, trousers, shirt, skirt, dress, jumper, underwear, hat, scarf, overalls, shorts, swim wear, socks and suits. The textile may also be in the form of a bag, belt, curtains, rug, blanket, sheet or a furniture covering. The textile can also be in the form of a panel, sheet or roll of material which is later used to prepare the finished item or items. The textile can be or comprise a synthetic fibre, a natural fibre or a combination thereof. The textile can comprise a natural fibre which has undergone one or more chemical modifications. Examples of natural fibres include hair (e.g. wool), silk and cotton. Examples of synthetic textile fibres include Nylon (e.g. Nylon 6,6), acrylic, polyester and blends thereof. As used herein, the term “animal skin substrate” includes hides, pelts, leather and fleeces. Typically, the animal skin substrate is a hide or a pelt. The hide or pelt may be a processed or unprocessed animal skin substrate. Suitable animal skin substrates include cattle, pigs, sheep, goats and buffalo. Preferably the animal skin substrate is a bovine skin substrate. Skin substrates of livestock and especially cattle are preferred. It will be appreciated that, in the context of the present invention, the term “animal skin” excludes human skin.

The treating of a substrate which is or comprises a textile according to the present invention may be a cleaning process or any other treatment process such as coloration (preferably dyeing), ageing or abrading (for instance stone-washing), bleaching or other finishing process. Stonewashing is a known method for providing textiles having “wom in” or “stonewashed” characteristics such as a faded appearance, a softer feel and a greater degree of flexibility. Stonewashing is frequently practiced with denim. Preferably the treating of a substrate which is or comprises a textile is a cleaning process. The cleaning process may be a domestic or industrial cleaning process.

As used herein, the term “treating” in relation to treating an animal skin substrate is preferably a tannery process, including colouring and tanning and associated tannery processes, preferably selected from curing, beamhouse treatments, pre-tanning, tanning, re-tanning, fat liquoring, enzyme treatment, tawing, crusting, dyeing and dye fixing, preferably wherein said beamhouse treatments are selected from soaking, liming, deliming, reliming, unhairing, fleshing, bating, degreasing, scudding, pickling and depickling. Preferably, said treating of an animal skin substrate is a process used in the production of leather. Preferably, said treating acts to transfer a tanning agent (including a colourant or other agent used in a tannery process) onto or into the animal skin substrate.

The treatment formulation referred to herein may comprise one or more treatment agent(s) which are suitable to effect the desired treating of the substrate.

Thus, a method according to the present invention which is a cleaning process suitably comprises agitating the substrate with said solid particulate material, a liquid medium and one or more treatment formulation(s) wherein said treatment formulation is preferably a detergent composition comprising one or more of the following components: surfactants, dye transfer inhibitors, builders, enzymes, metal chelating agents, biocides, solvents, stabilizers, acids, bases and buffers.

Similarly, the treatment formulation of a coloration process is preferably a composition comprising one or more dyes, pigments, optical brighteners and mixtures thereof.

The treatment formulation of a stone-washing process may comprise an appropriate stone-washing agent, as known in the art, for instance an enzymatic treatment agent such as a cellulase.

The treatment formulation of a tannery process suitably comprises one or more agent(s) selected from tanning agents, re-tanning agents and tannery process agents. The treatment formulation may comprise one or more colourant(s). The tanning or re-tanning agent is preferably selected from synthetic tanning agents, vegetable tanning or vegetable re-tanning agents and mineral tanning agents such as chromium (III) salts or salts and complexes containing iron, zirconium, aluminium and titanium. Suitable synthetic tanning agents include amino resins, polyacrylates, fluoro and/or silicone polymers and formaldehyde condensation polymers based on phenol, urea, melamine, naphthalene, sulphone, cresol, bisphenol A, naphthol and/or biphenyl ether. Vegetable tanning agents comprise tannins which are typically polyphenols. Vegetable tanning agents can be obtained from plant leaves, roots and especially tree barks. Examples of vegetable tanning agents include the extracts of the tree barks from chestnut, oak, redoul, tanoak, hemlock, quebracho, mangrove, wattle acacia; and myrobalan. Suitable mineral tanning agents comprise chromium compounds, especially chromium salts and complexes, typically in a chromium (III) oxidation state, such as chromium (III) sulphate. Other tanning agents include aldehydes (glyoxal, glutaraldehyde and formaldehyde), phosphonium salts, metal compounds other than chromium (e.g. iron, titanium, zirconium and aluminium compounds), Preferably, the tanning agents are substantially free from chromium-containing compounds.

One or more substrates can be simultaneously treated by the method of the invention. The exact number of substrates will depend on the size of the substrates and the capacity of the apparatus utilized.

The total weight of dry substrates treated at the same time (i.e. in a single batch or washload) may be up to 50,000 kg. For textile substrates, the total weight is typically from 1 to 500 kg, more typically 1 to 300 kg, more typically 1 to 200 kg, more typically from 1 to 100 kg, even more typically from 2 to 50 kg and especially from 2 to 30 kg. For animal substrates, the total weight is normally at least about 50 kg, and can be up to about 50,000 kg, typically from about 500 to about 30,000 kg, from about 1000 kg to about 25,000 kg, from about 2000 to about 20,000 kg, or from about 2500 to about 10,000 kg.

Preferably the liquid medium is an aqueous medium, i.e. the liquid medium is or comprises water. In order of increasing preference, the liquid medium comprises at least 50 wt %, at least 60 wt %, at least 70 wt %, at least 80 wt %, at least 90 wt %, at least 95 wt % and at least 98 wt % of water. The liquid medium may optionally comprise one or more organic liquids including for example alcohols, glycols, glycol ethers, amides and esters. Preferably, the sum total of all organic liquids present in the liquid medium is no more than 10 wt %, more preferably no more than 5 wt %, even more preferably no more than 2 wt %, especially no more than 1% and most especially the liquid medium is substantially free from organic liquids.

The liquid medium preferably has a pH of from 3 to 13. The pH or the treatment liquor can differ at different times, points or stages in the treatment method according to the invention. It can be desirable to treat (particularly to clean) a substrate under alkaline pH conditions, although while higher pH offers improved performance (particularly cleaning performance) it can be less kind to some substrates. Thus, it can be desirable that the liquid medium has a pH of from 7 to 13, more preferably from 7 to 12, even more preferably from 8 to 12 and especially from 9 to 12. In a further preferred embodiment, the pH is from 4 to 12, preferably 5 to 10, especially 6 to 9, and most especially 7 to 9, particularly in order to improve fabric care. It may also be desirable that the treating of a substrate, or one or more specific stage(s) of a treatment process, is conducted under acid pH conditions. For instance, certain steps in the treatment of animal skin substrates are advantageously conducted at a pH which is typically less than 6.5, even more typically less than 6 and most typically less than 5.5, and typically no less than 1, more typically no less than 2 and most typically no less than 3. Certain fabric or garment finishing treatment methods, for instance stone-washing, may also utilise one or more acidic stage(s). An acid and/or base may be added in order to obtain the abovementioned pH values. Preferably, the abovementioned pH is maintained for at least a part of the duration, and in some preferred embodiments for all of the duration, of the agitation. In order to prevent the pH of the liquid medium from drifting during the treatment, a buffer may be used.

Preferably, the weight ratio of the liquid medium to the dry substrate is no more than 20:1, more preferably no more than 10:1, especially no more than 5:1, more especially no more than 4.5:1 and even more especially no more than 4:1 and most especially no more than 3:1. Preferably, the weight ratio of liquid medium to the dry substrate is at least 0.1:1, more preferably at least 0.5:1 and especially at least 1:1. In the present invention, it is possible to use surprisingly small amounts of liquid medium whilst still achieving good treatment performance (particularly cleaning performance), which has environmental benefits in terms of water usage, waste water treatment and the energy required to heat or cool the water to the desired temperature.

Preferably, the ratio of particles to dry substrate is at least 0.1:1, especially at least 0.5:1 and more especially at least 1:1 w/w. Preferably, the ratio of particles to dry substrate is no more than 30:1, more preferably no more than 20:1, especially no more than 15:1 and more especially no more than 10:1 w/w. Preferably, the ratio of the particles to dry substrate is from 0.1:1 to 30:1, more preferably from 0.5:1 to 20:1, especially from 1:1 to 15:1 w/w and more especially from 1:1 to 10:1 w/w.

The treatment method agitates the substrate in the presence of the solid particulate material. The agitation may be in the form of shaking, stirring, jetting and tumbling. Of these, tumbling is especially preferred. Preferably, the substrate and solid particulate material are introduced into the drum which is rotated so as to cause tumbling. The rotation can be such as to provide a centripetal force of from 0.05 to 1 G and especially from 0.05 to 0.7 G. The centripetal force is preferably as calculated at the interior walls of the drum furthest away from the axis of rotation.

The solid particulate material is able to contact the substrate, suitably mixing with the substrate during the agitation.

The agitation may be continuous or intermittent. Preferably, the method is performed for a period of from 1 minute to 10 hours, more preferably from 5 minutes to 3 hours and even more preferably from 10 minutes to 2 hours.

The treatment method is preferably performed at a temperature of from greater than 0° C. to about 95° C., preferably from 5 to 95° C., preferably at least 10° C., preferably at least 15° C., preferably no more than 90° C., preferably no more than 70° C., and advantageously no more 50° C., no more than 40° C. or no more than 30° C. Such milder temperatures allow the particles to provide the afore-mentioned benefits over larger numbers of treatment cycles. Preferably, when several batches or washloads are treated or cleaned, every treating or cleaning cycle is performed at no more than a temperature of 95° C., more preferably at no more than 90° C., even more preferably at no more than 80° C., especially at no more than 70° C., more especially at no more than 60° C. and most especially at no more than 50° C., and from greater than 0° C., preferably at least 5° C., preferably at least 10° C., preferably at least 15° C., preferably from greater than 0 to 50° C., greater than 0 to 40° C., or greater than 0 to 30° C., and advantageously from 15 to 50° C., 15 to 40° C. or 15 to 30° C. These lower temperatures again allow the particles to provide the benefits for a larger number of treatment or wash cycles.

It will be appreciated that the duration and temperature conditions described hereinabove are associated with the treating of an individual batch comprising at least one of said substrate(s).

Agitation of the substrates with the solid particulate material suitably takes place in said one or more discrete treating step(s) of the aforementioned treatment cycle. Thus, the duration and temperature conditions described hereinabove are preferably associated with the step of agitating said substrate(s) with solid particulate material, i.e. said one or more discrete treating step(s) of the aforementioned treatment cycle.

Preferably, the method is a method for cleaning a substrate, preferably a laundry cleaning method, preferably a method for cleaning a substrate which is or comprises a textile. Thus, preferably, a batch is a washload. Preferably the washload comprises at least one soiled substrate, preferably wherein the soiled substrate is or comprises a soiled textile. The soil may be in the form of, for example, dust, dirt, foodstuffs, beverages, animal products such as sweat, blood, urine, faeces, plant materials such as grass, and inks and paints. The cleaning procedure of an individual washload typically comprises the steps of agitating the washload with said solid particulate material in a cleaning apparatus for a cleaning cycle. A cleaning cycle typically comprises one or more discrete cleaning step(s) and optionally one or more post-cleaning treatment step(s), optionally one or more rinsing step(s), optionally one or more step(s) of separating the cleaning particles from the cleaned washload, optionally one or more extraction step(s) of removing liquid medium from the cleaned washload, optionally one or more drying step(s), and optionally the step of removing the cleaned washload from the cleaning apparatus.

Where the method is a cleaning method, the substrate is preferably agitated with said solid particulate material, a liquid medium, and preferably also a detergent composition. The detergent composition may comprise any one or more of the following components: surfactants, dye transfer inhibitors, builders, enzymes, metal chelating agents, biocides, solvents, stabilizers, acids, bases and buffers. In particular, the detergent composition may comprise one or more enzyme(s).

Where the method is a cleaning method, optional post-cleaning additives which may be present in a rinsing liquid medium include optical brightening agents, fragrances and fabric softeners.

### KIT OF CONVERSION OF CONVENTIONAL APPARATUS AND METHOD OF RETROFITTING

In a fourth aspect of the invention, there is provided a kit for converting an apparatus which is not suitable for use in the treatment of substrates using a solid particulate material into an apparatus according to the present invention and defined hereinabove which is suitable for use in the treatment of substrates using a solid particulate material, wherein the apparatus comprises a housing having mounted therein a rotatably mounted drum having an inner surface and an end wall and which further comprises access means for introducing said substrates into said drum, and wherein said kit comprises:
(a) solid particulate material;
(b) storage means for storage of said solid particulate material; and
(c) at least one elongate protrusion suitable for locating on said inner surface of said drum such that the or each elongate protrusion extends in a direction away from said end wall, wherein said elongate protrusion has an end proximal to the end wall and an end distal to the end wall, wherein said elongate protrusion comprises a collecting aperture and a collecting flow path to facilitate flow of said solid particulate material from the interior of said drum to said storage means, wherein said collecting aperture defines the start of a collecting flow path, and wherein the same elongate protrusion further comprises a dispensing aperture and a dispensing flow path to facilitate flow of said solid particulate material from said storage means to the interior of said drum, wherein said dispensing aperture defines the end of a dispensing flow path, wherein said collecting aperture is disposed in a first side of said elongate protrusion, wherein said first side of said elongate protrusion is the leading side of said elongate protrusion during rotation of the drum in a collecting direction, and wherein said flow of said solid particulate material from the storage means towards the interior of the drum is facilitated by the rotation of said drum in a dispensing direction and the flow of said solid particulate material from the interior of the drum towards the storage means is facilitated by the rotation of said drum in said collecting direction, wherein rotation in said dispensing direction is in the opposite rotational direction to rotation in said collecting direction,
   wherein said kit is adapted to allow affixing of said storage means and said elongate protrusion(s) to one or more interior surface(s) of the drum, characterised in that said elongate protrusion exhibits one or more harvesting apertures disposed in a second side of said elongate protrusion, wherein the second side is defined as the leading side of said elongate protrusion during rotation of the drum in said dispensing direction, wherein said harvesting aperture(s) facilitate flow of said solid particulate material from the interior of said drum to said storage means during rotation of the drum in a dispensing direction.

According to a fifth aspect of the present invention, there is provided a method of constructing an apparatus according to the present invention and as defined hereinabove which is suitable for use in the treatment of substrates using a solid particulate material, the method comprising retrofitting a starting apparatus which is not suitable for use in the treatment of substrates using a solid particulate material and which comprises a housing having mounted therein a rotatably mounted drum having an inner surface and an end wall and which further comprises access means for introducing said substrates into said drum, wherein said retrofitting comprises the steps of:
(i) providing solid particulate material, providing one or more storage means for storage of solid particulate material, and providing at least one elongate protrusion(s); and
(ii) affixing said storage means and said elongate protrusion(s) to one or more interior surface(s) of the drum,
   wherein said at least one elongate protrusion is suitable for locating on said inner surface of said drum such that the or each elongate protrusion extends in a direction away from said end wall, wherein said elongate protrusion has an end proximal to the end wall and an end distal to the end wall, wherein said elongate protrusion comprises a collecting aperture and a collecting flow path to facilitate flow of said solid particulate material from the interior of said drum to said storage means, wherein said collecting aperture defines the start of a collecting flow path, and wherein the same elongate protrusion further comprises a dispensing aperture and a dispensing flow path to facilitate flow of said solid particulate material from said storage means to the interior of said drum, wherein said dispensing aperture defines the end of a dispensing flow path, wherein said collecting aperture is disposed in a first side of said elongate protrusion, wherein said first side of said elongate protrusion is the leading side of said elongate protrusion during rotation of the drum in a collecting direction, and wherein said flow of said solid particulate material from the storage means towards the interior of the drum is facilitated by the rotation of said drum in a dispensing direction and the flow of said solid particulate material from the interior of the drum towards the storage means is facilitated by the rotation of said drum in said collecting direction, wherein rotation in said dispensing direction is in the opposite rotational direction to rotation in said collecting direction,
   characterised in that said elongate protrusion exhibits one or more harvesting apertures disposed in a second side of said elongate protrusion, wherein the second side is defined as the leading side of said elongate protrusion during rotation of the drum in said dispensing direction, wherein said harvesting aperture(s) facilitate flow of said solid particulate material from the interior of said drum to said storage means during rotation of the drum in a dispensing direction.

It will be appreciated that the features, preferences and embodiments described hereinabove for the first, second and third aspects are applicable also to the fourth and fifth aspects.

### FIGURES

The invention is further illustrated with reference to the following figures.

FIGS. 1 to 10 and 35 to 37 illustrate the elongate protrusion of Embodiment A.

FIG. 11 illustrates a harvesting (herringbone) flow path located in the base of an elongate protrusion, which is applicable to both Embodiments A and B.

FIGS. 12a and 12b illustrate harvesting apertures and associated flow path located on the second side of an elongate protrusion, and the configuration of the harvesting apertures and flow path in these figures is applicable to both Embodiments A and B.

FIGS. 13 to 29 illustrate the elongate protrusion of Embodiment B, as well as various elements of the apparatus (including aspects of the storage means, drum, access means, drive shaft etc) which are generally applicable to both Embodiments A and B.

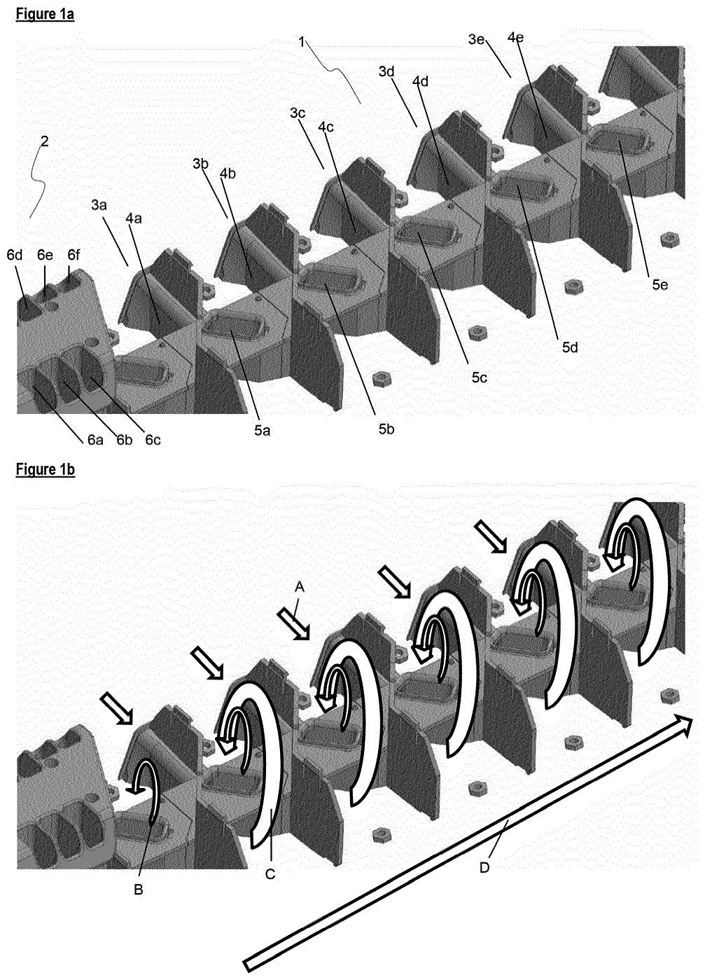

FIG. 1a illustrates the internal structure of an elongate protrusion (1), the internal structure having an Archimedean screw arrangement. The elongate protrusion has a distal end (2) and a proximal end (not shown). During rotation of the drum (not shown) in a collecting direction, solid particulate material enters collecting apertures (3a, 3b, 3c, 3d, 3e etc), and passes through a first portion of a collecting flow path (not shown) located in a wall of the Archimedean screw arrangement (4a, 4b, 4c, 4d, 4e etc), towards and through transferring apertures (5a, 5b, 5c, 5d, 5e etc) into a common internal flow path. The common internal flow path extends between the dispensing apertures (6a, 6b, 6c, 6d, 6e, 6f in the distal end (2) of the elongate protrusion (1) and the storage means (not shown) which is located in the end wall (not shown) of the drum at the proximal end of the elongate protrusion.

FIG. 1b illustrates the flow of solid particulate material during rotation of the drum in a collecting direction in the context of the elongate protrusion of FIG. 1a. Solid particulate material enters the collecting apertures in the direction of the arrows (A), passes through each of the first portions of said collecting flow path and then through the transferring apertures in the direction of the small curved arrows (B) into the common internal flow path. During rotation of the drum in a collecting direction, the flow of solid particulate material in the common internal flow path is shown by the large curved arrows (C). A plurality of rotations of the drum in a collecting direction causes the solid particulate material to flow along the elongate protrusion in the direction of arrow (D), towards the proximal end of the elongate protrusion and the storage means in the end wall of the drum.

FIG. 1c illustrates the flow of solid particulate material during rotation of the drum in a dispensing direction in the context of the elongate protrusion of FIG. 1a. Solid particulate material exits the storage means (not shown) which is located at the proximal end (not shown) of the elongate protrusion and enters the common internal flow path. During rotation of the drum in a dispensing direction, the flow of solid particulate material in the common internal flow path is shown by the large curved arrows (E). A plurality of rotations of the drum in a dispensing direction causes the solid particulate material to flow along the elongate protrusion in the direction of arrow (F), towards the distal end of the elongate protrusion, whereupon it exits via dispensing apertures into the interior of the drum.

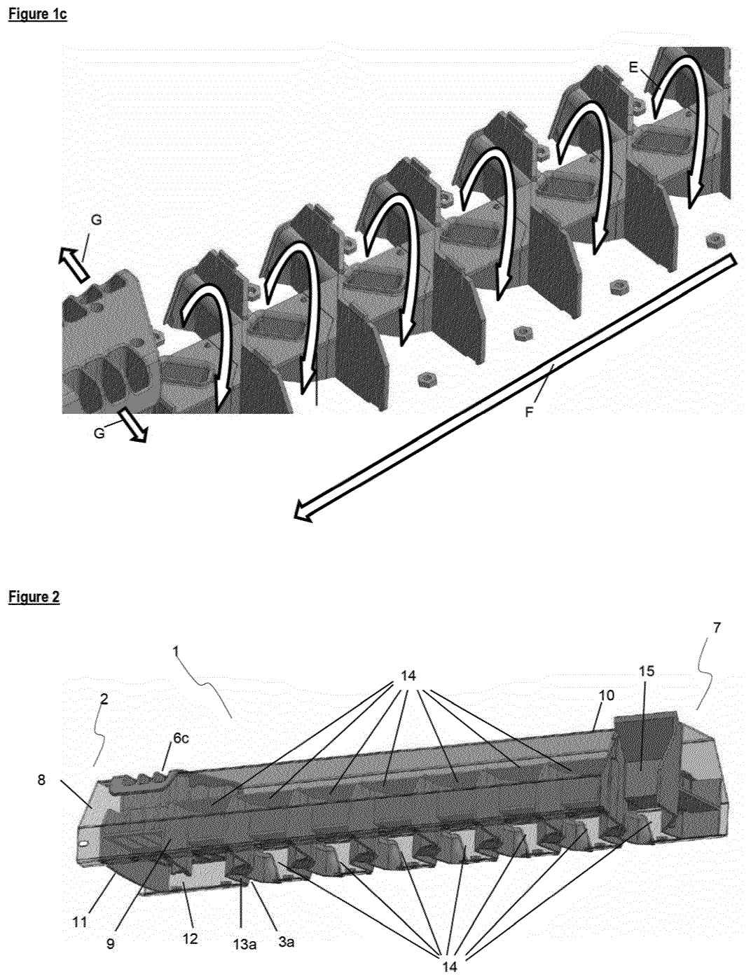

FIG. 2 illustrates the elongate protrusion of FIGS. 1a to 1c viewed in perspective from beneath. The elongate protrusion (1) has a distal end (2) and a proximal end (7). The elongate protrusion (1) is illustrated with a cover (8) which encases the internal structure of the elongate protrusion. The elongate protrusion has a second, trailing side (9) during rotation of the drum in a collecting direction. The elongate protrusion has an upper surface (10) which is disposed towards the interior of the drum. In the typical and preferred embodiment of a cylindrical drum, the structural internal elements of the elongate protrusion are curved at the base thereof where the elongate protrusion meets the inner surfaces of the drum, as illustrated in respect of distal end element (11) which forms an end wall of the dispensing flow path. The elongate protrusion has seven collecting apertures (of which only collecting aperture (3a) is indicated in the Figure), and these are located in the first, leading side of the elongate protrusion during rotation of the drum in a collecting direction. Each collecting aperture is in fluid communication with a first portion of said collecting flow path, of which only first portion (13a) is indicated in the Figure. The elongate protrusion has six dispensing apertures (of which only dispensing aperture (6c) is indicated in the Figure), which are in fluid communication with said dispensing flow path, and specifically in fluid communication with said second portion of said dispensing flow path (12). The common internal flow path (14) forms part of both the collecting and dispensing flow paths and extends along the length of the elongate protrusion. At the proximal end (7) of the elongate protrusion (1) the common internal flow path (14) is in fluid communication with the storage means (not shown) via aperture (15).

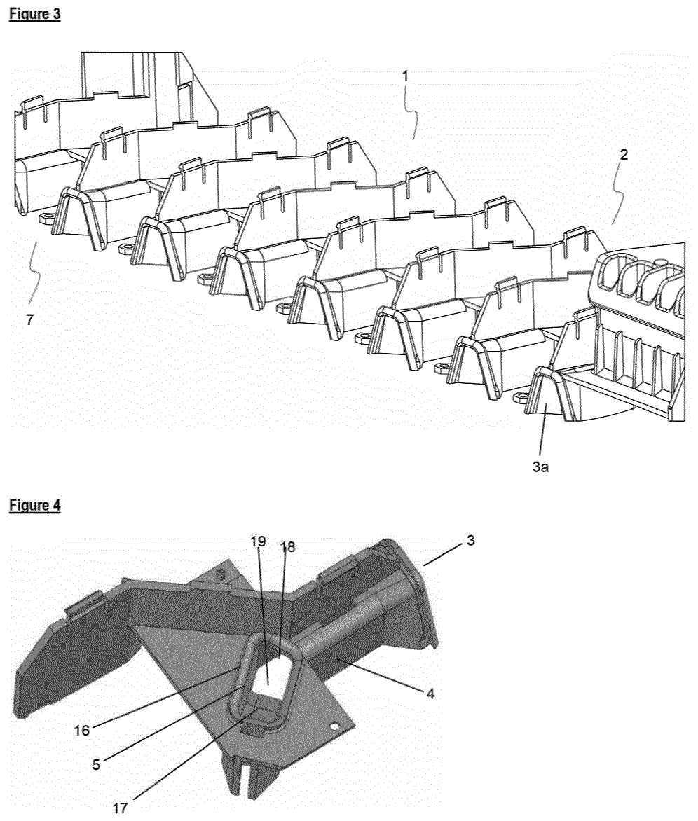

FIG. 3 illustrates the internal structure of elongate protrusion (1) having a distal end (2) and a proximal end (7), from the perspective of its first, leading side during rotation of the drum in a collecting direction. The elongate protrusion has a plurality of collecting apertures (of which only collecting aperture (3a) is indicated in the Figure), each of which has a funnel shape in order to increase the catchment area for solid particulate material.

FIG. 4 illustrates a portion of the internal structure of an elongate protrusion according to a central entry embodiment, which portion comprises a collecting aperture (3), a first portion of said collecting flow path which is located in a wall (4) of an Archimedean screw arrangement, and a transferring aperture (5). The portion in FIG. 4 is particularly representative of a modular section of internal structure of an elongate protrusion comprising a series of modular sections which constitute the common internal flow path.

FIG. 4 also illustrates a deflector rib (16) around the periphery of the transferring aperture, which biases solid particulate present in the common internal flow path away from the transferring aperture during rotation of the drum in either the collecting or dispensing directions.

FIG. 4 also illustrates a substantially perpendicular arrangement of the transferring and collecting apertures, and in the embodiment exemplified in this figure, the transferring and collecting apertures are disposed at 90° to each other.

FIG. 4 also illustrates the first section (18) and second section (19) of said first portion of said collecting flow path, wherein the second section (19) is disposed at an angle β of about 135° to the first section (18) such that said section is angled towards the proximal end of the elongate protrusion.

FIG. 4 also illustrates a first portion of a collecting flow path which is configured to bias solid particulate material towards the transferring aperture during rotation of the drum in a collecting direction, the biasing means in this Figure taking the form of an inclined surface (17) which is present in said section (19).

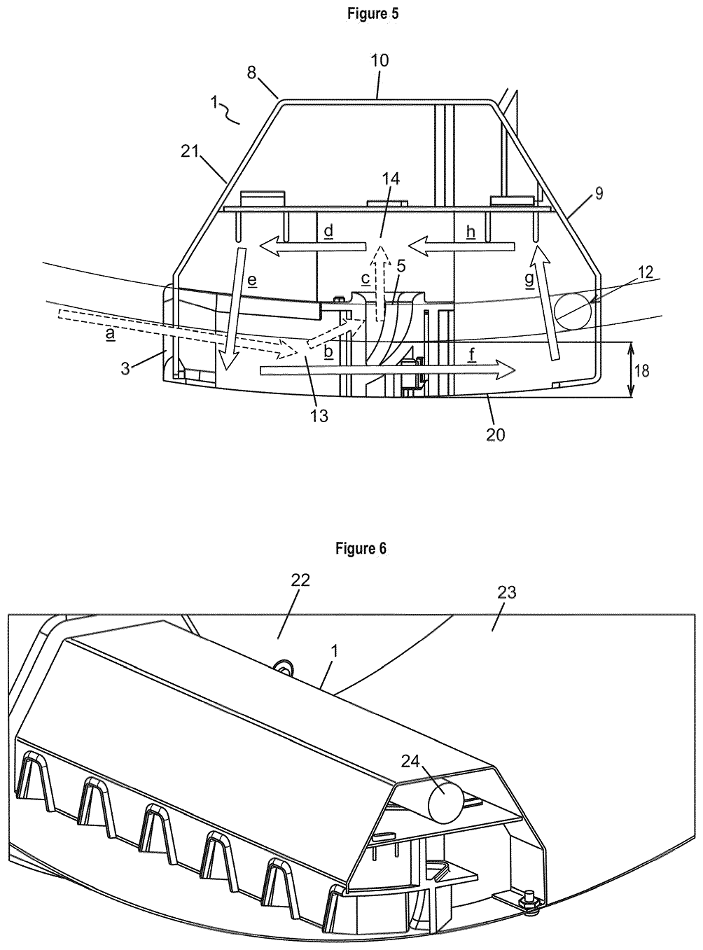

FIG. 5 illustrates a cross-section of an elongate protrusion (1) of the kind described in FIGS. 1 to 4, the cross-section being taken perpendicular to the length of the elongate protrusion. The elongate protrusion (1) has cover (8) which encases the internal structure of the elongate protrusion, and an upper surface (10) which is disposed towards the interior of the drum (not shown). The Figure shows the curved base (20) of the elongate protrusion in the typical and preferred embodiment of a cylindrical drum. The elongate protrusion has a first, leading side (21) and a second, trailing side (9) during rotation of the drum in a collecting direction. Arrows (a) to (h) illustrate the sequential flow path of solid particulate material during rotation of the drum in a collecting direction through collecting aperture (3), first portion (13) of a collecting flow path, transferring aperture (5) and into the common internal flow path (14), in which it is transferred towards the proximal end of the elongate protrusion within the Archimedean screw arrangement in a substantially helical flow path.

FIG. 6 illustrates an elongate protrusion (1) of the kind described in FIGS. 1 to 5, which is disposed within a cylindrical rotatable drum having an end wall (22) and an inner surface (23). The storage means (not shown) is located within the end wall (22).

FIG. 6 also illustrates the location of tie bar (24) in the embodiment wherein the common internal flow path is constituted by the walls of a series of separate modular sections, wherein the modular sections are joined together linearly by means of a tie-bar which extends from the first to the last modular section.

It will be appreciated that FIGS. 1 to 6 are particularly representative of the central entry embodiment referred to herein.

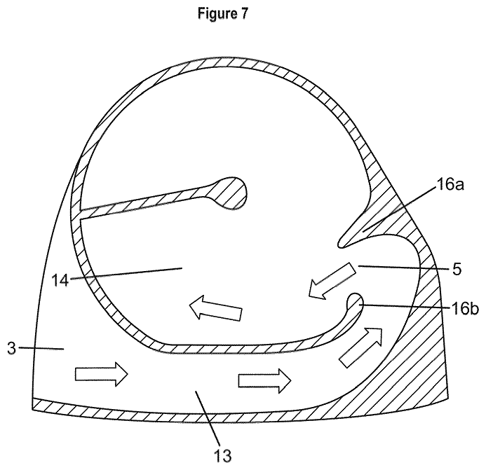

FIG. 7 is a cross-section of an elongate protrusion according to a peripheral entry embodiment, as described herein, and in particular according to the first configuration of the peripheral entry embodiment. The cross-section is taken perpendicular to the length of the elongate protrusion having a plurality of collecting apertures in the same way as FIG. 5. The arrows show the sequential flow path of solid particulate material during rotation of the drum in a collecting direction through collecting aperture (3), first portion (13) of a collecting flow path, and through transferring aperture (5) which is located at the periphery of the common internal flow path (14), and into the common internal flow path (14). Again, solid particulate material is transferred towards the proximal end of the elongate protrusion in a substantially helical flow path within the Archimedean screw arrangement during rotation of the drum in a collecting direction. A deflector rib comprises a first deflector rib portion (16a) and a second deflector rib portion (16b) which bias solid particulate material away the transferring aperture.

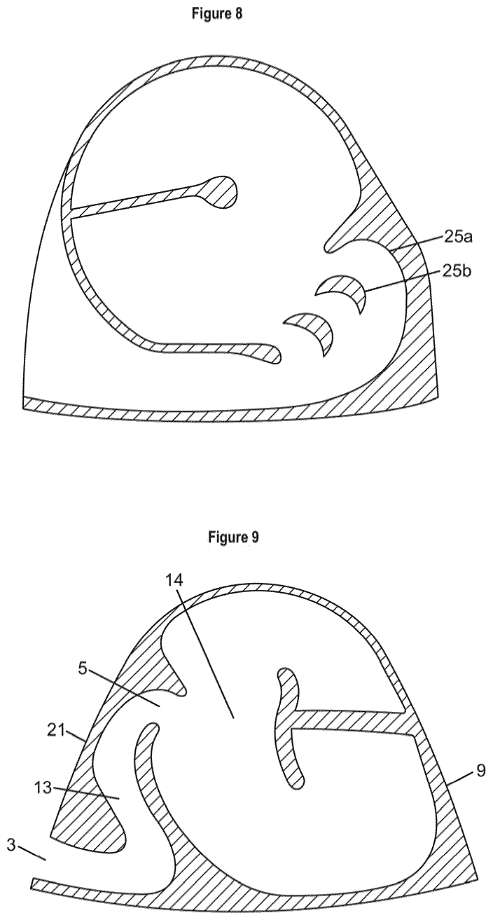

FIG. 8 is a variant of the embodiment of FIG. 7 and illustrates a transferring aperture (5) having vanes or louvres (25a, 25b) which extend across the cross-sectional area of the aperture, so that the transferring aperture becomes a plurality of slits.

FIG. 9 illustrates the second configuration of the peripheral entry embodiment as described herein. The transferring aperture (5) is located in the periphery of the common internal flow path (14) at a position which is closer to the first side (21) of the elongate protrusion than to the second side (9) of the elongate protrusion, wherein the second side (9) is the trailing side of the elongate protrusion during rotation of the drum in a collecting direction. The first portion (13) of a collecting flow path is S-shaped and disposed along the first side (21).

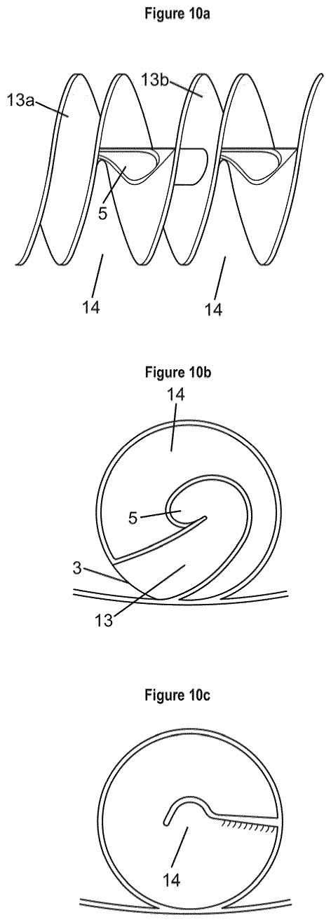

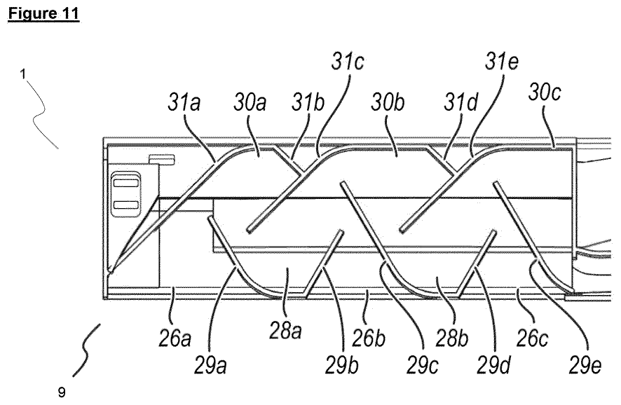

FIGS. 10a, 10b and 10c illustrates the “double helix embodiment”, in which the common internal flow path (14) and said first portions (13, 13a, 13b) of a collecting flow path are arranged as a double helical Archimedean screw, in which the common internal flow path is in helical juxtaposition with the first portions of said collecting paths along the elongate protrusion. In this embodiment, solid particulate material flows from a collecting aperture into the common internal flow path such that said material arrives at a location which is approximately central within the common internal flow path. FIG. 10b shows the cross-section of the elongate protrusion in the section through a first portion (13) of a collecting flow path. FIG. 10c shows the cross-section of the elongate protrusion in the section through the common internal flow path (14).

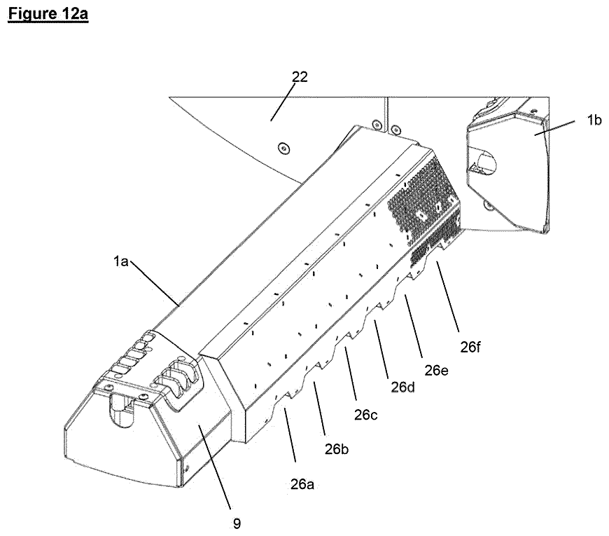

FIG. 11 illustrates a harvesting (or herringbone) flow path located in the base of an elongate protrusion (1). A plurality of harvesting apertures (26a, 26b, 26c) is disposed on the second side (9) of the elongate protrusion (wherein the second side (9) is the trailing side of the elongate protrusion during rotation of the drum in a collecting direction, and the leading side of the elongate protrusion during rotation of the drum in a dispensing direction). A first series of vanes (29a, 29b, 29c, 29d, 29e) is arranged to form a first series of U-shapes (28a, 28b), and a second series of vanes (31a, 31b, 31c, 31d, 31e) is arranged to form a second series of U-shapes (30a, 30b, 30c), wherein said first and second series of vanes and U-shapes are disposed in an opposing, interlocking (but non-contacting) and staggered arrangement, to form a chain of open compartments which provides a tortuous pathway from the harvesting apertures to the storage means (not shown).

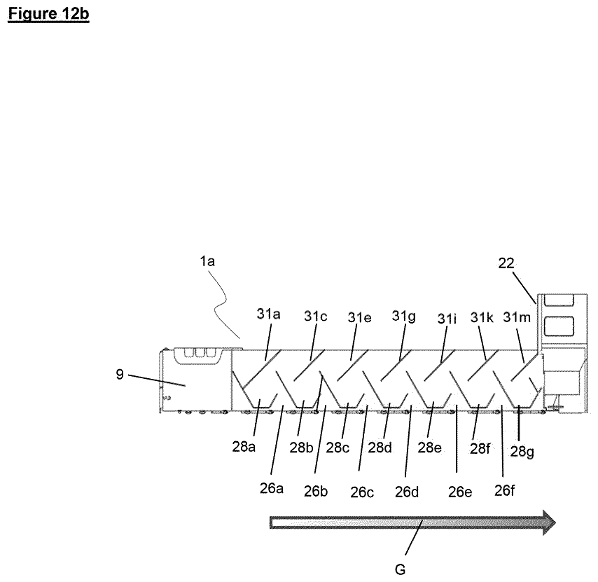

FIG. 12a illustrates harvesting apertures disposed on the second side (9) of elongate protrusion (1a). During rotation of the drum (not shown) in a dispensing direction, solid particulate material present in the interior of the drum enters harvesting apertures (26a to 26f) and passes through the harvesting flow path (not shown) to the storage means (not shown) in the end wall (22) of the drum. Also partially shown in FIG. 12a is a further elongate protrusion (1b)

FIG. 12b illustrates the chain of open compartments which constitutes the harvesting flow path of the elongate protrusion of FIG. 12a, and also illustrates a further example of the arrangement of vanes in the harvesting flow path. During rotation of the drum (not shown) in a dispensing direction, solid particulate material present in the interior of the drum enters harvesting apertures (26a to 26f located in the second side (9) of elongate protrusion (1a). The harvesting flow path comprises a first series of vanes which describes a first series of U-shapes (28a to 28g), wherein each pair of adjacent U-shapes are interrupted by a harvesting aperture. The first series of vanes and associated U-shapes are disposed adjacent the inner surface of the drum and closer to said inner surface than said second series of vanes. The harvesting flow path further comprises a second series of seven vanes (31a, 31c, 31e, 31g, 31i, 31k, 31m) which define a series of six U-shapes, wherein said second series of vanes are disposed in an opposing, interlocking and staggered arrangement with the first series of vanes, thereby defining a tortuous flow path from the harvesting apertures to the storage means in a manner which provides a tortuous flow path from the harvesting aperture(s) to the storage means. In the arrangement of FIG. 12b, it will be noted that at the start of the harvesting flow path, i.e. the end of the harvesting flow path which is closer to the distal end of the elongate protrusion, the first vane of the first series contacts the first vane of the second series in order to provide an end to the harvesting flow path. A plurality of rotations of the drum in the dispensing direction causes solid particulate material to flow along the harvesting flow path in the direction of arrow (G) towards the proximal end of the elongate protrusion and into the storage means.

FIG. 13 illustrates a section of the apparatus showing the end wall (41) of the drum having disposed therein storage means (42). A first elongate protrusion (43a) comprises a dispensing aperture (44) at its distal end and a dispensing flow path (45) which is configured as an Archimedean screw.

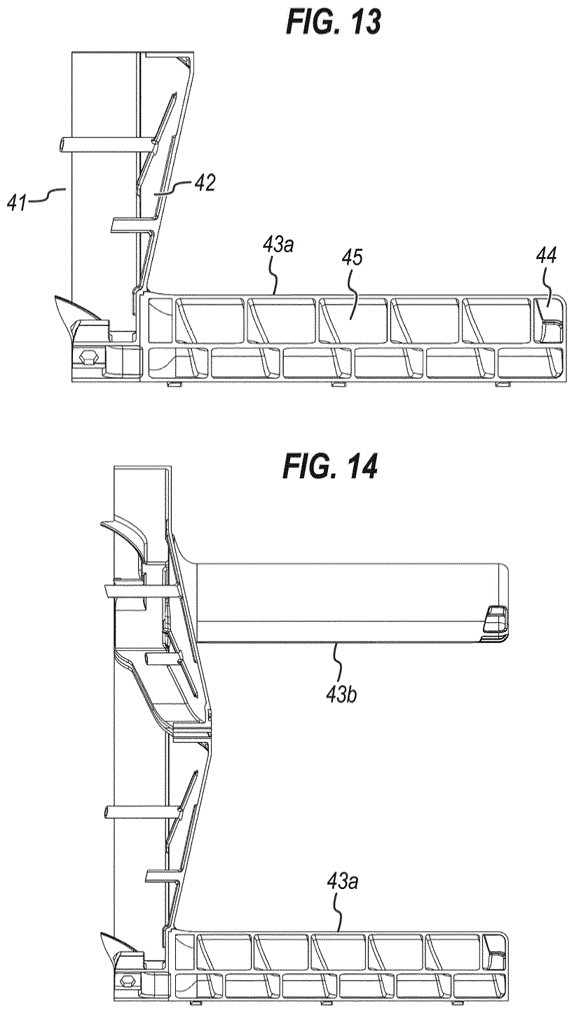

FIG. 14 illustrates a larger section of the drum showing the first elongate protrusion and a second elongate protrusion 43b.

FIG. 15 shows the region of the apparatus where elongate protrusion (43a) meets the end wall (41) of the drum in which is disposed the storage means. Solid particulate material enters the storage means via the collecting flow path (46) and collecting aperture (47). A portion of deflector wall (48) separates the collecting flow path (46) from the dispensing flow path (45).

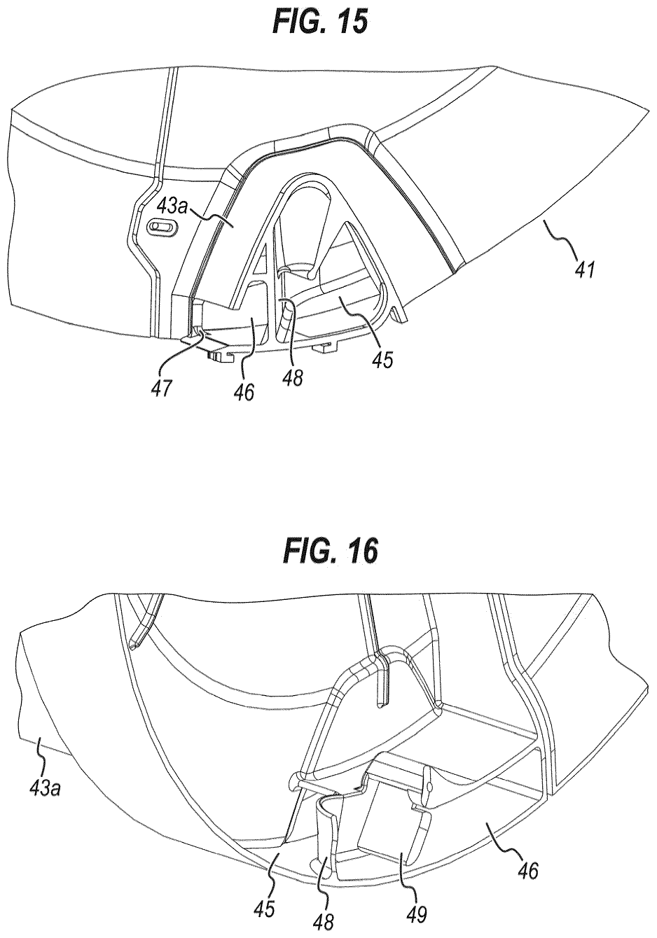

FIG. 16 shows in more detail the arrangement of the dispensing flow path (45), collecting flow path (46) and deflector wall (48) from the opposite side, relative to FIG. 15. A portion of elongate protrusion (43a) is also shown. One-way flap-valve (49) prevents egress of solid particulate material from the storage means into the interior of the drum via the collecting pathway.

FIG. 17 shows collecting aperture (47) in the proximal end of elongate protrusion (43a) at the end wall (41) of the drum.

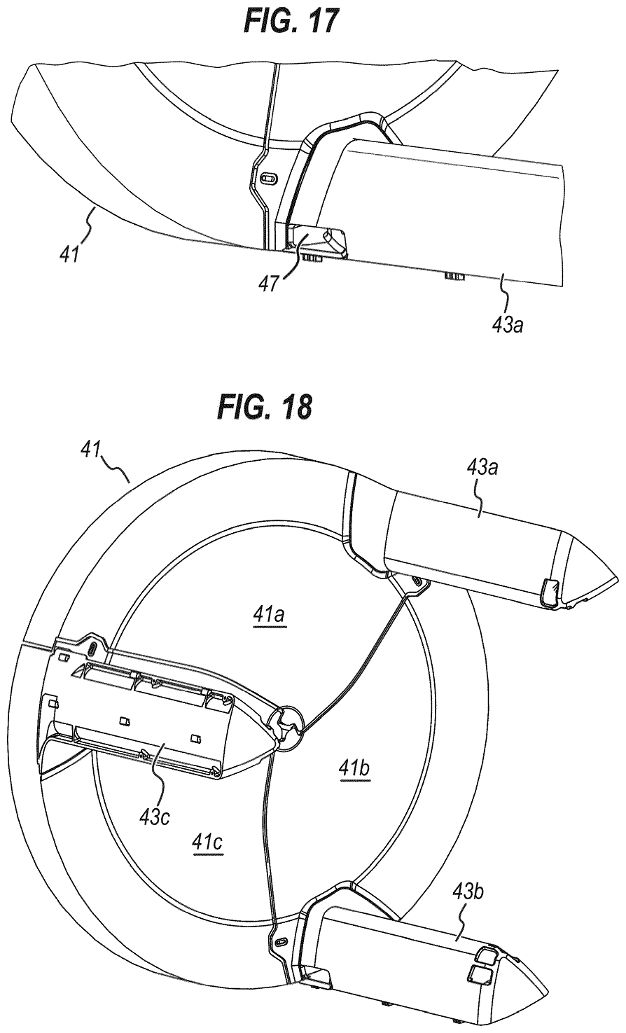

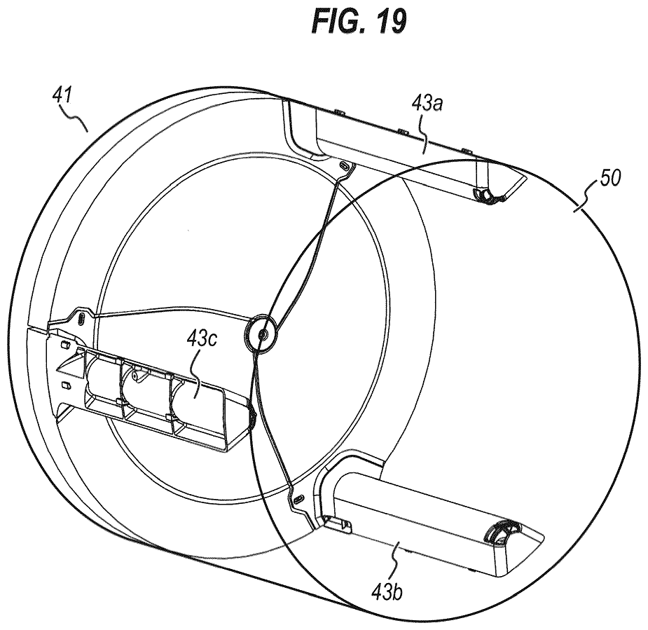

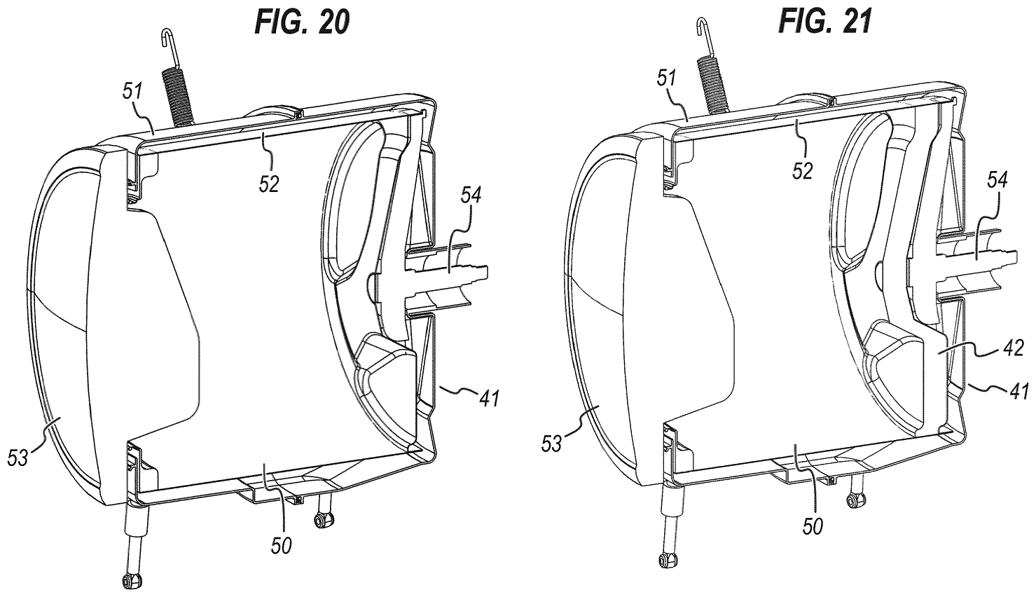

FIG. 18 shows a larger perspective view of the end wall (41) of a drum comprising storage means in three sections (41a, 41b, and 41c) allowing it to be retrofitted to existing drums. The figure also shows elongate protrusions (43a, 43b and 43c).

FIG. 19 shows the end wall (41) of a drum comprising storage means therein, and elongate protrusions (43a, 43b and 43c) disposed on the cylindrical inner surface (50) of the drum.

FIG. 20 shows certain elements of a rotatable drum (52) having an end wall (41) and a cylindrical inner surface (50), and located in a housing (51), wherein the interior of the drum is accessed by access means (53) and wherein the drum is connected to drive shaft (54) from a drive means (not shown) to effect rotation of the drum.

FIG. 21 shows the arrangement of FIG. 20 wherein a storage means (42) is disposed in, or retrofitted onto, the existing end wall (41) of the drum.

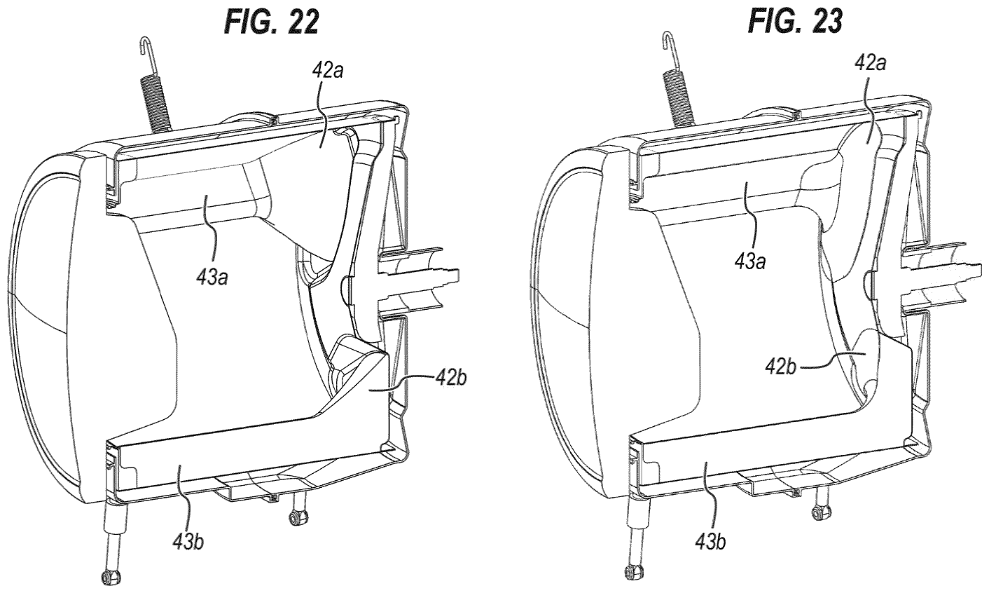

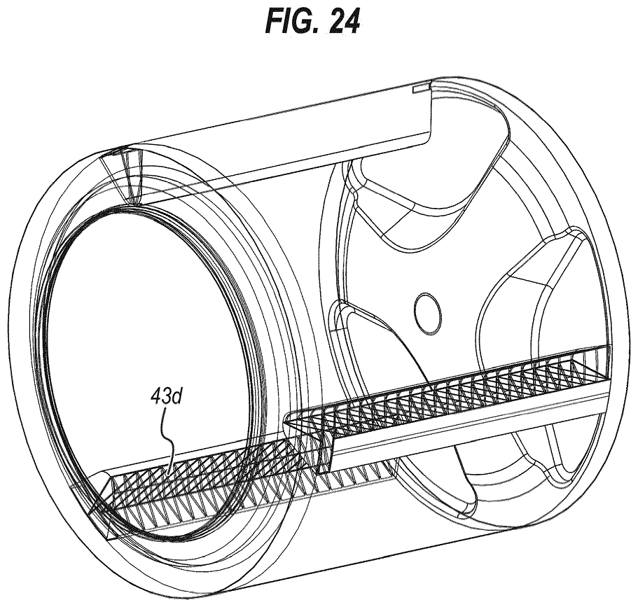

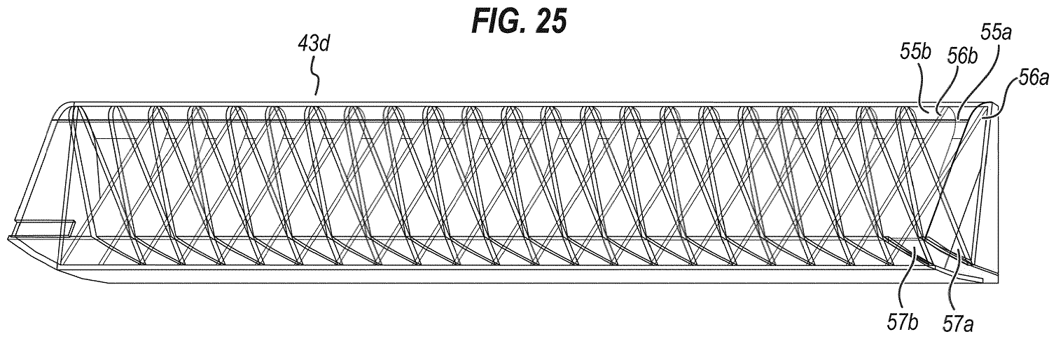

FIGS. 22 and 23 show an arrangement with a plurality of storage means (42a, 42b) and a plurality of elongate protrusions (43a, 43b).

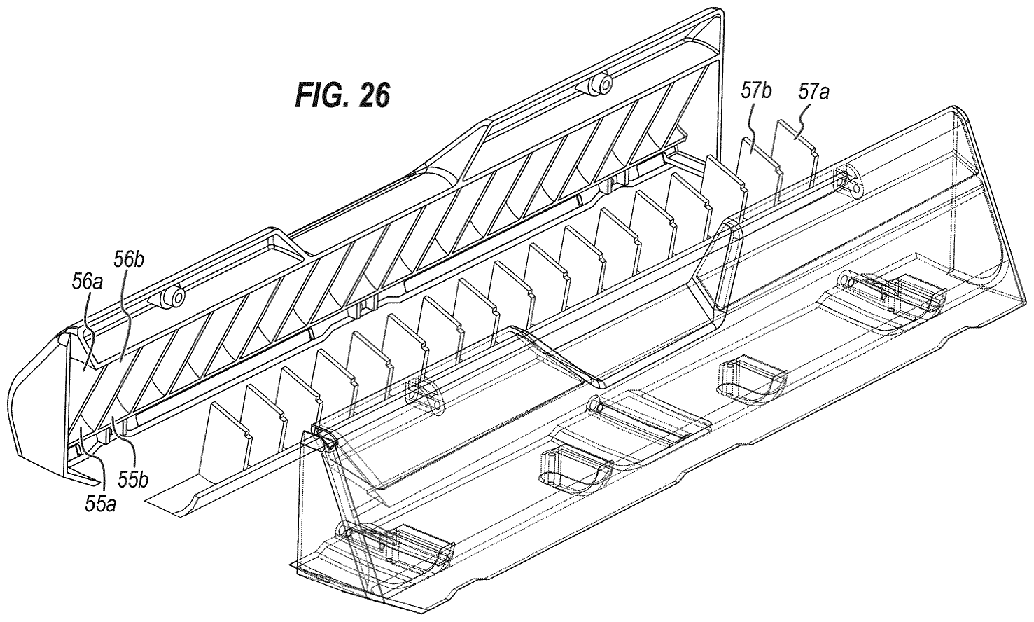

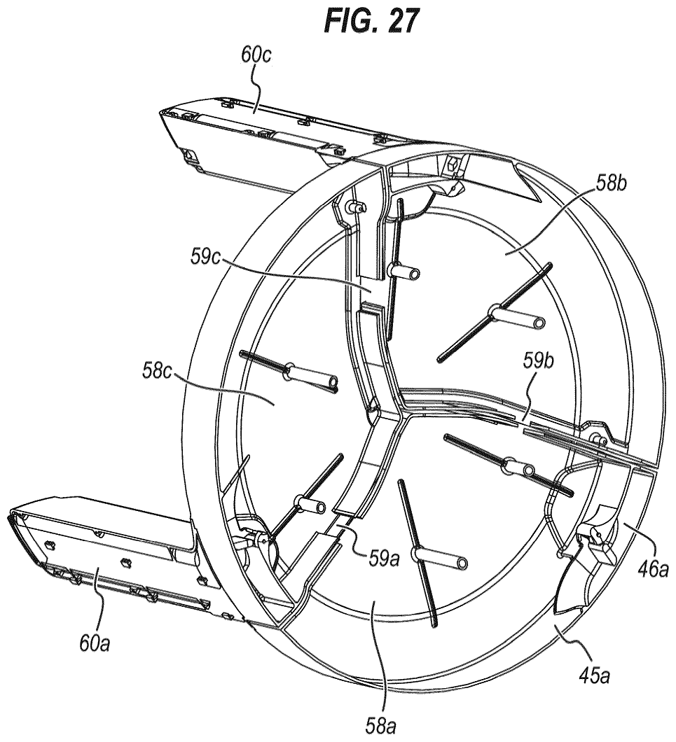

FIGS. 24, 25 and 26 show an elongate protrusion (43d), having the paternoster configuration described herein, wherein the dispensing flow path comprises a chain of open compartments (55a, b) formed by a first series of inclined, substantially parallel vanes (56a, b) and a second series of inclined, substantially parallel vanes (57a, b). FIG. 26 shows the elongate protrusion and dispensing flow path in dissembled form.

FIG. 27 shows a multi-compartment storage means located in the end-wall of the drum as hereinbefore described, comprising compartments 58a, 58b and 58c. Each compartment is in fluid communication with an adjacent compartment via communicating apertures 59a, 59b and 59c. Each compartment is associated with a single lifter 60a and 60c (lifter 60b not shown), and each compartment is associated with a single dispensing flow path (45a) and a single collecting flow path (46a) (shown only for compartment 58a).

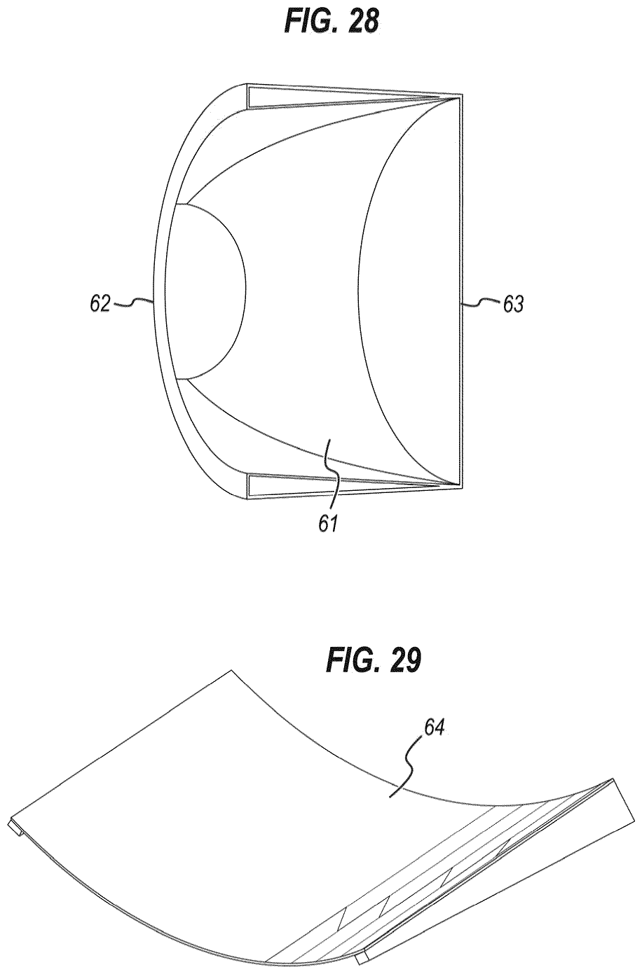

FIG. 28 shows a cross-section of a drum having a generally frusto-conical surface (61), inclined downwardly from the front of the drum (62) to the end wall of the drum (63), i.e. such that the internal diameter of the drum increases towards the end wall of the drum.

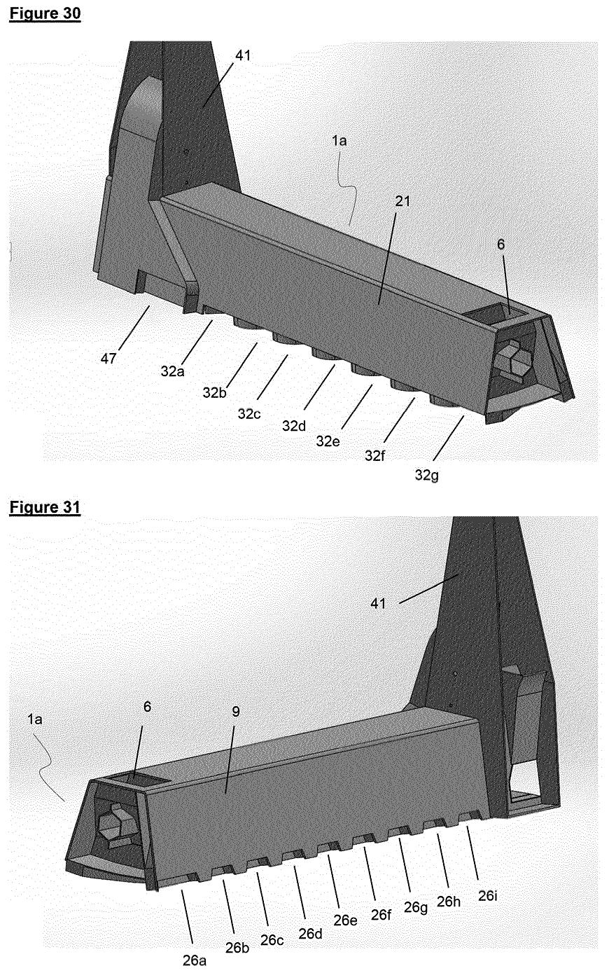

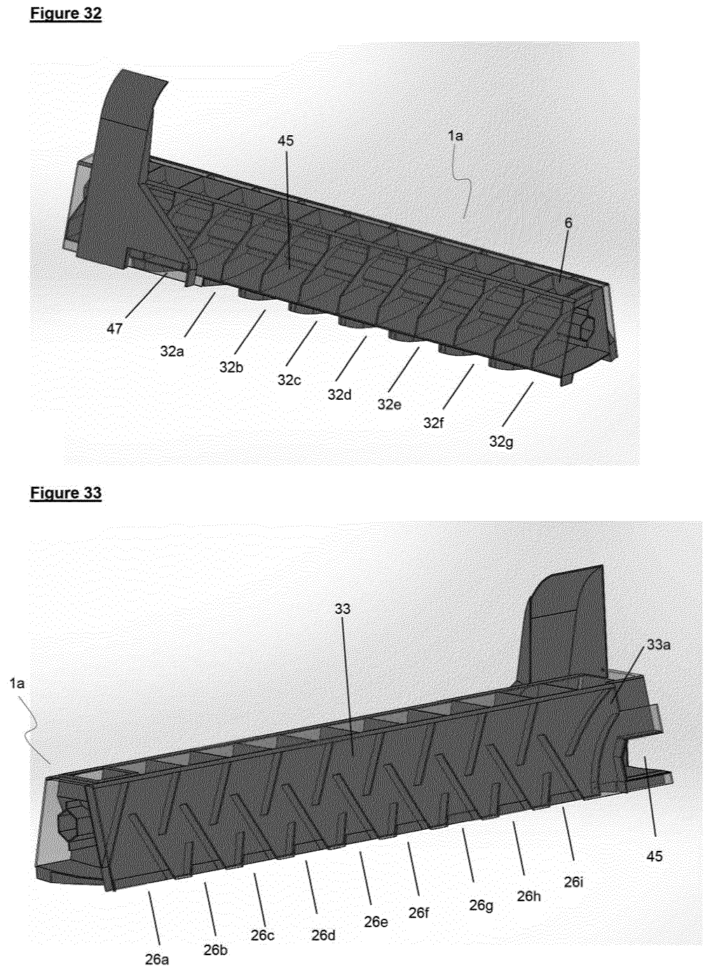

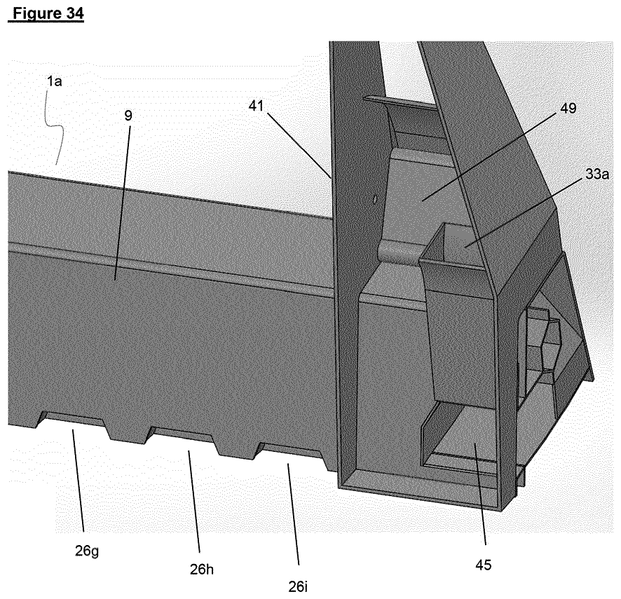

FIG. 29 shows a section (64) of a frusto-conical surface suitable for retro-fitting to a conventional apparatus for converting a drum having a cylindrical inner surface to a drum having a frusto-conical inner surface. Such a frusto-conical surface section is suitable as an insert for disposing between elongate protrusions (not shown) disposed on the inner surface of the drum (not shown).

FIGS. 30 to 34 illustrate the Double Herringbone arrangement in respect of an elongate protrusion according to Embodiment B disclosed herein.

FIG. 30 shows additional collecting apertures (32a to 32g) in the first side (21) of an elongate lifter (1a) where it meets the inner wall of the drum (not shown). The lifter further comprises collecting aperture (47) and dispensing aperture (6). FIG. 30 further shows a portion of the end wall of the drum (41).

FIG. 31 shows harvesting apertures (26a to 26i) in the second side (9) of elongate lifter (1a) where it meets the inner wall of the drum (not shown).

FIG. 32 corresponds to FIG. 30 but wherein the top cover and the first side of the elongate protrusion (1a) have been removed to illustrate the internal structure of the elongate protrusion, i.e. the chain of open compartments which constitute the dispensing flow path (45).

FIG. 33 corresponds to FIG. 31 but wherein the top cover and the second side (9) of the elongate protrusion (1a) have been removed to illustrate the internal structure, namely the series of open compartments which constitute the harvesting flow path (33). FIG. 33 further shows the portion of the dispensing flow path (45) which connects the storage means (not shown) with the chain of open compartments of the dispensing flow path shown in FIG. 32. The portion of the harvesting flow path marked as (33a) in FIG. 33 is in fluid communication with the storage means, i.e. it is the portion of the harvesting flow path where solid particulate material passes from the harvesting flow path to the storage means during rotation of the drum.

FIG. 34 shows the end wall of the drum (41) and a portion of elongate lifter (1a) having harvesting apertures (26g, 26h, 26i) in the second side (9) thereof. FIG. 34 further shows an arrangement of the dispensing flow path (45), the portion of the harvesting flow path (33a) which is in fluid communication with the storage means, and the one-way flap valve (49) through which solid particulate material passes from the collecting flow path (not shown) to the storage means.

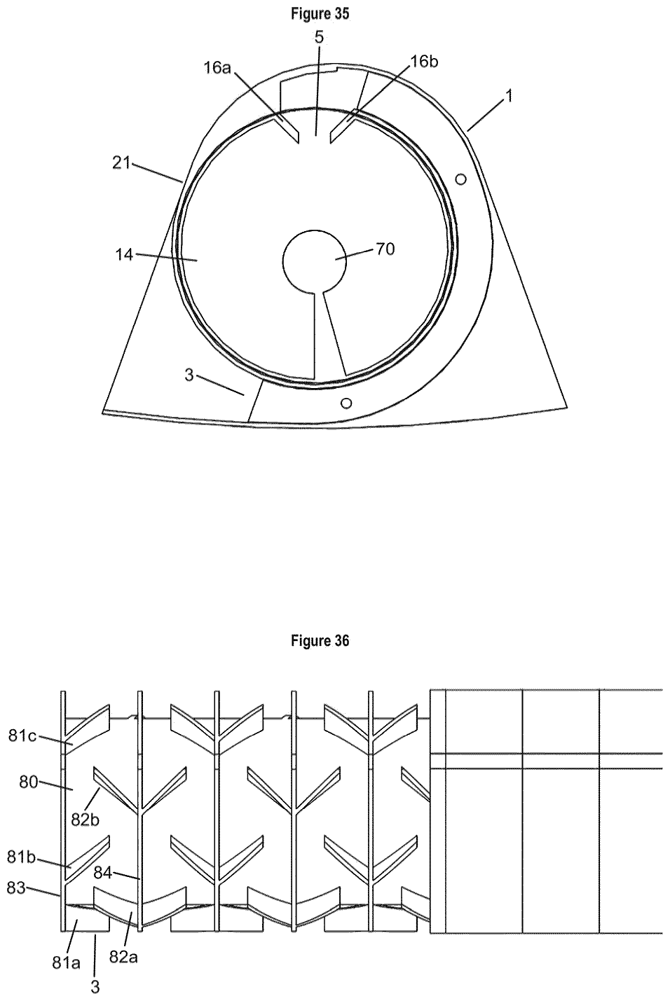

FIG. 35 illustrates the third configuration of the peripheral entry embodiment as described herein. The transferring aperture (5) (which in this figure is defined by a slot) is located in the periphery of the common internal flow path at a position which is distal to the inner wall of the drum and proximal to the rotational axis of the drum, and nearest the apex of the elongate protrusion (1). A first deflector rib portion (16a) and a second deflector rib portion (16b) are associated with the transferring aperture (5) and extend between opposing surfaces of an Archimedean screw arrangement. A collecting aperture (3) is disposed in the first side (21) of the elongate protrusion (1), which is the leading side during rotation of the drum in a collecting direction. The core (70) of the Archimedean screw is disposed eccentrically.

FIG. 36 shows an arrangement wherein a first portion (80) of a collecting flow path is equipped with a first series of vanes (81a, 81b, 81c) and a second series of vanes (82a, 82b) disposed in an opposing and staggered arrangement, and in an interlocking but non-contacting arrangement. The first series of vanes is disposed on a first internal wall (83) of said first portion (80) and said second series of vanes is disposed on second internal wall (84) of said first portion, wherein said first and second internal walls face each other. The vanes of each series are angled away from an internal wall of said first portion in the direction of flow of solid particulate from the collecting aperture (3) to the transferring aperture (not shown). The first and second series of vanes thereby permit flow of solid particulate material from the collecting aperture to the transferring aperture but discourage flow in the opposite direction, and provide a tortuous pathway from the collecting aperture to the transferring aperture which biases solid particulate material towards the common internal flow path during rotation of the drum.

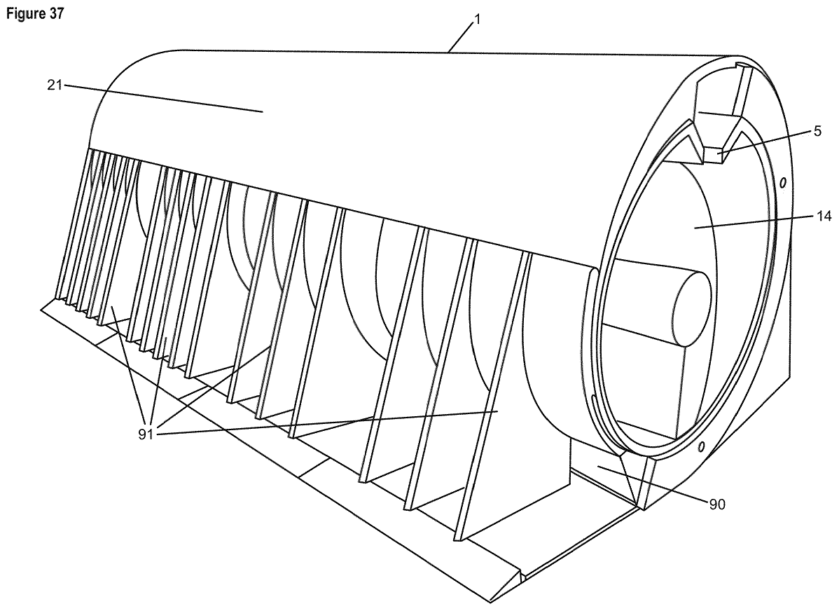

FIG. 37 illustrates an elongate protrusion (1) wherein the collecting aperture is a slot (90) which extends along the base of the first side (21) of said elongate protrusion (1), which is the leading side during rotation of the drum in a collecting direction. The collecting aperture (90) is in fluid communication with a plurality of collecting flow paths (not shown), each of which has a first flow portion (not shown) which is in fluid communication with the common internal flow path (14) via a transferring aperture (5). A series of vertical guide ribs (91) is disposed in front of the slot (90) to define a series of collecting channels which are in fluid communication with the interior of the drum (not shown) and said slot (90).

1. An apparatus for use in the treatment of substrates with a solid particulate material, said apparatus comprising a housing having mounted therein a rotatably mounted drum having an inner surface and an end wall, and access means for introducing said substrates into said drum, wherein
(a) said drum comprises storage means for storage of said solid particulate material;
(b) said drum has at least one elongate protrusion located on said inner surface of said drum wherein the elongate protrusion extends in a direction away from said end wall, wherein said elongate protrusion has an end proximal to the end wall and an end distal to the end wall;
(c) the or each elongate protrusion comprises a collecting aperture and a collecting flow path to facilitate flow of said solid particulate material from the interior of said drum to said storage means, wherein said collecting aperture defines the start of a collecting flow path, and wherein the same elongate protrusion further comprises a dispensing aperture and a dispensing flow path to facilitate flow of said solid particulate material from said storage means to the interior of said drum, wherein said dispensing aperture defines the end of a dispensing flow path;
(d) wherein said collecting aperture is disposed in a first side of said elongate protrusion, wherein said first side of said elongate protrusion is the leading side of said elongate protrusion during rotation of the drum in a collecting direction; and
(e) wherein said flow of said solid particulate material from the storage means towards the interior of the drum is facilitated by the rotation of said drum in a dispensing direction and the flow of said solid particulate material from the interior of the drum towards the storage means is facilitated by the rotation of said drum in said collecting direction, wherein rotation in said dispensing direction is in the opposite rotational direction to rotation in said collecting direction,
characterised in that:
(f) said elongate protrusion exhibits one or more harvesting apertures disposed in a second side of said elongate protrusion, wherein the second side is defined as the leading side of said elongate protrusion during rotation of the drum in said dispensing direction, wherein said harvesting aperture(s) are in fluid communication with a harvesting flow path, wherein said harvesting aperture(s) facilitate flow of said solid particulate material from the interior of said drum via said harvesting flow path to said storage means during rotation of the drum in a dispensing direction.

2. An apparatus according to claim 1 wherein said elongate protrusion comprises a plurality of said harvesting apertures.

3. An apparatus according to claim 1 or 2 wherein said harvesting flow path is located in or on the base of the elongate protrusion, or wherein said harvesting flow path is located in or on the second side of the elongate protrusion.

4. An apparatus according to any preceding claim wherein said harvesting flow path is configured to bias solid particulate material towards the storage means during rotation of the drum in a dispensing direction and preferably also in a collecting direction.

5. An apparatus according to any preceding claim wherein said harvesting flow path is located within an elongate cavity located in or on the base of said elongate protrusion, or in or on the second side of said elongate protrusion, wherein said elongate cavity has a flat, plate-like shape having a length, width and depth, wherein the length dimension of said cavity is disposed along at least a part of the elongate dimension of the elongate protrusion, wherein the width dimension of said cavity is disposed along at least a part of the width of the base of said elongate protrusion, or along at least a part of the width of the second side of said elongate protrusion, depending on the location of the harvesting flow path in or on the elongate protrusion, and wherein the depth dimension of said cavity is substantially normal to the base of said elongate protrusion, or the second side of said elongate protrusion, depending on the location of the harvesting flow path in or on the elongate protrusion, and wherein said cavity has a first edge and a second edge, wherein said first and second edges are on opposite edges of the width dimension of the cavity, wherein said harvesting aperture(s) are disposed in the first edge, such that wherein said harvesting flow path is located in or on the base of said elongate protrusion the first edge of the elongate cavity is located at the second side of the elongate protrusion, and wherein said harvesting flow path is located in or on the second side of said elongate protrusion, the first edge of the elongate cavity is located at the juncture of the second side of said elongate protrusion with the inner wall of the drum.

6. An apparatus according to any preceding claim wherein said harvesting flow path comprises a chain of open compartments in fluid communication with the storage means.

7. An apparatus according to claim 6, said chain of open compartments is formed by a first series of vanes and a second series of vanes, wherein said first and second series of vanes are disposed along at least part of the length of the elongate protrusion, wherein said first series of vanes are disposed in an opposing and staggered arrangement with said second series of vanes in a manner to provide a tortuous pathway from the harvesting apertures to the storage means which biases solid particulate material towards the storage means during rotation of the drum.

8. An apparatus according to claim 7 wherein the vanes of the second series are substantially parallel to each other.

9. An apparatus according to claim 7 or 8 wherein consecutive vanes of said second series are arranged in a U-shape, wherein each U-shape has a distal wall closer to the distal end of the elongate protrusion and a proximal wall closer to the proximal end of the elongate protrusion, such that said second series of vanes defines a series of adjoining U-shapes comprising a first U-shape and a second U-shape and optionally one or more subsequent U-shape(s), wherein said first U-shape is closer to the distal end of the elongate protrusion than said second adjoining U-shape, preferably wherein a proximal wall of said first U-shape is the same wall as the distal wall of said adjoining second U-shape.

10. An apparatus according to any of claims 7 to 9 wherein said second series of vanes defines a series of inclined adjoining U-shapes wherein the incline of the distal and proximal walls of said U-shape is towards the distal end of the elongate protrusion.

11. An apparatus according to claim 9 or 10 wherein the mouth of said U-shape faces inwardly towards the interior of the elongate protrusion, and preferably faces towards a harvesting aperture or faces towards the side of the harvesting flow path in which the harvesting apertures are located.

12. An apparatus according to any of claims 9 to 11 wherein said chain of open compartments is located in or on the base of the elongate protrusion and the second series of vanes is disposed adjacent the first side of the elongate protrusion or closer to said first side than said first series of vanes, preferably such that the base of said U-shape is or is juxtaposed with the interior surface of the first side of the elongate protrusion, such that the mouth of the U-shape faces inwardly towards the interior of the elongate protrusion and in the direction of rotation of the drum during rotation in a dispensing direction.

13. An apparatus according to any of claims 9 to 11 wherein said chain of open compartments is located in or on the second side of the elongate protrusion and the second series of vanes is disposed adjacent an apex of the elongate protrusion or closer to said apex than said first series of vanes, preferably such that the mouth of said U-shape faces inwardly towards the interior of the elongate protrusion and towards the inner surface of the drum.

14. An apparatus according to any of claims 7 to 13 wherein the vanes of the first series are arranged in a series of U-shapes wherein each U-shape has a distal wall closer to the distal end of the elongate protrusion and a proximal wall closer to the proximal end of the elongate protrusion.

15. An apparatus according to claim 14 wherein said first series of vanes defines a series of U-shapes wherein at least one and preferably each pair of adjacent U-shapes do not adjoin each other, and wherein at least one and preferably each pair of adjacent U-shapes are interrupted by a harvesting aperture in the second side of the elongate protrusion.

16. An apparatus according to claim 14 or 15 wherein a plurality of harvesting apertures in the second side of the elongate protrusion provides multiple entry points into the chain of open compartments.

17. An apparatus according to claim 14, 15 or 16 wherein the mouth of said U-shape faces inwardly towards the interior of the elongate protrusion and away from a harvesting aperture.

18. An apparatus according to any of claims 14 to 17 wherein a U-shape defined by the vanes of the first series comprises a distal wall which is inclined towards the distal end of the elongate protrusion and a proximal wall which is inclined towards the proximal end of the elongate protrusion.

19. An apparatus according to any of claims 14 to 18 wherein said chain of open compartments is located in or on the base of the elongate protrusion and the first series of vanes is disposed adjacent the second side of the elongate protrusion or closer to said second side than said second series of vanes, preferably such that the base of said U-shape is or is juxtaposed with the interior surface of the second side of the elongate protrusion, such that the mouth of the U-shape faces inwardly towards the interior of the elongate protrusion and in the opposite direction to the rotational direction of the drum during rotation in a dispensing direction.

20. An apparatus according to any of claims 14 to 18 wherein said chain of open compartments is located in or on the second side of the elongate protrusion and the first series of vanes is disposed adjacent the inner surface of the drum or closer to said inner surface than said second series of vanes, preferably such that the mouth of said U-shape faces inwardly towards the interior of the elongate protrusion and towards the apex of the elongate protrusion.

21. An apparatus according to any of claims 9 to 20 wherein the series of U-shapes defined by the first series of vanes are disposed in an opposing and staggered arrangement with the series of U-shapes defined by the second series of vanes in a manner to provide a tortuous harvesting flow path from the harvesting aperture(s) to the storage means which biases solid particulate material towards the storage means during rotation of the drum.

22. An apparatus according to any of claims 9 to 21 wherein said harvesting aperture(s) is/are in fluid communication with the storage means via said harvesting flow path comprising a chain of open compartments configured to bias solid particulate material towards the storage means during rotation of the drum in at least a dispensing direction, and wherein the apparatus is configured such that:
(i) during rotation of the drum in a dispensing direction solid particulate material enters a harvesting aperture and passes into one of the open compartments in said chain of open compartments, preferably into a U-shape formed by the second series of vanes,
(ii) wherein upon further rotation of the drum in the dispensing direction said solid particulate material is transferred into an opposing and staggered U-shape formed by the first series of vanes wherein said opposing and staggered U-shape is closer to the proximal end of the elongate protrusion than said U-shape formed by the second series of vanes from which the solid particulate material was transferred, and
(iii) wherein upon further rotation of the drum in the dispensing direction said solid particulate is transferred into a further U-shape formed by the second series of vanes wherein said further U-shape formed by the second series of vanes is closer to the proximal end of the elongate protrusion than said U-shape formed by the first series of vanes from which the solid particulate material was transferred, thereby biasing said solid particulate material towards the storage means.

23. An apparatus according to any preceding claim which is configured to:
(i) dispense solid particulate material into the interior of the drum during rotation of the drum in a dispensing direction at a dispensing rate defined by R_{D}, and
(ii) harvest solid particulate material from the interior of the drum via the harvesting aperture(s) into the elongate protrusion during rotation of the drum in a dispensing direction at a harvesting rate defined by R_{H}, wherein the net rate of introduction (NR_{I}) of solid particulate material into the drum during rotation of the drum in a dispensing direction is given by NR_{I}=R_{D}−R_{H},
and wherein the apparatus is configured such that NR_{I} is positive,
and preferably wherein R_{H} is no more than about 50%, preferably no more than about 40%, preferably no more than about 30%, preferably no more than about 20%, of R_{D}.

24. An apparatus according to any preceding claim wherein the harvesting flow path comprises a valve, preferably a one-way flap valve, to prevent egress of solid particulate material from the storage means back into the harvesting flow path during rotation of the drum in a collecting direction.

25. An apparatus according to any preceding claim wherein said dispensing aperture is located in said elongate protrusion at its distal end or closer to its distal end than its proximal end, or from at least about half way along said elongate protrusion from the proximal end to the distal end thereof, or wherein the or each elongate protrusion has a plurality of dispensing apertures spaced along the length of said elongate protrusion from its proximal end to its distal end.

26 An apparatus according to any preceding claim wherein the or each elongate protrusion is configured to bias solid particulate material present inside the storage means and/or dispensing flow path towards said dispensing aperture during rotation of the drum in the dispensing direction.

27. An apparatus according to any preceding claim wherein the drum is configured to bias solid particulate material present inside the drum towards said collecting aperture(s) during rotation of the drum in the collecting direction, and the drum is configured to bias solid particulate material present inside the storage means and/or dispensing flow path towards said dispensing aperture(s) during rotation of the drum in the dispensing direction.

28. An apparatus according to any preceding claim wherein the or each elongate protrusion is configured to, bias solid particulate material present inside said collecting flow path towards the storage means during rotation of the drum in the collecting direction.

29. An apparatus according to any preceding claim wherein said collecting flow path and said dispensing flow path are partially but not completely coextensive.

30. An apparatus according to claim 29 wherein the or each elongate protrusion comprises a plurality of collecting apertures disposed in said first side of said elongate protrusion at a plurality of positions from the proximal end to the distal end thereof.

31. An apparatus according to claim 29 or 30 wherein a portion of said collecting flow path and a portion of said dispensing flow path share a common internal flow path within the or each elongate protrusion.

32. An apparatus according to claim 31 wherein said common internal flow path is configured to bias solid particulate material present inside said common internal flow path towards the storage means during rotation of the drum in the collecting direction and towards said dispensing aperture(s) during rotation of the drum in the dispensing direction.

33. An apparatus according to claim 31 or 32 wherein said common internal flow path is or comprises an Archimedean screw arrangement located in the or each elongate protrusion.

34. An apparatus according to claim 33 wherein the surfaces of said Archimedean screw arrangement are rectilinear or curvilinear or a combination thereof.

35. An apparatus according to any one of claims 31 to 34 wherein said collecting, flow path comprises a first portion which is in fluid communication with said collecting aperture and said common internal flow path.

36. An apparatus according to claim 35 wherein said first portion of said collecting flow path is defined by said collecting aperture at one end of said portion and a transferring aperture at the other end of said portion wherein said transferring aperture facilitates the transfer of solid particulate material from said first portion to said common internal flow path during rotation of the drum in the collecting direction.

37. An apparatus according to claim 36 wherein said transferring aperture is configured such that rotation of the drum in either the collecting or dispensing direction biases solid particulate material which is present in said common internal flow path away from said transferring aperture.

38. An apparatus according to claim 36 or 37 wherein said transferring aperture is located approximately centrally within the common internal flow path.

39. An apparatus according to any of claims 36 to 38 wherein said first portion of a collecting flow path is equipped with a plurality of vanes which permit flow of solid particulate material from the collecting aperture to the transferring aperture but discourage flow of solid particulate present in said first portion back out of the collecting aperture, preferably wherein said plurality of vanes comprises a first series of vanes and a second series of vanes wherein said first and second series of vanes are disposed along at least part of the length of said first portion of a collecting flow path, wherein said first series of vanes is disposed in an opposing and staggered arrangement with said second series of vanes, preferably wherein the vanes of each of the first and second series are angled away from an internal wall of said first portion in the direction of flow of solid particulate from the collecting aperture to the transferring aperture thereby permitting flow of solid particulate material from the collecting aperture to the transferring aperture but discouraging flow in the opposite direction.

40. An apparatus according to any of claims 35 to 39 wherein said first portion of said collecting flow path is located within a wall of the Archimedean screw arrangement as defined in claim 33 or 34.

41. An apparatus according to any one of claims 31 to 40 wherein the or each elongate protrusion comprises a plurality of collecting apertures wherein each collecting aperture is in fluid communication with said common internal flow path via a plurality of collecting flow paths each of which has a first portion in fluid communication with said collecting aperture and said common internal flow path, such that each of said first portions facilitates the flow of solid particulate material into said common internal flow path during rotation of the drum in a collecting direction.

42. An apparatus according to any of claims 31 to 41 wherein the common internal flow path is constituted by the walls of a series of separate modular sections wherein each of said modular sections comprises a collecting aperture, a first portion of a collecting flow path and a transferring aperture as defined in any of claims 36 to 39, wherein said series of separate modular sections, when joined together, form at least some of the boundary walls of the common internal flow path.

43. An apparatus according to any of claims 1 to 28 wherein the elongate protrusion comprises a dispensing flow path and a collecting flow which are different flow paths.

44. An apparatus according to claim 43 wherein said elongate protrusion(s) and/or said drum are configured to bias solid particulate material present inside the drum towards the end wall of the drum during rotation of the drum in a collecting direction.

45. An apparatus according to claim 43 or 44 wherein said collecting aperture is located in said elongate protrusion at its proximal end.

46. An apparatus according to claim 45 wherein the elongate protrusion comprises a collecting groove along at least part of said first side thereof, wherein the collecting groove is configured to collect solid particulate material during rotation in a collecting direction, whereupon the solid particulate material is biased towards the collecting aperture during further rotation in a collecting direction, preferably wherein said collecting groove is disposed in the elongate protrusion along at least part of the edge of the elongate protrusion where it meets the inner wall of the drum.

47. An apparatus according to any of claims 43 to 46 wherein an elongate protrusion is disposed on the inner surface of the drum such that one or more angled channels are present between the underside of the elongate protrusion and the inner surface of the drum, or are present through an elongate protrusion at one or more position(s) where the elongate protrusion meets the inner surface of the drum so that one boundary wall of the angled channel presents a surface which is continuous with the inner surface of the drum, wherein said angled channel(s) is/are configured to allow solid particulate material to flow underneath or through the elongate protrusion such that during rotation of the drum in a collecting direction the exit point of an angled channel is closer to the end-wall of the drum than the entry point of that angled channel, and wherein the entry point of an angled channel is located on said first side of an elongate protrusion and the exit point of an angled channel is located on the opposite, second side of an elongate protrusion.

48. An apparatus according to any of claims 43 to 47 wherein the inner surface of the drum is textured or contoured with one or more guiding elements affixed thereto or formed integrally therewith to bias solid particulate material towards the end-wall of the drum during rotation of the drum in a collecting direction.

49. An apparatus according to claim 48 wherein said guiding element comprises one or more ribs and/or one or more grooves which are disposed on or in the inner surface of the drum between adjacent elongate protrusions such that said rib(s) and/or groove(s) are angled in a manner which directs solid particulate material away from a first elongate protrusion and the front of the drum and towards the adjacent elongate protrusion and the end-wall of the drum during rotation of the drum in a collecting direction.

50. An apparatus according to claim 49 wherein the guiding element is a rib having a profile configured to retain solid particulate material during the biasing thereof towards the end-wall of the drum, preferably wherein the edge of the rib which is the leading edge during rotation of the drum in a collecting direction comprises a collecting groove which runs at least partially along the length of the rib.

51. An apparatus according to any of claims 48 to 50 wherein the guiding element is a perforated diverting rib disposed on the inner surface of the drum between adjacent elongate protrusions such that said perforated diverting rib extends in a direction away from the end-wall of the drum and towards the front of the drum, wherein the perforated diverting rib has a first edge which is the leading edge during rotation of the drum in a collecting direction and a second edge which is the trailing edge during rotation of the drum in a collecting direction, wherein each of the first and second edges has one or more apertures therein, and wherein the perforated diverting rib comprises a plurality of angled channels which connect the aperture(s) on the first edge with the aperture(s) on the second edge, and wherein the exit point from an angled channel at the second edge of the rib is closer to the end-wall of the drum than the entry point into that angled channel at the first edge of the rib, thereby allowing solid particulate material to flow through the perforated diverting rib so that during rotation of the drum in a collecting direction the solid particulate material is biased towards the end-wall of the drum.

52. An apparatus according to any of claims 43 to 51 wherein the inner surface of the rotatably mounted drum is configured to bias solid particle material towards the end wall of the drum wherein said inner surface defines a frusto-conical surface such that the inner surface of the drum is inclined in a downwards direction from the front of the drum to the end wall of the drum.

53. An apparatus according to claim 52 wherein the inner surface of the drum is configured to define at least one collecting channel in said inner surface at the juncture of the inner surface and the end-wall of the drum, wherein the collecting channel extends along the juncture of the inner surface and the end-wall of the drum to the collecting aperture, and is thus configured to bias solid particulate material towards the collecting aperture during rotation of the drum in a collecting direction.

54. An apparatus according to any of claims 43 to 53 wherein the dispensing flow path comprises a chain of open compartments or an Archimedean screw arrangement located in the elongate protrusion and configured to bias solid particulate material present inside the storage means and/or dispensing flow path towards said dispensing aperture during rotation of the drum in a dispensing direction.

55. An apparatus according to any of claims 43 to 54 wherein said collecting flow path comprises a valve, preferably a one-way flap valve, to prevent egress of said solid particulate material from said storage means to the interior of said drum via said collecting flow path.

56. An apparatus according to any of claims 43 to 55 wherein the harvesting flow path is located in or on the second side of said elongate protrusion, and wherein the elongate protrusion comprises one or more additional collecting aperture(s) disposed in a first side thereof at one or more position(s) from the proximal end to the distal end thereof, wherein said additional collecting aperture(s) is/are in fluid communication with an additional collecting flow path which in turn is in fluid communication with the storage means, preferably wherein said additional collecting flow path is located in or on the base of said elongate protrusion and is configured to bias solid particulate material towards the storage means during rotation of the drum, particularly during rotation of the drum in a collecting direction.

57. An apparatus according to claim 56 wherein said additional collecting flow path is a chain of open compartments which is located in or on the base of said elongate protrusion, wherein said chain of open compartments is formed by a first series of vanes and a second series of vanes, wherein said first and second series of vanes are disposed along at least part of the length of the elongate protrusion, wherein said first series of vanes are disposed in an opposing and staggered arrangement with said second series of vanes in a manner to provide a tortuous additional collecting flow path from the additional collecting apertures to the storage means.

58. An apparatus according to any preceding claim wherein movement of said solid particulate material between the storage means and the interior of the drum is actuated entirely by rotation of the drum.

59. An apparatus according to any preceding claim wherein the storage means is or comprises at least one cavity located in the end wall of the drum.

60. An apparatus according to any preceding claim wherein the storage means comprises multiple compartments, for instance, 2, 3, 4, 5 or 6 compartments, particularly wherein said multiple compartments are arranged so as to retain balance of the drum during rotation.

61. An apparatus according to any preceding claim wherein the storage means comprises multiple compartments located in the end wall of the drum, wherein each of the compartments is defined by a cavity bound by a first wall and a second wall which each extend outwards from the rotational axis of the drum towards and preferably to the inner wall of the drum, preferably wherein each compartment is associated with a single elongate protrusion comprising said collecting flow path and said dispensing flow path.

62. An apparatus according to claim 61 wherein each compartment is in fluid communication with its adjacent compartment or compartments such that solid particulate material, as well as any liquid medium, is able to pass from one compartment directly into an adjacent compartment during rotation of the drum.

63. An apparatus according to claim 62 wherein fluid communication between adjacent compartments is effected by a communicating aperture in the wall between adjacent compartments, preferably wherein a communicating aperture exhibits a smallest dimension which is at least 4 times greater than the longest dimension of the solid particulate material, and preferably wherein the largest dimension of the communicating aperture is no greater than 50% of the longest dimension of a wall between adjacent compartments, and preferably wherein said communicating aperture is located in a wall between adjacent compartments at a point that is closer to the mid-point of said wall between adjacent compartments than to either the rotational axis of the drum or the inner wall of the drum.

64. An apparatus according to any preceding claim wherein the storage means further comprises one or more perforations which have dimensions smaller than the shortest linear dimension of the solid particulate material so as to permit passage of fluids through said perforations into and out of the storage means, particularly out of or into the interior of said drum respectively, but to prevent egress of said solid particulate material through said perforations.

65. An apparatus according to any preceding claim wherein the dispensing flow path is configured such that it dispenses solid particulate material from a dispensing aperture therein when the dispensing aperture is above the horizontal plane bisecting the axis of drum rotation.

66. An apparatus according to any preceding claim wherein the dimensions of said dispensing flow path, said collecting flow path and said harvesting flow path are such that they have no internal dimension which is less than 2 times, more preferably less than 3 times, the longest dimension of the solid particulate material.

67. An apparatus according to any preceding claim wherein the storage means and the or each elongate protrusion can be assembled inside the drum, and/or are able to be retrofitted to an existing drum, and/or are removable and replaceable such that the solid particulate material contained therein may be replaced with fresh solid particulate material.

68. An apparatus according to any preceding claim wherein the inner surface of said drum comprises perforations which have dimensions smaller than the shortest linear dimension of the solid particulate material so as to permit passage of fluids into and out of said drum but to prevent egress of said solid particulate material.

69. An apparatus according to claim 68 wherein said housing is a tub which surrounds said drum, preferably wherein said tub and said drum are substantially concentric, preferably wherein the walls of said tub are unperforated but having disposed therein one or more inlets and/or one or more outlets suitable for passage of a liquid medium and/or one or more treatment agents into and out of the tub.

70. An apparatus according to any preceding claim further comprising a seal between the access means and the tub.

71. An apparatus according to any preceding claim wherein said drum has an opening at the opposite end of the drum to the end wall through which said substrates are introduced into said drum.

72. An apparatus according to any preceding claim wherein the dispensing flow path and/or the storage means are configured such that it takes 2, 3, 4, 5, 6, 7, 8, 9 or 10 rotations in the dispensing direction to begin to release the solid particulate material into the interior of said drum.

73. An apparatus according to any preceding claim wherein the apparatus does not comprise a further storage means which is not attached to or integral with the drum, and/or wherein the apparatus does not comprise a pump for circulating said solid particulate material between the storage means and the interior of the drum.

74. An apparatus according to any preceding claim wherein the apparatus does not comprise a pump for circulating said solid particulate material.

75. An apparatus according to any preceding claim wherein the drum comprises two, three, four, five or six elongate protrusions

76. An apparatus according to any preceding claim wherein said treatment of substrates with solid particulate material is in the presence of a liquid medium and/or one of more treatment formulation(s).

77. An apparatus according to any preceding claim which comprises aid solid particulate material.

78. An apparatus according to any preceding claim wherein the particles of the solid particulate material have (i) an average mass of from about 1 mg to about 1000 mg; and/or (ii) an average volume in the range of from about 5 to about 500 mm³; and/or (iii) an average surface area of from 10 mm² to 500 mm² per particle; and/or (iv) an average particle size of from 1 mm to 50 mm, preferably from 2 to 20 mm, preferably from 5 mm to 10 mm; and/or (v) and average density of at least about 1 g/cm³ or at least about 1.4 g/cm³.

79. An apparatus according to any preceding claim wherein the particles of the solid particulate comprise a polymer, preferably wherein the polymer is or comprises a polyalkylene, a polyamide, a polyester or a polyurethane, preferably a polyalkylene, polyester or polyamide, preferably a polyamide selected from nylon 6 or nylon 6,6 or a polyalkylene selected from polypropylene, and preferably a polyamide or a polyamide selected from nylon 6 or nylon 6,6.

80. An apparatus according to any preceding claim wherein the particles of h solid particulate material are spheroidal or ellipsoidal or a mixture thereof,

81. An apparatus according to any preceding claim wherein the rotatable drum is cylindrical.

82. A method of treating a substrate, the method cornprising agitating the substrate in an apparatus according to any of claims 1 to 81 with solid particulate material.

83. A method according to claim 82 wherein the solid particulate material is re-used in further treatment procedures according to the method.

84. A method according to claim 82 or 83 wherein the method is a method for treating multiple batches, wherein a batch comprises at least one substrate, the method comprising agitating a first batch with solid particulate material, wherein said method further comprises the steps of:
(a) collecting said solid particulate material in the storage means;
(b) agitating a second batch comprising at least one substrate with solid particulate material collected from step (a); and
(c) optionally repeating steps (a) and (b) for subsequent batch(es) comprising at least one substrate.

85. A method according to any of claims 82 to 84 wherein the method comprises agitating the substrate with solid particulate material and a liquid medium, preferably wherein the liquid medium is aqueous.

86. A method according to any of claims 82 to 85 wherein the method comprises agitating the substrate with said solid particulate material and a treatment formulation.

87. A method according to any of claims 82 to 86 wherein the substrate is or comprises a textile.

88. A method according to claim 87 wherein the treating of said substrate is cleaning, coloration, bleaching, abrading or ageing, or other textile or garment finishing process.

89. A method according to claim 88 for cleaning a substrate wherein the substrate is a soiled substrate.

90. A method according to any of claims 82 to 86 wherein the substrate is or comprises an animal skin substrate.

91. A method according to claim 90 wherein the treating of an animal skin substrate is a tannery process.

92. An elongate protrusion wherein said elongate protrusion is as defined in any of claim 1 to 26, 28 to 47, 54 to 57, 65 to 67 or 72.

93. A kit for converting an apparatus which is not suitable for use in the treatment of substrates using a solid particulate material into an apparatus according to any one of claims 1 to 81 which is suitable for use in the treatment of substrates using a solid particulate material, wherein the apparatus comprises a housing having mounted therein a rotatably mounted drum having an inner surface and an end wall and which further comprises access means for introducing said substrates into said drum, and wherein said kit comprises:
(a) solid particulate material;
(b) storage means for storage of said solid particulate material; and
(c) at least one elongate protrusion suitable for locating on said inner surface of said drum such that the or each elongate protrusion extends in a direction away from said end wall, wherein said elongate protrusion has an end proximal to the end wall and an end distal to the end wall, wherein said elongate protrusion comprises a collecting aperture and a collecting flow path to facilitate flow of said solid particulate material from the interior of said drum to said storage means, wherein said collecting aperture defines the start of a collecting flow path, and wherein the same elongate protrusion further comprises a dispensing aperture and a dispensing flow path to facilitate flow of said solid particulate material from said storage means to the interior of said drum, wherein said dispensing aperture defines the end of a dispensing flow path, wherein said collecting aperture is disposed in a first side of said elongate protrusion, wherein said first side of said elongate protrusion is the leading side of said elongate protrusion during rotation of the drum in a collecting direction, and wherein said flow of said solid particulate material from the storage means towards the interior of the drum is facilitated by the rotation of said drum in a dispensing direction and the flow of said solid particulate material from the interior of the drum towards the storage means is facilitated by the rotation of said drum in said collecting direction, wherein rotation in said dispensing direction is in the opposite rotational direction to rotation in said collecting direction,
wherein said kit is adapted to allow affixing of said storage means and said elongate protrusion(s) to one or more interior surface(s) of the drum, characterised in that said elongate protrusion exhibits one or more harvesting apertures disposed in a second side of said elongate protrusion, wherein the second side is defined as the leading side of said elongate, protrusion during rotation of the drum in said dispensing direction, wherein said harvesting aperture(s) facilitate flow of said solid particulate material from the interior of said drum to said storage means during rotation of the drum in a dispensing direction.

94. A method of constructing an apparatus as defined in any of claims 1 to 81 which is suitable for use in the treatment of substrates using a solid particulate material, the method comprising retrofitting a starting apparatus which is not suitable for use in the treatment of substrates using a solid particulate material and which comprises a housing having mounted therein a rotatably mounted drum having an inner surface and an end wall and which further comprises access means for introducing said substrates into said drum, wherein said retrofitting comprises the steps of:
providing solid particulate material, providing one or more storage means for storage of solid particulate material, and providing at least one elongate protrusion(s); and
affixing said storage means and said elongate protrusion(s) to one or more interior surface(s) of the drum,
wherein said at least one elongate protrusion is suitable for locating on said inner surface of said drum such that the or each elongate protrusion extends in a direction away from said end wall, wherein said elongate protrusion has an end proximal to the end wall and an end distal to the end wall, wherein said elongate protrusion comprises a collecting aperture and a collecting flow path to facilitate flow of said solid particulate material from the interior of said drum to said storage means, wherein said collecting aperture defines the start of a collecting flow path, and wherein the same elongate protrusion further comprises a dispensing aperture and a dispensing flow path to facilitate flow of said solid particulate material from said storage means to the interior of said drum, wherein said dispensing aperture defines the end of a dispensing flow path, wherein said collecting aperture is disposed in a first side of said elongate protrusion, wherein said first side of said elongate protrusion is the leading side of said elongate protrusion during rotation of the drum in a collecting direction, and wherein said flow of said solid particulate material from the storage means towards the interior of the drum is facilitated by the rotation of said drum in a dispensing direction and the flow of said solid particulate material from the interior of the drum towards the storage means is facilitated by the rotation of said drum in said collecting direction, wherein rotation in said dispensing direction is in the opposite rotational direction to rotation in said collecting direction,
characterised in that said elongate protrusion exhibits one or more harvesting apertures disposed in a second side of said elongate protrusion, wherein the second side is defined as the leading side of said elongate protrusion during rotation of the drum in said dispensing direction, wherein said harvesting aperture(s) facilitate flow of said solid particulate material from the interior of said drum to said storage means during rotation of the drum in a dispensing direction.
